(19) United States
(12) Patent Application Publication
(10) Pub. No.: US 2024/0161443 A1
(43) Pub. Date: May 16, 2024

(54) INFORMATION PROCESSING SYSTEM AND LEARNING MODEL GENERATION METHOD

(71) Applicant: SONY SEMICONDUCTOR SOLUTIONS CORPORATION, KANAGAWA (JP)

(72) Inventor: KAZUYUKI OKUIKE, KANAGAWA (JP)

(21) Appl. No.: 18/551,009

(22) PCT Filed: Feb. 15, 2022
(86) PCT No.: PCT/JP2022/005907

§ 371 Date: Sep. 18, 2023

(30) Foreign Application Priority Data
Mar. 25, 2021 (JP) 2021-052409

(51) Int. Cl. G06V 10/26; G06F 21/62; G06V 10/774; G06V 10/82; G06V 20/64

(52) U.S. Cl. CPC G06V 10/273; G06F 21/6245; G06V 10/7753; G06V 10/82; G06V 20/64

(57) ABSTRACT

Before recognition processing is performed, preprocessing is performed on image data acquired by a sensor or image data obtained by converting the image data. An information processing system according to an embodiment includes a specifying unit (201) that specifies a correction target pixel in a depth map using a first learning model and a correction unit (202) that corrects the correction target pixel specified by the specifying unit.

### FIELD

The present disclosure relates to an information processing system and a learning model generation method.

### BACKGROUND

In recent years, with the development of automatic driving systems, authentication systems, and the like, technologies for executing recognition processing on two-dimensional data or three-dimensional data acquired by various sensors such as an image sensor and a TOF (Time Of Flight) have been developed.

### CITATION LIST

### Patent Literature

Patent Literature 1: JP 2014-524016 A

### SUMMARY

### Technical Problem

However, if the recognition processing is directly executed on image data acquired by the sensor such as the image sensor or the TOF sensor or image data obtained by converting the image data, problems sometimes occur.

For example, in some case, the image quality of these image data is deteriorated because of an optical factor, an electrical factor, or the like. In that case, if data acquired by the sensor is directly used for the recognition processing, recognition accuracy is likely to be deteriorated. Alternatively, in order to perform the recognition processing with high accuracy, it is desirable to use high-definition image data. However, when the image data has high definition, not only information that is a target of the recognition processing but also information other than the target of the recognition processing, for example, it is likely that information concerning privacy and security such as a face and a fingerprint other than the target of the recognition processing are acquired with high accuracy and these kinds of information leak to outsiders.

Therefore, the present disclosure proposes an information processing system and a learning model generation method capable of applying, before performing recognition processing, preprocessing to image data acquired by a sensor or image data obtained by converting the image data and executing the recognition processing on information subjected to the preprocessing.

### Solution to Problem

To solve the problems described above, an information processing system according to an embodiment of the present disclosure includes a specifying unit that specifies a correction target pixel in a depth map using a first learning model and a correction unit that corrects the correction target pixel specified by the specifying unit.

To solve the problems described above, an information processing system according to an embodiment of the present disclosure includes a specifying unit that specifies a correction target pixel in a first image data using a first learning model and a correction unit that corrects the correction target pixel specified by the specifying unit.

### BRIEF DESCRIPTION OF DRAWINGS

FIG. 1 is a block diagram illustrating a schematic configuration example of an information processing system according to a first embodiment.

FIG. 2 is a block diagram illustrating a configuration example of an imaging unit according to the first embodiment.

FIG. 3 is a diagram illustrating a series of operation examples of the information processing system according to the first embodiment.

FIG. 4 is a diagram illustrating an example of corrected data input to recognition processing according to the first embodiment.

FIG. 5 is a diagram illustrating another example of the corrected data input to the recognition processing according to the first embodiment.

FIG. 6 is a diagram illustrating still another example of the corrected data input to the recognition processing according to the first embodiment.

FIG. 7 is a block diagram illustrating a schematic configuration example of an information processing system according to a modification 1 of the first embodiment.

FIG. 8 is a diagram illustrating a series of operation example of the information processing system according to the modification 1 of the first embodiment.

FIG. 9 is a diagram illustrating another series of operation example of the information processing system according to the modification 1 of the first embodiment.

FIG. 10 is a diagram illustrating a series of operation example of an information processing system according to a modification 2 of the first embodiment.

FIG. 11 is a block diagram illustrating a schematic configuration example of an information processing system according to a second embodiment.

FIG. 12 is a diagram illustrating an operation example of the information processing system according to the second embodiment.

FIG. 13 is a block diagram illustrating a schematic configuration example of an information processing system according to a modification of the second embodiment.

FIG. 14 is a block diagram illustrating a configuration example of an information processing system according to a first example of a third embodiment.

FIG. 15 is a block diagram illustrating a configuration example of an information processing system according to a second example of the third embodiment.

FIG. 16 is a block diagram illustrating a configuration example of an information processing system according to a third example of the third embodiment.

FIG. 17 is a block diagram illustrating a configuration example of an information processing system according to a fourth example of the third embodiment.

FIG. 18 is a block diagram illustrating a configuration example of an information processing system according to a fifth example of the third embodiment.

FIG. 19 is a block diagram illustrating a configuration example of an information processing system according to a sixth example of the third embodiment.

FIG. 20 is a block diagram illustrating a configuration example of an information processing system according to a seventh example of the third embodiment.

FIG. 21 is a block diagram illustrating a configuration example of an information processing system according to an eighth example of the third embodiment.

FIG. 22 is a block diagram illustrating a configuration example of an information processing system according to a ninth example of the third embodiment.

FIG. 23 is a block diagram illustrating a configuration example of an information processing system according to a tenth example of the third embodiment.

FIG. 24 is a block diagram illustrating a configuration example of an information processing system according to an eleventh example of the third embodiment.

FIG. 25 is a block diagram illustrating a configuration example of an information processing system according to a first example of a fourth embodiment.

FIG. 26 is a block diagram illustrating a configuration example of an information processing system according to a second example of the fourth embodiment.

FIG. 27 is a block diagram illustrating a configuration example of an information processing system according to a third example of the fourth embodiment.

FIG. 28 is a block diagram illustrating a configuration example of an information processing system according to a fourth example of the fourth embodiment.

FIG. 29 is a block diagram illustrating a configuration example of an imaging device according to the present disclosure.

FIG. 30 is a block diagram illustrating a configuration example of an imaging device according to a modification of the present disclosure.

FIG. 31 is a block diagram illustrating a schematic configuration example of an information processing system according to a first example of the present disclosure.

FIG. 32 is a diagram illustrating an example of image data acquired in the information processing system according to the first example of the present disclosure.

FIG. 33 is a diagram illustrating an example of image data corrected in the information processing system according to the first example of the present disclosure.

FIG. 34 is a diagram illustrating an example of image data displayed in the information processing system according to the first example of the present disclosure.

FIG. 35 is a block diagram illustrating a schematic configuration example of an information processing system according to a second example of the present disclosure.

FIG. 36 is a diagram illustrating a configuration example of a system including a device that performs AI processing.

FIG. 37 is a block diagram illustrating a configuration example of electronic equipment.

FIG. 38 is a block diagram illustrating a configuration example of an edge server or a Cloud server.

FIG. 39 is a block diagram illustrating a configuration example of an optical sensor.

FIG. 40 is a block diagram illustrating a configuration example of a processing unit.

FIG. 41 is a flowchart for explaining a flow of processing in which AI is used.

FIG. 42 is a flowchart for explaining a flow of correction processing.

FIG. 43 is a flowchart for explaining a flow of processing in which AI is used.

FIG. 44 is a flowchart for explaining a flow of learning processing.

FIG. 45 is a diagram illustrating a flow of data among a plurality of devices.

### DESCRIPTION OF EMBODIMENTS

Embodiments of the present disclosure are explained in detail below with reference to the drawings. Note that, in the embodiments explained below, redundant explanation is omitted by denoting the same parts with the same reference numerals and signs.

The present disclosure is explained according to the item order described below.
1. First Embodiment
1.1 Configuration example of an information processing system
1.2 Configuration example of an imaging unit
1.3 Operation example of the information processing system
1.4 Action and effects
1.5 Modification 1
1.6 Modification 2
1.7 Summary of the first embodiment and the modifications thereof
2. Second Embodiment
2.1 Configuration example of an information processing system
2.2 Operation example of the information processing system
2.3 Action and effects
2.4 Modifications
2.5 Summary of the second embodiment and modifications thereof
3. Third Embodiment
3.1 Configuration example of an information processing system
3.1.1 First example
3.1.2 Second example
3.1.3 Third example
3.1.4 Fourth example
3.1.5 Fifth example
3.1.6 Sixth example
3.1.7 Seventh example
3.1.8 Eighth example
3.1.9 Ninth example
3.1.10 Tenth example
3.1.11 Eleventh example
3.2 Action and effects
3.3 Summary of the third embodiment
4. Fourth Embodiment
4.1 Configuration example of an information processing system
4.1.1 First example
4.1.2 Second example
4.1.3 Third example
4.1.4 Fourth example
5. Specific configuration example of an imaging device
5.1 Modification of the imaging device
6. Use case
6.1 First example
6.2 Second example
7. Application example in which AI is used

### 1. First Embodiment

First, a first embodiment of the present disclosure is explained in detail with reference to the drawings. In the first embodiment, a case in which a TOF sensor is used as a sensor is illustrated.

### 1.1 Configuration Example of an Information Processing System

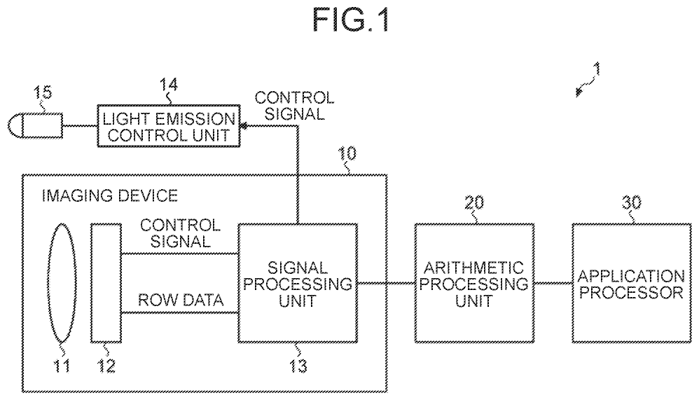

FIG. 1 is a block diagram illustrating a schematic configuration example of an information processing system according to the present embodiment. As illustrated in FIG. 1, an information processing system 1 according to the present embodiment includes an imaging device 10 that performs a light receiving operation and generates a depth map using a result of the light receiving operation, an arithmetic processing unit 20 that is a preprocessing unit that performs preprocessing on the depth map before recognition processing is performed on the depth map, and an application processor (AP) 30 that is a recognition processing unit that performs the recognition processing using information output by the preprocessing unit and outputs obtained information.

The imaging device 10 includes a lens 11, an imaging unit 12, and a signal processing unit 13. A light emitting system including a light emitting unit 15 and a light emission control unit 14 is connected to the imaging device 10. The light emitting system including the light emission control unit 14 and the light emitting unit 15 may be disposed in a housing of the imaging device 10 or may be disposed outside the housing of the imaging device 10. Note that, in the present disclosure, a part configuring the imaging device 10 and including at least the imaging unit 12 and the signal processing unit 13 is referred to as imaging processing unit for convenience.

The light emission control unit 14 outputs irradiation light (for example, infrared (IR) light) with the light emitting unit 15 according to a control signal from the signal processing unit 13. For example, when a control signal for instructing light emission is input from the signal processing unit 13, the light emission control unit 14 causes the light emitting unit 15 to emit light in synchronization with a predetermined cycle set in advance or an input cycle of the control signal.

The imaging device 10 measures the distance to an object by receiving light (reflected light) of irradiation light emitted from the light emitting unit 15 and reflected by the object to return to the light emitting unit 15. At that time, an IR bandpass filter may be provided between the lens 11 and the imaging unit 12 and the light emitting unit 15 may emit infrared light corresponding to a transmission wavelength band of the IR bandpass filter.

Note that the TOF sensor configured by the imaging device 10 and the light emitting system may be a dTOF sensor of a direct TOF scheme that calculates the distance to an object based on an elapsed time from light emission of the light emitting unit 15 until detection of reflected light by the imaging unit 12 or may be an iTOF sensor of an indirect TOF scheme that calculates the distance to an object from a phase of the reflected light of pulsed irradiation light output from the light emitting unit 15 and reflected by the object to return to the light emitting unit 15. As a sensor that performs light reception corresponding to phase, for example, the iTOF sensor may perform light reception with a phase delay of 90 degrees, light reception with a phase delay of 180 degrees, and light reception with a phase delay of 270 degrees based on light reception with a phase delay of 0 degrees for receiving light without deviation from a phase on an irradiation side. Instead of the TOF sensor configured by the imaging device 10 and the light emitting system, various sensors capable of acquiring distance information about points (for example, corresponding to pixels) distributed one-dimensionally or two-dimensionally such as an ultrasonic sensor or a millimeter wave radar may be used.

The signal processing unit 13 executes various kinds of signal processing on row data output from the imaging unit 12. For example, when the imaging device 10 and the light emitting system configure the iTOF sensor, the signal processing unit 13 executes processing such as noise removal and white balance adjustment on the row data according to necessity.

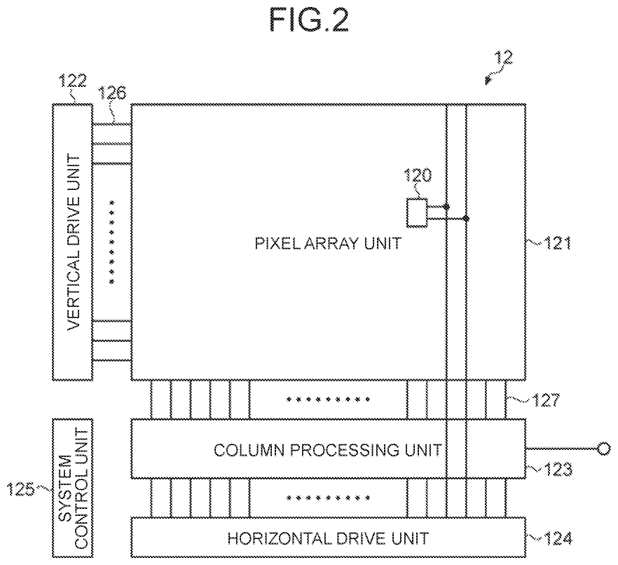

The signal processing unit 13 also operates as a calculation unit that calculates the distance (a depth value) from the imaging device 10 to the object based on the row data (pixel data) supplied from the imaging unit 12. The signal processing unit 13 generates a depth map (also referred to as depth image or distance measurement image) in which depth values (depth information) are stored as pixel values of pixels 120 (see FIG. 2) of the imaging unit 12 and outputs the depth map to the arithmetic processing unit 20. At that time, the signal processing unit 13 may also calculate, for the pixels 120 of the imaging unit 12, reliability of the calculated depth values, generate a reliability map storing the reliability (luminance information) as the pixel values of the pixels 120 of the imaging unit 12, and output the reliability map to the arithmetic processing unit 20.

Note that the imaging device 10 may have a configuration in which the imaging unit 12 and the signal processing unit 13 are disposed on different semiconductor chips or may have a configuration in which the imaging unit 12 and the signal processing unit 13 are disposed on a single semiconductor chip. Further, the single semiconductor chip on which the imaging unit 12 and the signal processing unit 13 are disposed may be a stacked chip in which a semiconductor chip on which the imaging unit 12 is disposed and a semiconductor chip on which the signal processing unit 13 is disposed are bonded together.

Furthermore, the processing executed by the signal processing unit 13 may be executed using a DNN (Deep Neural Network), a CNN (Convolutional Neural Network), an RNN (Recurrent Neural Network), a GAN (Generative Adversarial Network), or an auto encoder or may be executed using a dedicated chip such as an image signal processor (ISP). When the machine learning is used, the signal processing unit 13 may be configured by a processing device such as a DSP (Digital Signal Processor) or a CPU (Central Processing Unit).

The arithmetic processing unit 20, which is a preprocessing unit, performs preprocessing on the depth map generated by the imaging device 10 before the application processor 30, which is a recognition processing unit, performs recognition processing on the depth map. The arithmetic processing unit 20 includes a machine learning processing unit that executes at least a part of the preprocessing using the machine learning. The machine learning processing unit executes processing for specifying a pixel having predetermined information or a pixel included in a region having the predetermined information in the depth map using the machine learning. The arithmetic processing unit 20 is configured by a processing device such as a DSP or a CPU. The arithmetic processing unit 20 specifies, with respect to the depth map output from the signal processing unit 13, a pixel (hereinafter referred to as target pixel) to be corrected and executes correction of a pixel value (in the present embodiment, a depth value) for the specified pixel. At least a part of these kinds of processing performed by the arithmetic processing unit 20 may be executed using the machine learning such as the DNN, the CNN, the RNN, the GAN, or the auto encoder. The arithmetic processing unit 20 may include, as hardware the processing, a processor for executing a learned network and a memory in which learned parameters are stored. The specifying and the correction of the target pixel are explained in detail below.

For example, the application processor (is also referred to as information processing unit or recognition processing unit) 30 may execute, on the depth map in which the target pixel is corrected, various kinds of processing such as recognition processing for recognizing an object present in the depth map or movement of the object. At least a part of these kinds of processing performed by the application processor 30 may be executed using the machine learning such as the DNN, the CNN, the RNN, the GAN, or the auto encoder (a machine learning recognition processing unit). The application processor 30 may include, as hardware the processing, a processor for executing a learned network and a memory in which learned parameters are stored. Alternatively, at least a part of the processing explained above performed by the application processor 30 may be executed based on an algorithm or the like prepared in advance (a non-machine learning recognition processing unit). The application processor 30 may include hardware for that purpose. The application processor 30 may output the depth map before processing or after the processing to an external device such as a Cloud server via a predetermined network.

### 1.2 Configuration Example of an Imaging Unit

FIG. 2 is a block diagram illustrating a configuration example of the imaging unit according to the present embodiment. Note that, in the present embodiment, a case in which the imaging unit 12 is a CMOS (Complementary Metal Oxide Semiconductor) image sensor is illustrated. However, not only this, but various image sensors such as a CCD (Charge-Coupled Device) image sensor can be used.

The imaging unit 12 includes a pixel array unit 121, a vertical drive unit 122, a column processing unit 123, a horizontal drive unit 124, and a system control unit 125. The pixel array unit 121, the vertical drive unit 122, the column processing unit 123, the horizontal drive unit 124, and the system control unit 125 are formed on a not-illustrated semiconductor substrate (chip).

In the pixel array unit 121, pixels 120 including photoelectric conversion elements that generate photoelectric charges having a charge amount corresponding to an amount of incident light are two-dimensionally arranged in a matrix and stores the photoelectric charges on the inside. Note that, in the following explanation, the photoelectric charge having the charge amount corresponding to the amount of incident light is simply described as “charge”.

In the pixel array unit 121, with respect to the pixel array in the matrix, a pixel drive line 126 is further formed for each of rows along the left-right direction (an array direction of pixels in a pixel row) in the figure and a vertical signal line 127 is formed for each of columns along the up-down direction (an array direction of pixels in a pixel column) in the figure. One end of the pixel drive line 126 is connected to output ends corresponding to the rows of the vertical drive unit 122.

The vertical drive unit 122 is a pixel drive unit that is configured by a shift register, an address decoder, and the like and drives the pixels of the pixel array unit 121 simultaneously for all the pixels or in units of rows. Pixel signals output from the pixels 120 of a pixel row selectively scanned by the vertical drive unit 122 are supplied to the column processing unit 123 through each of vertical signal lines 127. The column processing unit 123 performs, for each of pixel columns of the pixel array unit 121, predetermined signal processing on the pixel signals output from the pixels 120 of the selected row through the vertical signal lines 127 and temporarily holds the pixel signals after the signal processing.

Specifically, the column processing unit 123 can execute, for example, CDS (Correlated Double Sampling) processing as the signal processing. By the CDS processing by the column processing unit 123, fixed pattern noise specific to pixels such as reset noise or threshold variation of an amplification transistor is removed. Note that it is also possible to impart, for example, an AD (Analog-to-Digital) function to the column processing unit 123 other than the noise removal processing and output a signal level as a digital signal.

The horizontal drive unit 124 configured by a shift register, an address decoder, and the like and sequentially selects unit circuits corresponding to pixel columns of the column processing unit 123. By this selective scanning by the horizontal drive unit 124, pixel signals subjected to the signal processing by the column processing unit 123 are sequentially output to the signal processing unit 13.

The system control unit 125 is configured by a timing generator and the like that generates various timing signals and performs drive control of the vertical drive unit 122, the column processing unit 123, the horizontal drive unit 124, and the like based on various timing signals generated by the timing generator.

In the pixel array unit 121, the pixel drive line 126 is wired in the row direction for each of pixel rows and two vertical signal lines 127 are wired in the column direction for the pixel columns with respect to the pixel array in the matrix. For example, the pixel drive line 126 transmits a drive signal for performing driving when reading a signal from a pixel. Note that, in FIG. 2, the pixel drive line 126 is illustrated as one wire but is not limited to one wire. One end of the pixel drive line 126 is connected to output ends corresponding to the rows of the vertical drive unit 122.

### 1.3 Operation Example of the Information Processing System

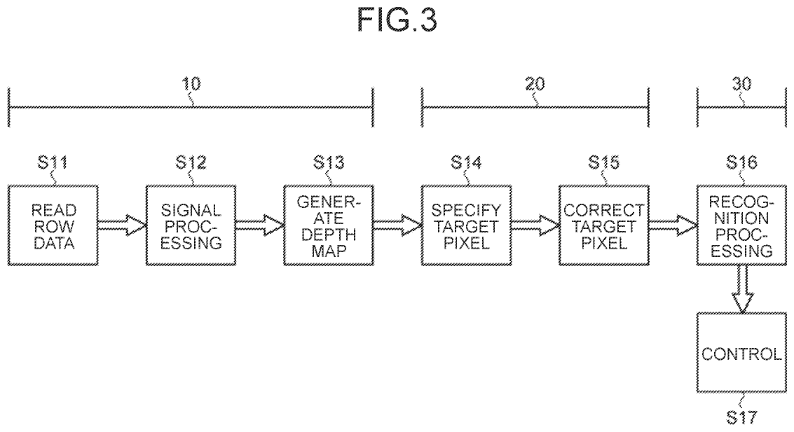

Next, an operation example of the information processing system 1 according to the present embodiment is explained in detail with reference to the drawings. FIG. 3 is a diagram illustrating a configuration example of the information processing system according to the present embodiment.

As illustrated in FIG. 3, in step S11, first, a light receiving operation by the imaging unit 12 and reading of row data, which is a light receiving result, are executed. For example, when the imaging device 10 configures the dTOF sensor, the row data may be, for example, image data in which pixel signals indicating presence or absence of detection of reflected light detected in the pixels 120 are arrayed in a matrix. However, when the pixel 120 is a so-called SPAD (Single Photon Avalanche Diode) pixel, the row data may be, for example, image data in which the number of pixels, which detected the reflected light, counted for each of regions divided by a predetermined number of pixels 120 is set as a pixel signal. When the imaging device 10 configures the iTOF sensor, the row data may be, for example, image data in which pixel signals indicating amounts of reflected light made incident on the pixels 120 in respective phases are arrayed in a matrix.

In step S12, the signal processing unit 13 executes predetermined signal processing (also referred to as preprocessing) such as noise removal on the row data output from the imaging unit 12. In the following explanation, row data subjected to preprocessing is referred to as image data.

In step S13, the signal processing unit 13 generates a depth map by using the preprocessed image data. Note that the generation of the depth map is not limited to be generated using one piece of image data and may be generated using a plurality of pieces of image data. That is, the light emitting unit 15 may be caused to periodically emit light for a plurality of times (for example, several thousand times or more) and one depth map may be generated using image data acquired for respective times of the light emission. Here, in FIG. 3, reference numeral 10 described above S11 to S13 indicates that the processing in S11 to S13 is executed in the imaging device 10.

Note that, as explained above, the processing in steps S12 and S13 executed by the signal processing unit 13 may be executed using machine learning or may be executed using a dedicated chip.

Before the application processor 30, which is the recognition processing unit, performs the recognition processing (step S16) on the depth map generated in step S13, the arithmetic processing unit 20 performs preprocessing on the depth map in step S14. The arithmetic processing unit 20 includes a machine learning processing unit that executes at least part of the preprocessing using machine learning. The machine learning processing unit executes, using the machine learning, processing for specifying a pixel having predetermined information or a pixel included in a region having the predetermined information in the depth map.

As an example, the predetermined information may be information generated by, in the information processing system 1, among factors that affect data of the depth map generated by the imaging processing unit,
a factor of being other than a subject that is a target imaged by the imaging processing unit and a factor of being other than an optical path connecting the imaging processing unit and the subject with a straight line, and
an optical or electrical factor in the system,
and written in the depth map generated by the imaging processing unit. Alternatively, the predetermined information may be noise that occurred in the light receiving operation and is due to an electrical factor or an optical factor, variation in a light receiving result due to an electrical factor or an optical factor, or information erroneously detected because of an electrical factor or an optical factor. These kinds of predetermined information may be, for example, a so-called defective pixel (also referred to as error pixel) having a value different from an original value in the depth map. More specifically, the predetermined information may be, for example, a flying pixel or a pixel affected by noise (hereinafter referred to as noise pixel as well).

Alternatively, as another example, the predetermined information may be information different from information obtained by the recognition processing, the information being information concerning a subject in the depth map generated by the imaging processing unit, and, in particular, may be information relating to privacy or security of the subject in the depth map. This information may be, for example, regions for target objects relating to security or privacy (hereinafter referred to as specific regions as well) or pixels included in these regions. More specifically, the information may be, for example, in a system that recognizes a suspicious person near an ATM (Automatic Teller Machine), a region where an input key is displayed on an operation screen of the ATM that is not a recognition target, a region for a face, a palm, a finger, or the like of a person who operates the ATM, or pixels included in these regions. Alternatively, the information may be, in a system that measures a traffic volume of cars and people on a road, information more detailed than recognition of a car or a person, for example, a region for a license plate of a car or the like or a face of a driver, or pixels included in these regions. Alternatively, the information may be, in a system that monitors a residence for crime prevention, information concerning other than a monitoring target residence, for example, a region for an object that can specify an address of the monitoring target residence such as a surrounding house other than the monitoring target residence, a signboard, or a sign, or pixels included in these regions.

Alternatively, in step S14, the arithmetic processing unit 20 may specify a correction target pixel (a target pixel) in the depth map generated in step S13. Here, the pixels in the depth map may be pixels each having a depth value up to the target object. The correction target pixel in the present embodiment may be variously modified according to a target, a purpose, or the like to which the information processing system 1 according to the present embodiment is applied. As an example, the correction target pixel in the present embodiment may be a so-called defective pixel (also referred to as error pixel) having a value different from an original value or, as another example, may be a pixel included in a region for a target object relating to security or privacy. For example, when the target pixel is the defective pixel, the target pixel may be a flying pixel, a pixel affected by noise (hereinafter referred to as noise pixel as well), or the like. For example, when the target pixel is a pixel included in a region (hereinafter referred to as specific region as well) for the target object relating to security and privacy, the target object relating to security and privacy may be a region in which an input key is displayed on an operation screen of an ATM (Automatic Teller Machine), a face and a palm of a person, a license plate of a car or the like, an object capable of specifying an address such as a surrounding house other than an own house, a signboard, or a sign, or the like.

In addition, in the present embodiment, in step S14, the arithmetic processing unit 20 may specify a target pixel using the machine learning such as the DNN, the CNN, the RNN, the GAN, or the auto encoder. Learning of a learning model used in the machine learning may be supervised learning or unsupervised learning. In the case of the supervised learning, for example, teacher data including, as a data set, a depth map to be input and a target pixel for each purpose to be output may be used for the learning of the learning model. However, when the auto encoder is adopted, a model may be trained by the unsupervised learning. The learning of the learning model may be executed in the arithmetic processing unit 20, may be executed in the application processor 30, or may be executed in an external server (including a Cloud server) or the like. In that case, the target pixel for each purpose, which is correct answer data in the teacher data, may be, for example, a pixel artificially specified in an external server (including a Cloud server) that trains a learning model, or may be a pixel obtained by inference in which a learning model in the past is used.

The machine learning processing unit included in the arithmetic processing unit 20 includes a supervised learning processing unit that has performed supervised learning or an unsupervised learning processing unit that has performed unsupervised learning as a processing unit that executes, using machine learning, processing for specifying, in the depth map, a pixel (a target pixel) having predetermined information or a pixel (a target pixel) included in a region (for example, a specific region) having the predetermined information.

The supervised learning processing unit includes, for example, a DNN. The DNN included in the supervised learning processing unit is a DNN that has performed learning using, as teacher data, for example, (1) both a depth map including a pixel having the predetermined information and position information of the pixel, or (2) a depth map explicitly indicating the pixel having the predetermined information. The supervised learning processing unit receives, as input, the depth map generated by the imaging processing unit and outputs, as output, a result of specifying, in the depth map, the pixel having the predetermined information or the pixel included in a region having the predetermined information.

The unsupervised learning processing unit includes, for example, an auto encoder and a comparator. The auto encoder is an auto encoder that has performed learning using a depth map not including the predetermined information. The unsupervised learning processing unit receives, as input, the depth map generated by the imaging processing unit and outputs, as output, a result of specifying a pixel in which a difference between the depth map generated by the imaging processing unit and the depth map on which the learning has been performed is a predetermined threshold or more.

In the information processing system 1 according to the present embodiment, as explained with reference to FIG. 1 and FIG. 3, the machine learning processing unit includes, as a processing unit that executes the specifying processing using the machine learning, a supervised learning processing unit that has performed supervised learning or an unsupervised learning processing unit that has performed unsupervised learning.

The supervised learning processing unit includes a neural network.

The neural network included in the supervised learning processing unit is a neural network that has performed learning using, as teacher data,
both of a depth map including a pixel having the predetermined information and position information of the pixel, or
a depth map explicitly indicating the pixel having the predetermined information.

The supervised learning processing unit
receives, as input, the depth map generated by the imaging processing unit, ad
outputs, as output, a result of specifying, in the depth map, a pixel having predetermined information or a pixel included in a region having the predetermined information.

The supervised learning processing unit may use a learning model generation method for, to generate, as a learning model, a learning model for “in a use stage of the supervised learning processing unit, receiving, as input, a depth map generated by the imaging processing unit and outputting, as output, a result of specifying, in the depth map, a pixel having predetermined information or a pixel included in a region having the predetermined information”,
in a learning stage of the supervised learning processing unit,
“performing learning using, as teacher data, both of a depth map including a pixel having the predetermined information and position information of the pixel or a depth map explicitly indicating the pixel having the predetermined information to thereby generate the learning model”.

The unsupervised learning processing unit includes an auto encoder and a comparator.

The auto encoder is an auto encoder that has performed learning using a depth map not including the predetermined information.

The unsupervised learning processing unit
receives, as input, the depth map generated by the imaging processing unit, and
outputs, as output, a result of specifying a pixel in which a difference between the depth map generated by the imaging processing unit and the depth map on which the learning has been performed is a predetermined threshold or more.

The unsupervised learning processing unit may use a learning model generation method for, to generate, as a learning model, a learning model for “in a use stage of the unsupervised learning processing unit, receiving, as input, the depth map generated by the imaging processing unit and outputting, as output, a result of specifying a pixel in which a difference between the depth map generated by the imaging processing unit and the depth map on which the learning is performed is a predetermined threshold or more”,
in learning stage of the unsupervised learning processing unit,
“performing learning using a depth map not including the predetermined information to thereby generate the learning model”.

In step S15, the arithmetic processing unit 20 executes correction on the target pixel specified in step S14. The correction of the depth value of the target pixel may be executed using the machine learning such as the DNN, the CNN, the RNN, the GAN, or the auto encoder or may be executed based on an algorithm or the like prepared in advance. In the latter case based on the algorithm or the like (hereinafter referred to as rule base), for example, if the defective pixel is specified as the target pixel in step S14, the arithmetic processing unit 20 may correct the depth value of the target pixel to generate a depth map in which the influence by the flying pixel and the noise is reduced. On the other hand, if a pixel included in the specific region is specified as the target pixel, for example, the arithmetic processing unit 20 may replace the depth value of the pixel included in the specific region with, for example, a predetermined value (such as ‘0’ or ‘255’) or an average value of depth values of pixels included in the region to execute processing such as masking on the specific region. Here, in FIG. 3, reference numeral 20 described above S14 and S15 indicates that the processing of S14 and S15 is executed in the arithmetic processing unit 20.

In step S16, recognition processing for the depth map in which the target pixel is corrected is executed. This recognition processing may be executed using the machine learning such as the DNN, the CNN, the RNN, the GAN, or the auto encoder or may be executed based on an algorithm or the like prepared in advance.

The recognition processing executed in step S16 may be processing such as suspicious person detection, person detection, object recognition, terrain recognition, and vegetation recognition. In addition, the processing in step S16 may be executed in the application processor 30 or may be executed by an external processing device such as a Cloud server on a predetermined network. Note that the processing executed in step S16 is not limited to the recognition processing and various kinds of processing may be executed.

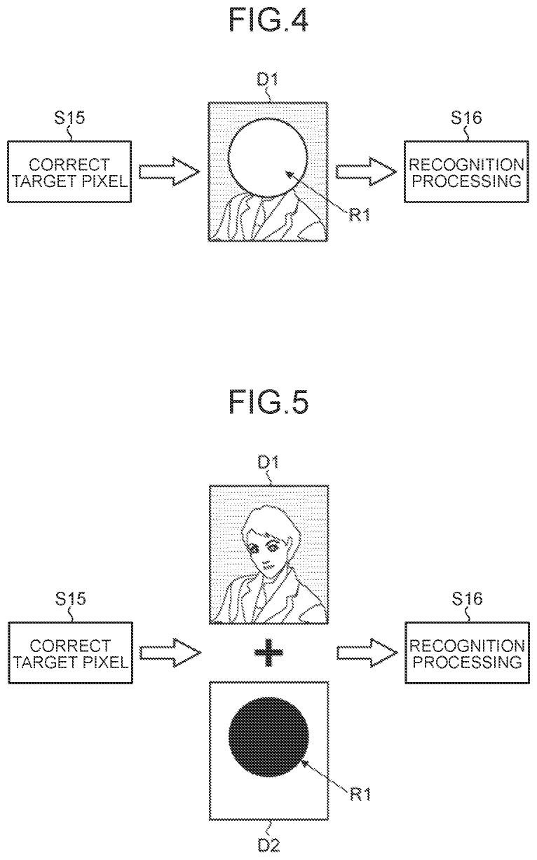

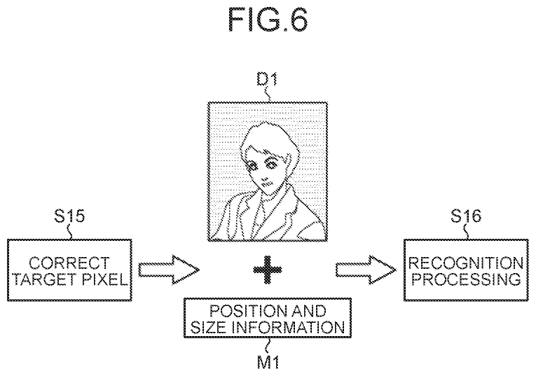

Note that the data input to the recognition processing (S16) may be correction data of a target pixel included in a region R1 in a depth map D1 as illustrated in FIG. 4, may be a combination of the depth map D1 output from the signal processing unit 13 and data D2, which is image data or graphic data for designating the region R1 of the target pixel in the depth map in units of pixels as illustrated in FIG. 5, or may be a combination of the depth map D1 output from the signal processing unit 13 and metadata for designating a position and a size of the region R1 of the target pixel in the depth map as illustrated in FIG. 6.

In other words, in the information processing system 1 according to the present embodiment, as illustrated in FIG. 4, the preprocessing unit may perform processing for changing, as information to be input to the recognition processing unit, data of the specified pixel in the depth map generated by the imaging processing unit to another value using data of pixels arranged around the pixel and input the depth map after the changing processing to the recognition processing unit.

The recognition processing unit may include a machine learning recognition processing unit that executes the recognition processing using machine learning.

The machine learning recognition processing unit may be a second machine learning processing unit that has performed learning using a depth map including an object to be a target of the recognition processing.

Alternatively, in the information processing system 1 according to the present embodiment, as illustrated in FIG. 4, the preprocessing unit may perform processing for changing, as information to be input to the recognition processing unit, data of the specified pixel in the depth map generated by the imaging processing unit to a predetermined value to indicate that the pixel is the specified pixel and input the depth map after the change processing to the recognition processing unit.

The recognition processing unit may include a machine learning recognition processing unit that executes the recognition processing using machine learning.

The machine learning recognition processing unit may be a second machine learning processing unit that has performed learning using a depth map including an object to be a target of the recognition processing.

Note that the value determined in advance to indicate that the pixel is the specified pixel may be, for example, a minimum value or a maximum value as a value of the pixel or a value close thereto.

Alternatively, in the information processing system 1 according to the present embodiment, as illustrated in FIG. 5, the preprocessing unit may input, as information to be input to the recognition processing unit, to the recognition processing unit, both of (1) the depth map generated by the imaging processing unit and (2) two-dimensional image data, the two-dimensional image data being a figure or image data indicating a position of the specified pixel in the depth map generated by the imaging processing unit.

The recognition processing unit may include a machine learning recognition processing unit that executes the recognition processing using machine learning.

The machine learning recognition processing unit may be a second machine learning processing unit that performs learning using both of a depth map including an object to be a target of the recognition processing and two-dimensional image data representing a position of the specified pixel.

Alternatively, in the information processing system 1 according to the present embodiment, as illustrated in FIG. 6, the preprocessing unit may input, as information to be input to the recognition processing unit, to the recognition processing unit, both of (1) the depth map generated by the imaging processing unit and (2) coordinate data representing the specified pixel position.

The recognition processing unit may include a machine learning recognition processing unit that executes the recognition processing using machine learning.

The machine learning recognition processing unit may be a second machine learning processing unit that has performed learning using both of a depth map including an object to be a target of the recognition processing and coordinate data indicating a position of the specified pixel.

In step S17, predetermined control may be executed based on a result of the recognition processing or the like in step S16. For example, when the suspicious person detection has been executed in step S16, control such as generation of an alert to a user, a management company, and the like, storage of image data obtained by imaging a person detected as a suspicious person, and transmission to an external processing device may be executed. When the person detection has been executed in step S16, control such as counting of the number of people may be executed. When the object recognition and the terrain recognition have been executed in step S16, control such as generation of an alert at the time of danger and construction machine control may be executed. When the terrain recognition and the vegetation recognition have been executed in step S16, control such as grasping of terrain, analysis of a vegetation/growth state, and spraying of pesticide/fertilizer/water may be executed.

### 1.4 Action and Effects

As explained above, according to the present embodiment, since processing (correction) for the depth map, which is the data acquired by the sensor, is executed before the processing such as the recognition processing for the depth map is executed, it is possible to achieve improvement of image quality deteriorated because of an optical factor, an electrical factor, or the like, prevention of leakage of information relating to security and privacy, and the like.

### 1.5 Modification 1

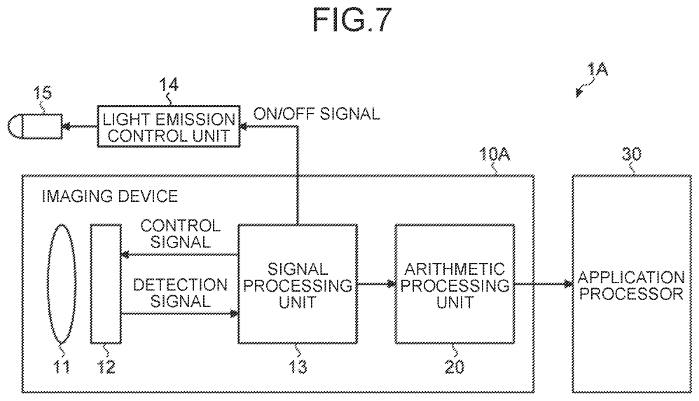

Note that, in the embodiment explained above, a case is illustrated in which the arithmetic processing unit 20 is provided outside the imaging device 10. However, not only this, but, for example, as in an information processing system 1A illustrated in FIG. 7, the arithmetic processing unit 20 may be included in an imaging device 10A. In that case, the arithmetic processing unit 20 may be disposed in a semiconductor chip different from the semiconductor chip on which the imaging unit 12 and/or the signal processing unit 13 are disposed or may be disposed on the same semiconductor chip as the semiconductor chip on which the imaging unit 12 and/or the signal processing unit 13 are arranged. In that case, in the arithmetic processing unit 20, the semiconductor chip on which the imaging unit 12 and/or the signal processing unit 13 and the arithmetic processing unit 20 are disposed may be a stacked chip formed by bonding a plurality of semiconductor chips.

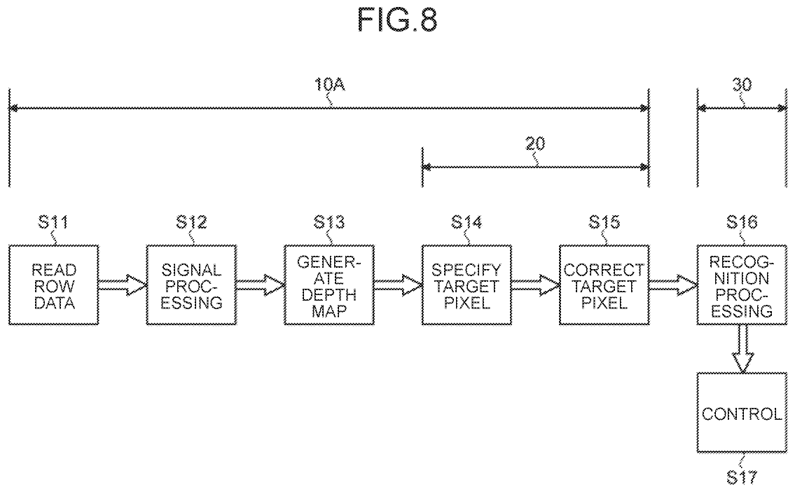

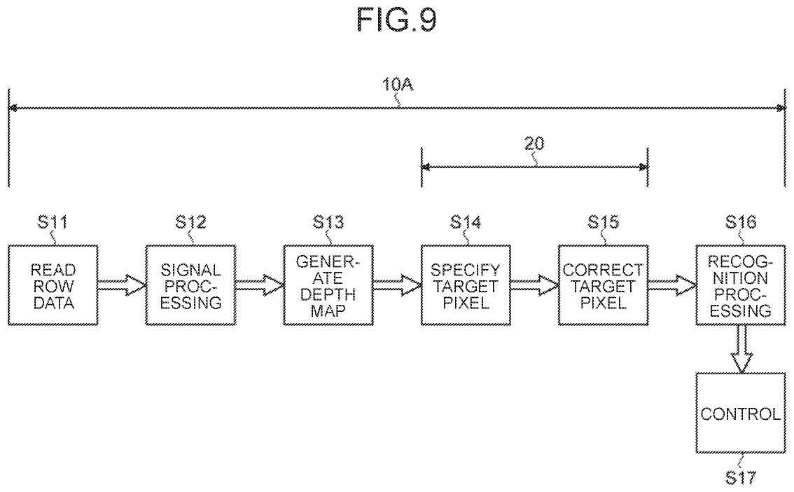

When the arithmetic processing unit 20 is included in the imaging device 10A as in the present modification, as illustrated in FIG. 8, steps S11 to S15 may be executed by the imaging device 10A and step S16 (and step S17) may be executed by the application processor 30, an external processing device, or the like. For example, an application or an external processing device in which the imaging device 10A and the arithmetic processing unit 20 are disposed on the inside of some housing and execute step S16 (the recognition processing) may be disposed on the inside of a housing different from the housing or on the Cloud via wired communication means or wireless communication means. As illustrated in FIG. 9, all of steps S11 to S16 (or S17) may be executed by the imaging device 10A. Note that, in the case of FIG. 9 in which the imaging device 10A executes step S16 (and step S17), the processing in step S16 (and step S17) may be executed in the arithmetic processing unit 20 or the signal processing unit 13.

### 1.6 Modification 2

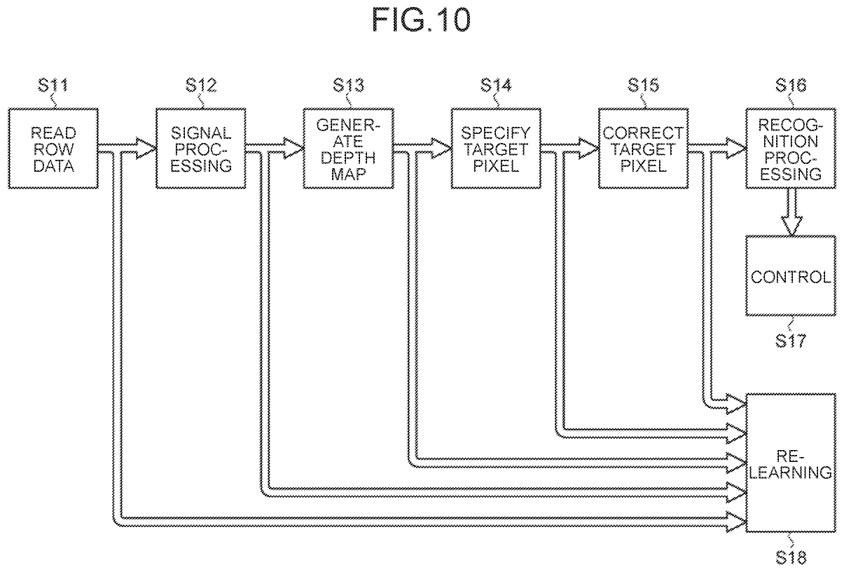

As explained in the first embodiment, at least one of the kinds of processing in steps S12 to S16 in FIG. 3, FIG. 8, or FIG. 9 may be executed using machine learning. In that case, as illustrated in FIG. 10, the data input to a step executed using the machine learning among the kinds of processing in steps S12 to S16 may be input not only to the step but also to an external processing device such as a Cloud server. In the external processing device, teacher data may be created using the input data and relearning of a learning model used in the step may be executed by using the created teacher data (step S18).

### 1.7 Summary of the First Embodiment and the Modifications Thereof

The contents of the first embodiment of the present disclosure and the modifications thereof explained above are summarized.

As explained with reference to FIG. 1 and FIG. 3, the information processing system 1 according to the present embodiment includes
the imaging processing unit (the imaging unit 12 and the signal processing unit 13) that performs a light receiving operation and generates a depth map using a result of the light receiving operation,
the preprocessing unit (the arithmetic processing unit 20) that performs preprocessing on the depth map before recognition processing is performed on the depth map, and
the recognition processing unit (the application processor 30) that performs the recognition processing using information output by the preprocessing unit and outputs obtained information.

The preprocessing unit includes the machine learning processing unit that executes at least a part of the preprocessing using machine learning.

The machine learning processing unit executes processing for specifying a pixel having predetermined information or a pixel included in a region having the predetermined information in the depth map using the machine learning. (Step S14)

As an example, in the system, the predetermined information may be information generated by, among factors that affect data of the depth map generated by the imaging processing unit,
a factor of being other than a subject, which is a target imaged by the imaging processing unit, and a factor of being other than an optical path connecting the imaging processing unit and the subject with a straight line, and
an optical or electrical factor in the system,
and written in the depth map generated by the imaging processing unit. Alternatively, the predetermined information may be noise that occurred in the light receiving operation and is due to an electrical factor or an optical factor, variation in a light receiving result due to an electrical factor or an optical factor, or information erroneously detected because of an electrical factor or an optical factor. These kinds of predetermined information may be, for example, a so-called defective pixel (also referred to as error pixel) having a value different from an original value in the depth map. More specifically, the predetermined information may be, for example, a flying pixel or a pixel affected by noise (hereinafter referred to as noise pixel as well).

Alternatively, as another example, the predetermined information may be information different from information obtained by the recognition processing, the information being information concerning a subject in the depth map generated by the imaging processing unit, and, in particular, may be information relating to privacy or security of the subject in the depth map. This information may be, for example, regions for target objects relating to security or privacy (hereinafter referred to as specific regions as well) or pixels included in these regions. More specifically, the information may be, for example, in a system that recognizes a suspicious person near an ATM (Automatic Teller Machine), a region where an input key is displayed on an operation screen of the ATM that is not a recognition target, a region for a face, a palm, a finger, or the like of a person who operates the ATM, or pixels included in these regions. Alternatively, the information may be, in a system that measures a traffic volume of cars and people on a road, information more detailed than recognition of a car or a person, for example, a region for a license plate of a car or the like or a face of a driver, or pixels included in these regions. Alternatively, the information may be, in a system that monitors a residence for crime prevention, information concerning other than a monitoring target residence, for example, a region for an object that can specify an address of the monitoring target residence such as a surrounding house other than the monitoring target residence, a signboard, or a sign, or pixels included in these regions. (Step S14)

In the information processing system 1 according to the present embodiment, as explained with reference to FIG. 1 and FIG. 3, the machine learning processing unit includes, as the processing unit that executes the specifying processing using the machine learning, the supervised learning processing unit that has performed the supervised learning or the unsupervised learning processing unit that has performed the unsupervised learning.

The supervised learning processing unit includes a neural network.

The neural network included in the supervised learning processing unit is a neural network that has performed learning using, as teacher data,
both of a depth map including a pixel having the predetermined information and position information of the pixel, or
a depth map explicitly indicating the pixel having the predetermined information.

The supervised learning processing unit
receives, as input, the depth map generated by the imaging processing unit, ad
outputs, as output, a result of specifying, in the depth map, a pixel having predetermined information or a pixel included in a region having the predetermined information.

The unsupervised learning processing unit includes an auto encoder and a comparator.

The auto encoder is an auto encoder that has performed learning using a depth map not including the predetermined information.

The unsupervised learning processing unit
receives, as input, the depth map generated by the imaging processing unit, and
outputs, as output, a result of specifying a pixel in which a difference between the depth map generated by the imaging processing unit and the depth map on which the learning has been performed is a predetermined threshold or more.

Further, in the information processing system 1 according to the present embodiment, as explained with reference to FIG. 4, the preprocessing unit may perform processing for changing, as information to be input to the recognition processing unit, data of the specified pixel in the depth map generated by the imaging processing unit to another value using data of pixels arranged around the pixel and input the depth map after the change processing to the recognition processing unit.

The recognition processing unit may include a machine learning recognition processing unit that executes the recognition processing using machine learning.

The machine learning recognition processing unit may be a second machine learning processing unit that has performed learning to receive, as input, a depth map including an object to be a target of the recognition processing and output a recognition result of the object to be the target of the recognition processing.

Alternatively, in the information processing system 1 according to the present embodiment, as explained with reference to FIG. 4, the preprocessing unit may perform processing for changing, as information to be input to the recognition processing unit, data of the specified pixel in the depth map generated by the imaging processing unit to a predetermined value to indicate that the pixel is the specified pixel and input the depth map after the change processing to the recognition processing unit.

The recognition processing unit may include a machine learning recognition processing unit that executes the recognition processing using machine learning.

The machine learning recognition processing unit may be a second machine learning processing unit that has performed learning to receive, as input, a depth map including an object to be a target of the recognition processing and output a recognition result of the object to be the target of the recognition processing.

Note that the value determined in advance to indicate that the pixel is the specified pixel may be, for example, a minimum value or a maximum value as a value of the pixel or a value close thereto.

Alternatively, in the information processing system 1 according to the present embodiment, as explained with reference to FIG. 5, the preprocessing unit may input, as information to be input to the recognition processing unit, to the recognition processing unit, both of (1) the depth map generated by the imaging processing unit and (2) two-dimensional image data, the two-dimensional data being a figure or image data indicating a position of the specified pixel in the depth map generated by the imaging processing unit.

The recognition processing unit may include a machine learning recognition processing unit that executes the recognition processing using machine learning.

The machine learning recognition processing unit may be a second machine learning processing unit that has performed learning to receive, as input, both of a depth map including an object to be a target of the recognition processing and two-dimensional image data representing a position of the specified pixel and output a recognition result of the object to be the target of the recognition processing.

Alternatively, in the information processing system 1 according to the present embodiment, as explained with reference to FIG. 6, the preprocessing unit may input, as information to be input to the recognition processing unit, to the recognition processing unit, both of (1) the depth map generated by the imaging processing unit and (2) coordinate data representing the specified pixel position.

The recognition processing unit may include a machine learning recognition processing unit that executes the recognition processing using machine learning.

The machine learning recognition processing unit may be a second machine learning processing unit that has performed learning to receive, as input, both of a depth map including an object to be a target of the recognition processing and coordinate data representing a position of the specified pixel and output a recognition result of the object to be the target of the recognition processing.

Alternatively, like the information processing system 1A according to the modification 1 explained with reference to FIG. 10, the information processing system 1 of the disclosure according to the present embodiment may perform relearning of the neural network of the supervised learning processing unit or relearning of the auto encoder of the unsupervised learning processing unit using the depth map generated by the imaging processing unit and the information concerning the specified pixel.

Further, in the information processing system 1 according to the present embodiment, as explained with reference to FIG. 1 and FIG. 3, the supervised learning processing unit may use a learning model generation method for, to generate, as a learning model, a learning model for “in a use stage of the supervised learning processing unit, receiving, as input, a depth map generated by the imaging processing unit and outputting, as output, a result of specifying, in the depth map, a pixel having predetermined information or a pixel included in a region having the predetermined information”,
in a learning stage of the supervised learning processing unit,
“performing learning using, as teacher data, both of a depth map including a pixel having the predetermined information and position information of the pixel or a depth map explicitly indicating the pixel having the predetermined information to thereby generate the learning model”.

Further, in the information processing system 1 according to the present embodiment, as explained with reference to FIG. 1 and FIG. 3, the unsupervised learning processing unit may use a learning model generation method for, to generate, as a learning model, a learning model for “in a use stage of the unsupervised learning processing unit, receiving, as input, the depth map generated by the imaging processing unit and outputting, as output, a result of specifying a pixel in which a difference between the depth map generated by the imaging processing unit and the depth map on which the learning is performed is a predetermined threshold or more”,
in learning stage of the unsupervised learning processing unit,
“performing learning using a depth map not including the predetermined information to thereby generate the learning model”.

### 2. Second Embodiment

Subsequently, a second embodiment of the present disclosure is explained in detail with reference to the drawings. In the first embodiment explained above, a case is illustrated in which the target pixel in the depth map generated using the TOF sensor configured by the imaging device 10 and the light emitting system is corrected. In contrast, in the second embodiment, a case is illustrated in which a depth map is generated based on stereo vision by two or more image data and a target pixel in the generated depth map is corrected. Note that, in the following explanation, the same components and operations as the components and the operations in the embodiment or the modifications thereof explained above are cited to omit detailed explanation of the components and the operations.

### 2.1 Configuration Example of an Information Processing System

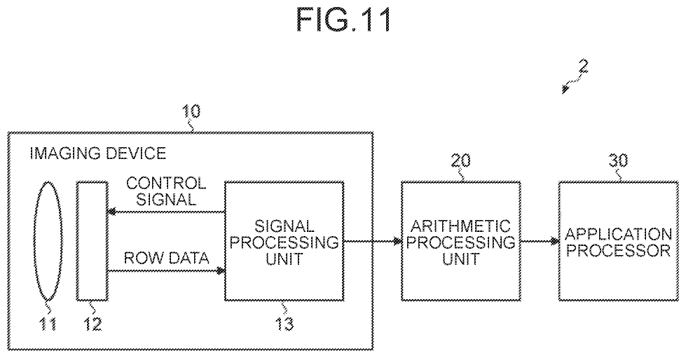

FIG. 11 is a block diagram illustrating a schematic configuration example of an information processing system according to the present embodiment. As illustrated in FIG. 11, in an information processing system 2 according to the present embodiment, the light emitting system (the light emission control unit 14 and the light emitting unit 15) configuring a TOF sensor is omitted in the same configuration as the configuration of the information processing system 1 explained with reference to FIG. 1 in the first embodiment.

### 2.2 Operation Example of the Information Processing System

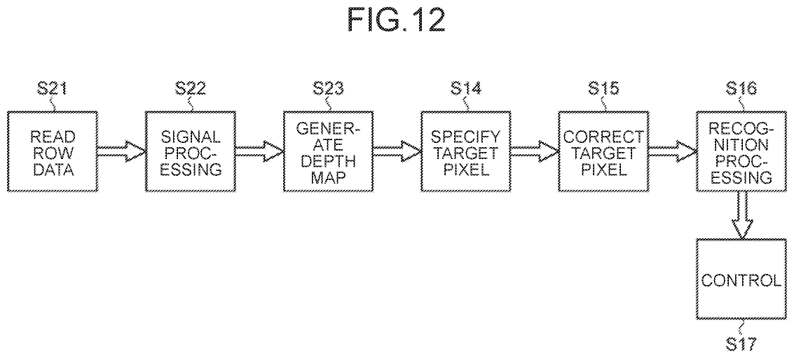

FIG. 12 is a diagram illustrating an operation example of the information processing system according to the present embodiment. As illustrated in FIG. 12, in an operation example of the information processing system 2 according to the present embodiment, steps S11 to S13 are replaced with steps S21 to S23 in the same operations as the operation example explained with reference to FIG. 3 in the first embodiment.

In step S21, as in step S11 in FIG. 3, a light receiving operation by the imaging unit 12 and reading of row data, which is a light receiving result of the light receiving operation, are executed. However, in the present embodiment, since the imaging device 10 operates as an image sensor that generates a multicolor color image or a single-color monochrome image, in step S21, image data including pixel signals corresponding to amounts of light made incident on the pixels 120 is read as row data.

In step S22, the signal processing unit 13 performs predetermined signal processing (preprocessing) such as defect correction, shading correction, color mixing correction, digital gain adjustment, white balance adjustment, demosaic (in the case of a color image,), gamma correction, and distortion correction on the row data output from the imaging unit 12.

In step S23, the signal processing unit 13 generates a depth map by using a stereo vision method in which two or more preprocessed image data is used.

Note that, as explained above, the processing in steps S22 and S23 executed by the signal processing unit 13 may be executed using machine learning, may be executed using a dedicated chip, or may be executed using a dedicated chip.

Thereafter, in the second embodiment, as in the first embodiment, a target pixel in the depth map is specified (step S14) and correction for the specified target pixel is executed (step S15). Recognition processing for the depth map in which the target pixel has been corrected is executed (step S16) and predetermined control is executed based on a result of the recognition processing and the like (step S17).

### 2.3 Action and Effects

As explained above, according to the present embodiment, as in the first embodiment, processing (correction) for the depth map, which is data acquired by the sensor, is executed before processing such as recognition processing for the depth map is executed. Therefore, it is possible to achieve improvement in image quality deteriorated because of an optical factor, an electrical factor, or the like, prevention of leakage of information relating to security or privacy, and the like.

The other components, operations, and effects may be the same as the components, the operations, and the effects of the embodiments or the modifications thereof explained above. Therefore, detailed explanation thereof is omitted here.

### 2.4 Modifications

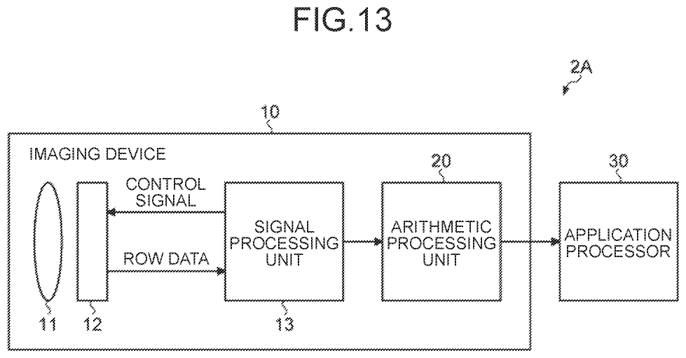

Note that, in the second embodiment explained above, a case is illustrated in which the arithmetic processing unit 20 is provided outside the imaging device 10. However, not only this, but, for example, the arithmetic processing unit 20 may be included in the imaging device 10A as in the information processing system 2A illustrated in FIG. 13. In that case, the arithmetic processing unit 20 may be disposed in a semiconductor chip different from the semiconductor chip on which the imaging unit 12 and/or the signal processing unit 13 are disposed or may be disposed on the same semiconductor chip as the semiconductor chip on which the imaging unit 12 and/or the signal processing unit 13 are arranged. In that case, in the arithmetic processing unit 20, the semiconductor chip on which the imaging unit 12 and/or the signal processing unit 13 and the arithmetic processing unit 20 are disposed may be a stacked chip formed by bonding a plurality of semiconductor chips.

When the arithmetic processing unit 20 is included in the imaging device 10A as in the present modification, as in the operation example explained with reference to FIG. 8 in the first embodiment, steps S21 to S23 and S14 to S15 may be executed by the imaging device 10A and step S16 (and step S17) may be executed by the application processor 30, an external processing device, or the like or, as in the operation example explained with reference to FIG. 9, all of steps S21 to S23 and S14 to S16 (or S17) may be executed by the imaging device 10A.

### 2.5 Summary of the Second Embodiment and Modifications Thereof

The contents of the second embodiment of the present disclosure and the modifications thereof explained above are summarized.

The information processing system 2 according to the second embodiment of the present disclosure can be explained as follows by combining the matters not explained on the assumption that the components and the operations are the same as the components and the operations in the first embodiment and the matters explained with reference to FIG. 12 and FIG. 13 on the assumption that the components and operations are different from the components and the operations in the first embodiment.

That is, the information processing system 2 according to the second embodiment of the present disclosure includes
the imaging processing unit (the imaging unit 12 and the signal processing unit 13) that performs a light receiving operation, generates a multicolor color image or a single-color monochrome image using a result of the light receiving operation, and generates a depth map with a stereo vision method using a plurality of these images,
the preprocessing unit (the arithmetic processing unit 20) that performs preprocessing on the depth map before recognition processing is performed on the depth map, and
the recognition processing unit (the application processor 30) that performs the recognition processing using information output by the preprocessing unit and outputs obtained information.

The preprocessing unit includes the machine learning processing unit that executes at least a part of the preprocessing using machine learning.

The machine learning processing unit executes processing for specifying a pixel having predetermined information or a pixel included in a region having the predetermined information in the depth map using the machine learning.

As an example, in the system, the predetermined information may be information generated by, among factors that affect data of the depth map generated by the imaging processing unit,
a factor of being other than a subject, which is a target imaged by the imaging processing unit, and a factor of being other than an optical path connecting the imaging processing unit and the subject with a straight line, and
an optical or electrical factor in the system,
and written in the depth map generated by the imaging processing unit. Alternatively, the predetermined information may be noise that occurred in the light receiving operation and is due to an electrical factor or an optical factor, variation in a light receiving result due to an electrical factor or an optical factor, or information erroneously detected because of an electrical factor or an optical factor. These kinds of predetermined information may be, for example, a so-called defective pixel (also referred to as error pixel) having a value different from an original value in the depth map. More specifically, the predetermined information may be, for example, a pixel affected by noise (hereinafter referred to as noise pixel.).

Alternatively, as another example, the predetermined information may be information different from information obtained by the recognition processing, the information being information concerning a subject in the depth map generated by the imaging processing unit, and, in particular, may be information relating to privacy or security of the subject in the depth map. This information may be, for example, regions for target objects relating to security or privacy (hereinafter referred to as specific regions as well) or pixels included in these regions. More specifically, the information may be, for example, in a system that recognizes a suspicious person near an ATM (Automatic Teller Machine), a region where an input key is displayed on an operation screen of the ATM that is not a recognition target, a region for a face, a palm, a finger, or the like of a person who operates the ATM, or pixels included in these regions. Alternatively, the information may be, in a system that measures a traffic volume of cars and people on a road, information more detailed than recognition of a car or a person, for example, a region for a license plate of a car or the like or a face of a driver, or pixels included in these regions. Alternatively, the information may be, in a system that monitors a residence for crime prevention, information concerning other than a monitoring target residence, for example, a region for an object that can specify an address of the monitoring target residence such as a surrounding house other than the monitoring target residence, a signboard, or a sign, or pixels included in these regions.

In the information processing system 2 according to the present embodiment, the machine learning processing unit includes, as a processing unit that executes the specifying processing using machine learning, a supervised learning processing unit that performs supervised learning or an unsupervised learning processing unit that performs unsupervised learning.

The supervised learning processing unit includes a neural network.

The neural network included in the supervised learning processing unit is a neural network that has performed learning using, as teacher data,
both of a depth map including a pixel having the predetermined information and position information of the pixel, or
a depth map explicitly indicating the pixel having the predetermined information.

The supervised learning processing unit
receives, as input, the depth map generated by the imaging processing unit, ad
outputs, as output, a result of specifying, in the depth map, a pixel having predetermined information or a pixel included in a region having the predetermined information.

The unsupervised learning processing unit includes an auto encoder and a comparator.

The auto encoder is an auto encoder that has performed learning using a depth map not including the predetermined information.

The unsupervised learning processing unit
receives, as input, the depth map generated by the imaging processing unit, and
outputs, as output, a result of specifying a pixel in which a difference between the depth map generated by the imaging processing unit and the depth map on which the learning has been performed is a predetermined threshold or more.

Further, in the information processing system 2 according to the present embodiment, as explained with reference to FIG. 4, the preprocessing unit may perform processing for changing, as information to be input to the recognition processing unit, data of the specified pixel in the depth map generated by the imaging processing unit to another value using data of pixels arranged around the pixel and input the depth map after the changing processing to the recognition processing unit.

The recognition processing unit may include a machine learning recognition processing unit that executes the recognition processing using machine learning.

The machine learning recognition processing unit may be a second machine learning processing unit that has performed learning to receive, as input, a depth map including an object to be a target of the recognition processing and output a recognition result of the object to be the target of the recognition processing.

Alternatively, in the information processing system 2 according to the present embodiment, as explained with reference to FIG. 4, the preprocessing unit may perform processing for changing, as information to be input to the recognition processing unit, data of the specified pixel in the depth map generated by the imaging processing unit to a predetermined value to indicate that the pixel is the specified pixel and input the depth map after the change processing to the recognition processing unit.

The recognition processing unit may include a machine learning recognition processing unit that executes the recognition processing using machine learning.

The machine learning recognition processing unit may be a second machine learning processing unit that has performed learning to receive, as input, a depth map including an object to be a target of the recognition processing and output a recognition result of the object to be the target of the recognition processing.

Note that the value determined in advance to indicate that the pixel is the specified pixel may be, for example, a minimum value or a maximum value as a value of the pixel or a value close thereto.

Alternatively, in the information processing system 2 according to the present embodiment, as explained with reference to FIG. 5, the preprocessing unit may input, as information to be input to the recognition processing unit, to the recognition processing unit, both of (1) the depth map generated by the imaging processing unit and (2) two-dimensional image data, the two-dimensional data being a figure or image data indicating a position of the specified pixel in the depth map generated by the imaging processing unit.

The recognition processing unit may include a machine learning recognition processing unit that executes the recognition processing using machine learning.

The machine learning recognition processing unit may be a second machine learning processing unit that has performed learning to receive, as input, both of a depth map including an object to be a target of the recognition processing and two-dimensional image data representing a position of the specified pixel and output a recognition result of the object to be the target of the recognition processing.

Alternatively, in the information processing system 2 according to the present embodiment, as explained with reference to FIG. 6, the preprocessing unit may input, as information to be input to the recognition processing unit, to the recognition processing unit, both of (1) the depth map generated by the imaging processing unit and (2) coordinate data representing the specified pixel position.

The recognition processing unit may include a machine learning recognition processing unit that executes the recognition processing using machine learning.

The machine learning recognition processing unit may be a second machine learning processing unit that has performed learning to receive, as input, both of a depth map including an object to be a target of the recognition processing and coordinate data representing a position of the specified pixel and output a recognition result of the object to be the target of the recognition processing.

Alternatively, like the information processing system 1A according to the modification 1 of the first embodiment explained with reference to FIG. 10, the information processing system 2 according to the present embodiment may perform relearning of the neural network of the supervised learning processing unit or relearning of the auto encoder of the unsupervised learning processing unit using the depth map generated by the imaging processing unit and the information concerning the specified pixel.

Further, in the information processing system 2 according to the present embodiment, as explained with reference to FIG. 1 and FIG. 3, the supervised learning processing unit may use a learning model generation method for, to generate, as a learning model, a learning model for “in a use stage of the supervised learning processing unit, receiving, as input, a depth map generated by the imaging processing unit and outputting, as output, a result of specifying, in the depth map, a pixel having predetermined information or a pixel included in a region having the predetermined information”,
in a learning stage of the supervised learning processing unit,
“performing learning using, as teacher data, both of a depth map including a pixel having the predetermined information and position information of the pixel or a depth map explicitly indicating the pixel having the predetermined information to thereby generate the learning model”.

Further, in the information processing system 2 according to the present embodiment, as explained with reference to FIG. 1 and FIG. 3, the unsupervised learning processing unit may use a learning model generation method for, to generate, as a learning model, a learning model for “in a use stage of the unsupervised learning processing unit, receiving, as input, the depth map generated by the imaging processing unit and outputting, as output, a result of specifying a pixel in which a difference between the depth map generated by the imaging processing unit and the depth map on which the learning is performed is a predetermined threshold or more”,
in learning stage of the unsupervised learning processing unit,
“performing learning using a depth map not including the predetermined information to thereby generate the learning model”.

### 3. Third Embodiment

Next, a third embodiment of the present disclosure is explained in detail with reference to the drawings. In the first and second embodiments explained above, a case is illustrated in which the correction target is the depth map. However, a target to which the technology according to the present disclosure is applicable is not limited to the depth map. The target can be various data in which one-dimensionally or two-dimensionally distributed points have some information. Therefore, in the third embodiment, a case in which image data not including distance information is set as a correction target is explained with reference to an example. Note that the image data may be a multi-color color image or a monochrome image of a single color, but in the following description, a case of a color image is illustrated. Note that, in the following explanation, the same components and operations as the components and the operations in the embodiments explained above are cited to omit redundant explanation.

### 3.1 Configuration Example of an Information Processing System

A schematic configuration example of an information processing system according to the present embodiment may be, for example, the same configuration as the configuration of the information processing system 2 explained with reference to FIG. 11 or FIG. 13 in the second embodiment. However, in the second embodiment explained with reference to FIG. 11 or FIG. 13, the imaging device 10 configuring the information processing system 2 is configured to generate a depth map from two or more image data based on stereo vision. On the other hand, in the information processing system in the present embodiment, the imaging device 10 and the lens 11 and the imaging unit 12 configuring the imaging device 10 may be configured to be able to capture one image data not including distance information. In the present embodiment, the signal processing unit 13 operates as a signal processing unit for performing signal processing of image data. In the following explanation, a configuration of the information processing system according to the present embodiment is explained with reference to several examples.

### 3.1.1 First Example

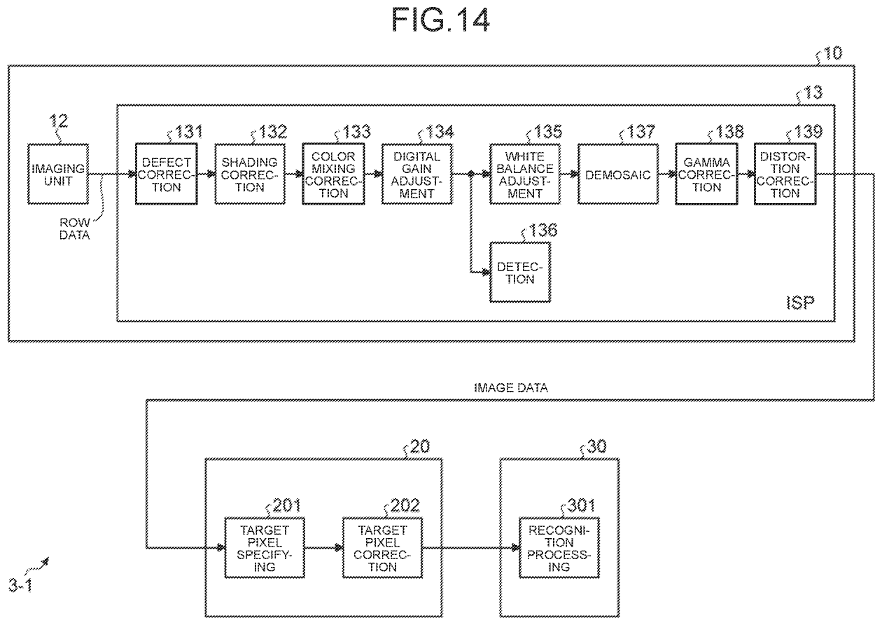

FIG. 14 is a block diagram illustrating a configuration example of an information processing system according to the first example of the present embodiment. As illustrated in FIG. 14, an information processing system 3-1 according to the first example includes the imaging device 10, the arithmetic processing unit 20, and the application processor 30 like the information processing system 2 illustrated in FIG. 11.

In FIG. 14, the imaging unit 12 performs a light receiving operation, outputs row data (image data), which is a light receiving result, and inputs the row data to the signal processing unit 13. This operation is equivalent to step S11 in the first embodiment explained with reference to FIG. 3. Note that the row data (the image data) output by the imaging unit 12 in the present embodiment is, as an example, a multicolor color image not including distance information. This point is different from the first embodiment. The signal processing unit 13 in the imaging device 10 sequentially executes preprocessing such as defect correction 131, shading correction 132, color mixing correction 133, digital gain adjustment 134, white balance adjustment 135, demosaic 137, gamma correction 138, and distortion correction 139 on the row data (the image data) input from the imaging unit 12. The signal processing unit 13 may execute detection 136 for checking a signal level of the image data subjected to the digital gain adjustment. Note that the processing illustrated above is merely an example and is not limited thereto. The signal processing unit 13 may execute various preprocessing such as black level processing, linear matrix processing, luminance color separation, edge enhancement processing, color difference matrix processing, and resizing/zooming processing.

Note that, in the first example, it is assumed that the signal processing unit 13 is configured by a dedicated chip such as an image signal processor (ISP).

These kinds of processing executed by the signal processing unit 13 in the present embodiment are equivalent to step S12 (the signal processing) in the operation flow of the information processing system illustrated in FIG. 3. However, step S12 of the present embodiment is different from S12 in the first embodiment in that the various kinds of signal processing explained above is executed on the multicolor color image.

In the present embodiment, step 13 in FIG. 3 and the processing for generating a depth map are unnecessary. This point is also different from the first embodiment.

In FIG. 14, the signal processing unit 13 inputs the image data subjected to the signal processing to the arithmetic processing unit 20. In the operation flow of the information processing system illustrated in FIG. 3, this is equivalent to performing the signal processing in step S12 in the imaging device 10 including the signal processing unit 13, inputting the image data serving as the signal processing result in step S12 to the arithmetic processing unit 20, and performing the target pixel specifying processing in step S14.

The arithmetic processing unit 20 sequentially executes the target pixel specifying 201 equivalent to the processing for specifying the target pixel explained as step S14 in the embodiments explained above and a target pixel correction 202 equivalent to the processing for correcting the target pixel explained as step S15. Note that, in the first embodiment, the processing in steps S14 and S15 is performed on the depth map. However, the third embodiment is different in that the processing in steps S14 and S15 is performed on a multicolor color image or a single-color monochrome image not including distance information.

As in step S14, the target pixel specifying 201 may specify a target pixel using the machine learning such as the CNN, the RNN, the DNN, the GAN, or the auto encoder. As in step S15, the target pixel correction 202 may be executed using the machine learning such as the CNN, the RNN, the DNN, the GAN, or the auto encoder or may be executed based on an algorithm or the like prepared in advance.

Note that, in the present embodiment, in the target pixel specifying 201, the arithmetic processing unit 20 may specify, for example, a pixel that causes blur that has occurred in image data, a pixel affected by noise, a pixel in which a false color occurs, a pixel equivalent to a lost line (edge), a pixel in which resolution of gradation is reduced, or the like as the target pixel. However, not only this, but, as in the embodiments and the modifications thereof explained above, the arithmetic processing unit 20 may specify, as target pixels, pixels included in a specific region for a target object relating to security and privacy such as a region where an input key is displayed on an operation screen of an ATM (Automatic Teller Machine), a face and a palm of a person, a license plate of a car or the like, a surrounding house other than an own house, or an object capable of specifying an address such as a signboard or a sign.

The application processor 30 executes recognition processing 301 equivalent to the recognition processing described as step S16 in the embodiments explained above. The application processor 30 may execute the control explained as step S17 in the embodiments explained above. Note that, although the processing in step S16 is performed on the depth map in the first embodiment, in the third embodiment, the processing in step S16 is performed on a multicolor color image or a single-color monochrome image not including distance information.

As explained above, by executing processing (correction) on image data, which is data acquired by a sensor, before executing recognition processing on the image data, it is possible to achieve improvement of image quality deteriorated by optical factors, electrical factors, and the like, prevention of leakage of information relating to security and privacy, and the like.

### 3.1.2 Second Example

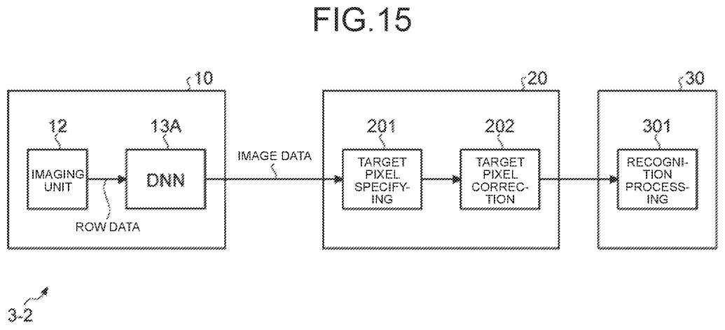

FIG. 15 is a block diagram illustrating a configuration example of an information processing system according to a second example of the present embodiment. As illustrated in FIG. 15, in an information processing system 3-2 according to the second example, in the same configuration as the configuration of the information processing system 3-1 according to the first example illustrated in FIG. 14, the signal processing unit 13 is replaced with a signal processing unit 13A configured by not a dedicated chip such as an ISP but a DSP or the like that executes the machine learning such as the DNN. That is, in the present embodiment, preprocessing on image data is executed using the machine learning such as the DNN, the CNN, the RNN, the GAN, or the auto encoder.

However, the processing executed by the DSP may be at least one of the defect correction 131, the shading correction 132, the color mixing correction 133, the digital gain adjustment 134, the white balance adjustment 135, the demosaic 137, the gamma correction 138, and the distortion correction 139 illustrated in FIG. 14. In this case, the remaining processing may be executed by a dedicated chip such as an ISP.

### 3.1.3 Third Example

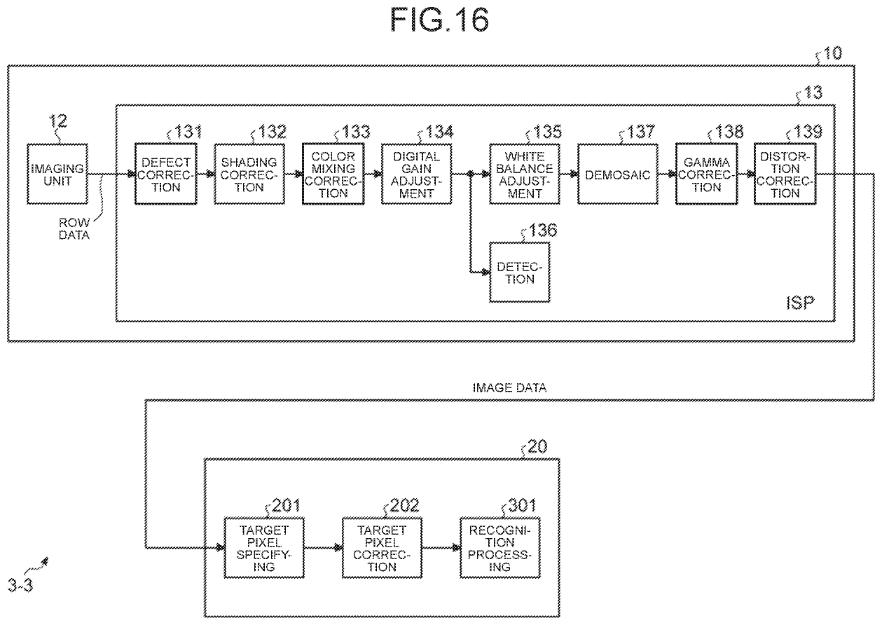

FIG. 16 is a block diagram illustrating a configuration example of an information processing system according to a third example of the present embodiment. As in an information processing system 3-3 illustrated in FIG. 16, the recognition processing 301 may be executed in the arithmetic processing unit 20.

### 3.1.4 Fourth Example

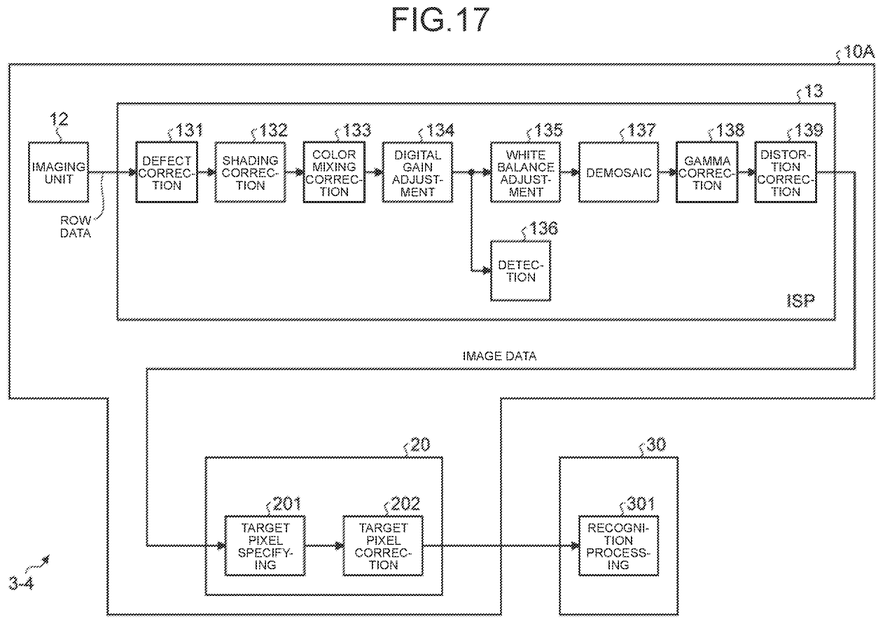

FIG. 17 is a block diagram illustrating a configuration example of an information processing system according to a fourth example of the present embodiment. As in an information processing system 3-4 illustrated in FIG. 17, the arithmetic processing unit 20 may be included in the imaging device 10 as in the modification 1 of the first embodiment (see FIG. 8) explained above.

### 3.1.5 Fifth Example

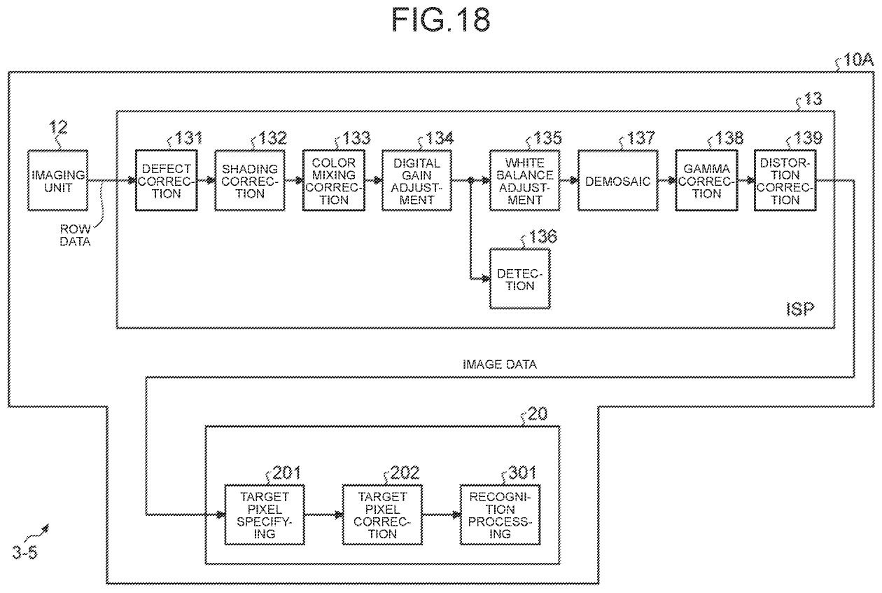

FIG. 18 is a block diagram illustrating a configuration example of an information processing system according to a fifth example of the present embodiment. As in the information processing system 3-5 illustrated in FIG. 18, the recognition processing 301 may be executed in the arithmetic processing unit 20 in the imaging device 10 as in the modification 1 of the first embodiment (see FIG. 9) explained above.

### 3.1.6 Sixth Example

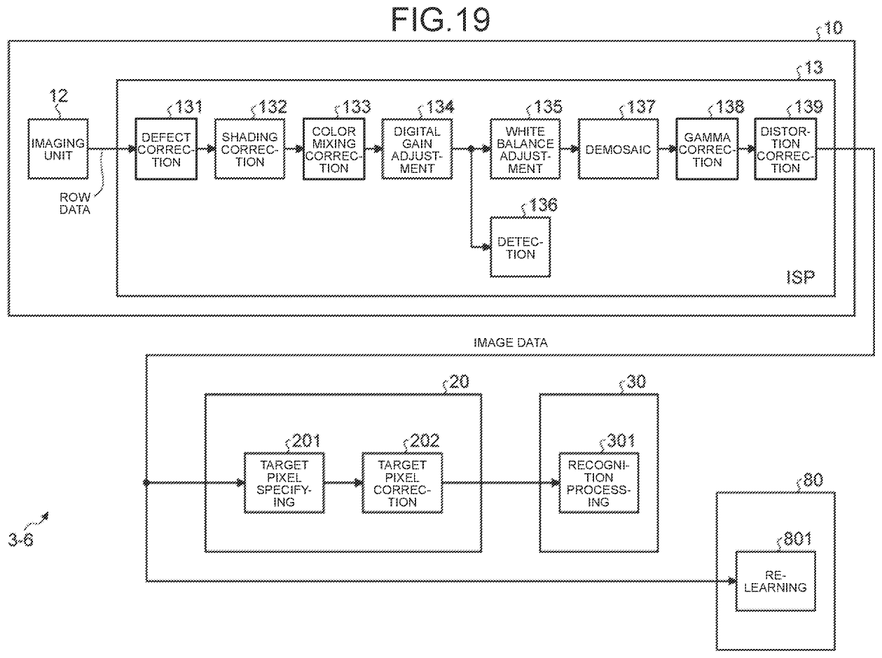

FIG. 19 is a block diagram illustrating a configuration example of an information processing system according to a sixth example of the present embodiment. As explained in the embodiments or the modifications thereof explained above, the target pixel specifying 201 can be executed using the machine learning such as the DNN, the CNN, the RNN, the GAN, and the auto encoder. Therefore, as in an information processing system 3-6 illustrated in FIG. 19, image data output from the signal processing unit 13 to be input to the target pixel specifying 201 may be input to an external processing device such as a Cloud server 80, and the processing device may execute relearning 801 of a learning model for executing the target pixel specifying 201. Note that, in the relearning of the learning model, teacher data for relearning may be created using image data in which a target pixel is specified.

### 3.1.7 Seventh Example

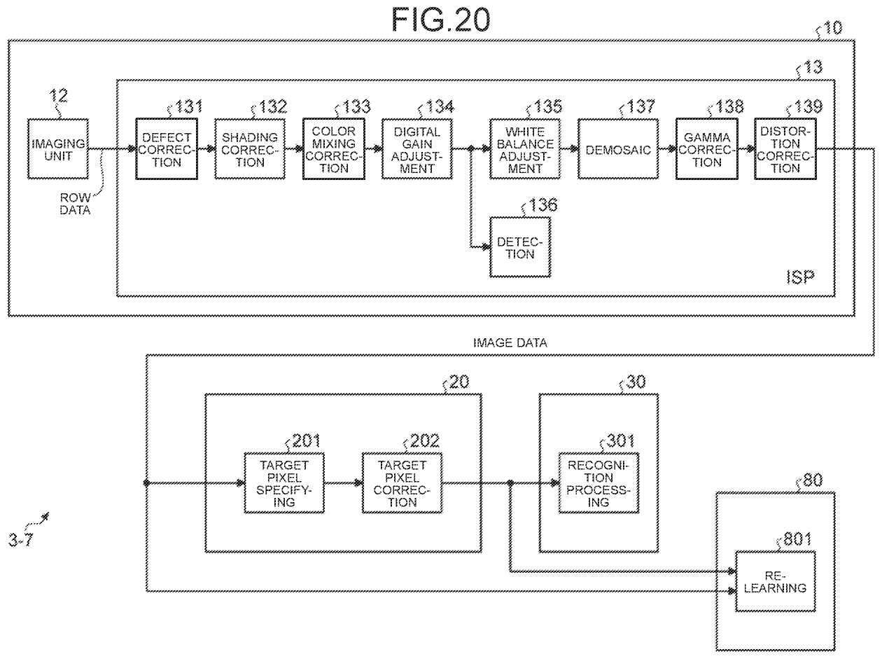

FIG. 20 is a block diagram illustrating a configuration example of an information processing system according to a seventh example of the present embodiment. As explained in the embodiments or the modifications thereof explained above, in addition to the target pixel specifying 201, the recognition processing 301 can be executed using machine learning such as DNN, CNN, RNN, GAN, and auto encoder. Therefore, as in an information processing system 3-7 illustrated in FIG. 20, image data after target pixel correction by the target pixel correction 202 to be input to the recognition processing 301 may be input to an external processing device such as the Cloud server 80, and the processing device may execute the relearning 801 of the learning model for executing the recognition processing 301. In the relearning of the learning model, teacher data for relearning may be created using the image data after the target pixel correction.

### 3.1.8 Eighth Example

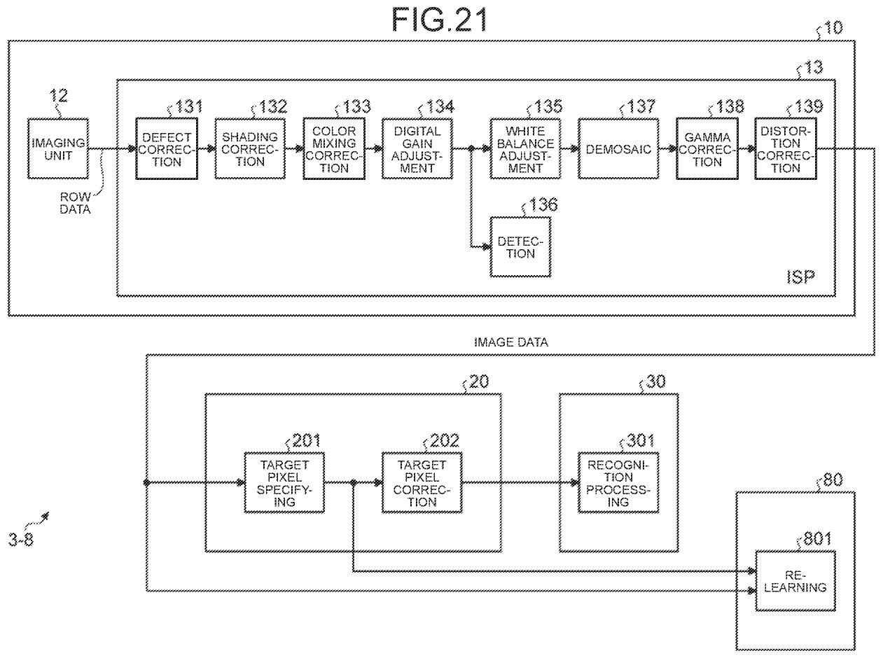

FIG. 21 is a block diagram illustrating a configuration example of an information processing system according to an eighth example of the present embodiment. As explained in the embodiments or the modifications thereof explained above, besides the target pixel specifying 201, the target pixel correction 202 can be executed using the machine learning such as the DNN, the CNN, the RNN, the GAN, or the auto encoder.

Therefore, as in an information processing system 3-8 illustrated in FIG. 21, the image data in which the target pixel is specified by the target pixel specifying 201 to be input to the target pixel correction 202 may be input to an external processing device such as the Cloud server 80, and the processing device may execute the relearning 801 of the learning model for executing the target pixel correction 202. Note that, in the relearning of the learning model, teacher data for relearning may be created using image data in which a target pixel is specified.

### 3.1.9 Ninth Example

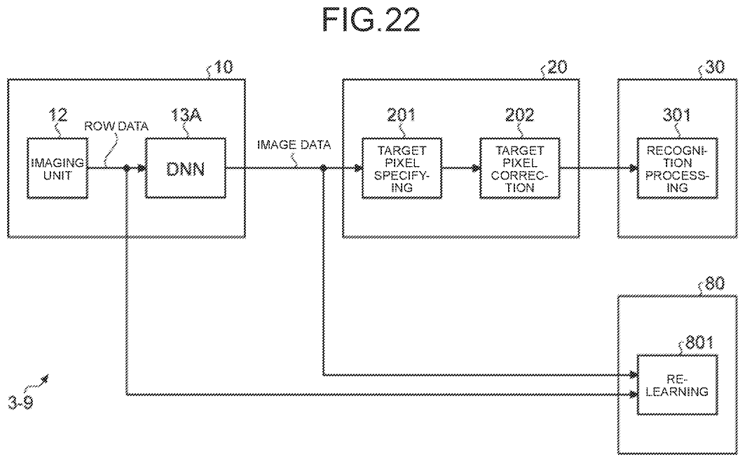

FIG. 22 is a block diagram illustrating a configuration example of an information processing system according to a ninth example of the present embodiment. As explained in the second example explained above, besides the target pixel specifying 201, preprocessing executed by the signal processing unit 13A can be executed using the machine learning such as the DNN, the CNN, the RNN, the GAN, and the auto encoder. Therefore, as in an information processing system 3-9 illustrated in FIG. 22, row data (image data) read from the imaging unit 12 to be input to the signal processing unit 13A may be input to an external processing device such as the Cloud server 80, and the processing device may execute the relearning 801 of the learning model for executing preprocessing. In the relearning of the learning model, teacher data for relearning may be created using row data (image data).

### 3.1.10 Tenth Example

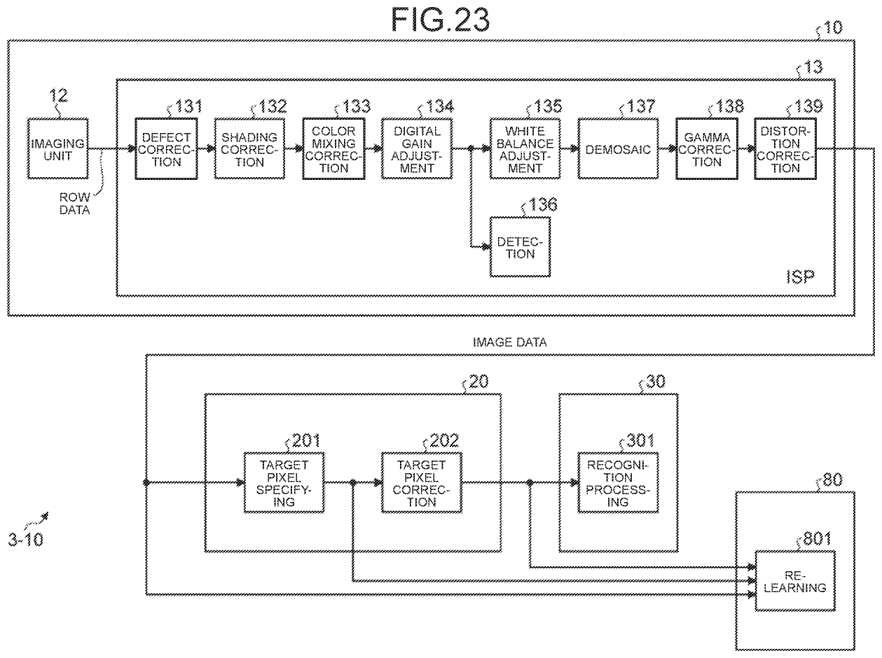

FIG. 23 is a block diagram illustrating a configuration example of an information processing system according to a tenth example of the present embodiment. As in the sixth example to the eighth example explained above, when both of the recognition processing 301 and the target pixel correction 202 are executed using the machine learning such as the DNN, the CNN, the RNN, the GAN, or the auto encoder besides the target pixel specifying 201, as in an information processing system 3-10 illustrated in FIG. 23, each input may be input to an external processing device such as the Cloud server 80, and the processing device may execute the relearning 801 of the learning model for executing each of the recognition processing 301 and the target pixel correction 202.

### 3.1.11 Eleventh Example

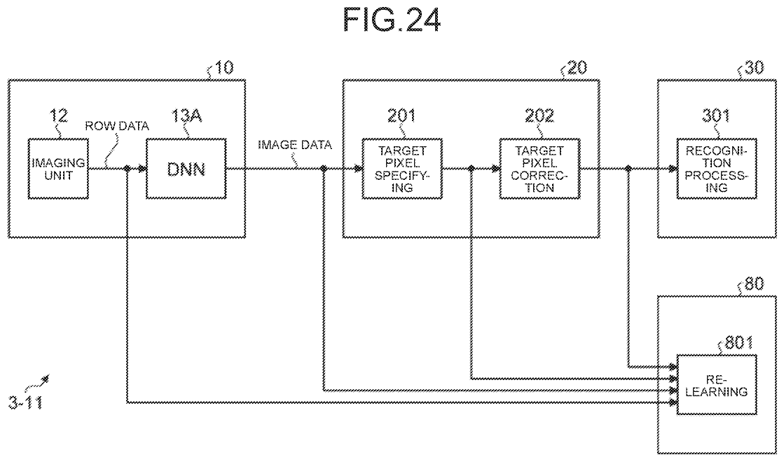

FIG. 24 is a block diagram illustrating a configuration example of an information processing system according to an eleventh example of the present embodiment. In addition to the tenth example explained above, as in the seventh example, when the preprocessing executed by the signal processing unit 13A is further executed using the machine learning such as the DNN, the CNN, the RNN, the GAN, or the auto encoder, as in an information processing system 3-11 illustrated in FIG. 24, row data (image data) read from the imaging unit 12 to be input to the signal processing unit 13A may be further input to an external processing device such as the Cloud server 80, and the processing device may further execute the relearning 801 of a learning model for executing the preprocessing.

### 3.2 Action and Effects

As explained above, according to the present embodiment, since processing (correction) for the image data, which is the data acquired by the sensor, is executed before the processing such as the recognition processing for the in which one-dimensionally or two-dimensionally distributed points have some information such as image data is executed, it is possible to achieve improvement of image quality deteriorated because of an optical factor, an electrical factor, or the like, prevention of leakage of information relating to security and privacy, and the like.

The other components, operations, and effects may be the same as the components, the operations, and the effects of the embodiments or the modifications thereof explained above. Therefore, detailed explanation thereof is omitted here.

### 3.3 Summary of the Third Embodiment

The contents of the third embodiment of the present disclosure explained above are summarized.

An information processing system (in the following explanation, the reference numerals of the information processing system according to the third embodiment are collectively described as ‘3’) 3 according to the third embodiment of the present disclosure can be explained as follows by combining matters, explanation of which is omitted because components and operations thereof are the same as the components and the operations in the first and second embodiments, and matters explained with reference to FIG. 14 to FIG. 24 because components and operations thereof are different from the components and the operations in the first and second embodiments.

That is, as described with reference to FIG. 13, the information processing system 3 according to the third embodiment of the present disclosure includes
the imaging processing unit (the imaging unit 12 and the signal processing unit 13) that performs a light receiving operation and generates a multicolor color image or a single-color monochrome image (hereinafter, these images are collectively simply referred to as image) using a result of the light receiving operation,
the preprocessing unit (the arithmetic processing unit 20) that performs preprocessing on the image before recognition processing is performed on the image, and
the recognition processing unit (the application processor 30) that performs the recognition processing using information output by the preprocessing unit and outputs obtained information.

The preprocessing unit includes the machine learning processing unit that executes at least a part of the preprocessing using machine learning.

The machine learning processing unit executes, using the machine learning, processing for specifying, in the image, a pixel having predetermined information or a pixel included in a region having the predetermined information. (Step S14)

As an example, in the system, the predetermined information may be information generated by, among factors that affect data of the image generated by the imaging processing unit,
a factor of being other than a subject, which is a target imaged by the imaging processing unit, and a factor of being other than an optical path connecting the imaging processing unit and the subject with a straight line, and
an optical or electrical factor in the system,
and written in the image generated by the imaging processing unit. Alternatively, the predetermined information may be noise that occurred in the light receiving operation and is due to an electrical factor or an optical factor, variation in a light receiving result due to an electrical factor or an optical factor, or information erroneously detected because of an electrical factor or an optical factor. The predetermined information may be, for example, a so-called defective pixel (also referred to as error pixel) having a value different from an original value in the image. More specifically, the predetermined information may be, for example, a pixel affected by noise (hereinafter referred to as noise pixel.).

Alternatively, as another example, the predetermined information may be information different from the information obtained by the recognition processing and information concerning a subject in the image generated by the imaging processing unit and may be, in particular, information relating to privacy or security of the subject in the image. This information may be, for example, regions for target objects relating to security or privacy (hereinafter referred to as specific regions as well) or pixels included in these regions. More specifically, the information may be, for example, in a system that recognizes a suspicious person near an ATM (Automatic Teller Machine), a region where an input key is displayed on an operation screen of the ATM that is not a recognition target, a region for a face, a palm, a finger, or the like of a person who operates the ATM, or pixels included in these regions. Alternatively, the information may be, in a system that measures a traffic volume of cars and people on a road, information more detailed than recognition of a car or a person, for example, a region for a license plate of a car or the like or a face of a driver, or pixels included in these regions. Alternatively, the information may be, in a system that monitors a residence for crime prevention, information concerning other than a monitoring target residence, for example, a region for an object that can specify an address of the monitoring target residence such as a surrounding house other than the monitoring target residence, a signboard, or a sign, or pixels included in these regions. (Step S14)

In the information processing system 3 according to the present embodiment, as explained with reference to FIG. 1 and FIG. 3, the machine learning processing unit includes, as the processing unit that executes the specifying processing using the machine learning, the supervised learning processing unit that has performed the supervised learning or the unsupervised learning processing unit that has performed the unsupervised learning.

The supervised learning processing unit includes a neural network.

The neural network included in the supervised learning processing unit is a neural network that has performed learning using, as teacher data,
both of an image including a pixel having the predetermined information and position information of the pixel, or
an image explicitly indicating the pixel having the predetermined information.

The supervised learning processing unit
receives, as input, the image generated by the imaging processing unit, and
outputs, as output, a result of specifying, in the image, a pixel having the predetermined information or a pixel included in a region having the predetermined information.

The unsupervised learning processing unit includes an auto encoder and a comparator.

The auto encoder is an auto encoder that has performed learning using an image not including the predetermined information.

The unsupervised learning processing unit
receives, as input, the image generated by the imaging processing unit, and
outputs, as output, a result of specifying a pixel in which a difference between the image generated by the imaging processing unit and the image on which the learning has been performed is a predetermined threshold or more.

Further, in the information processing system 3 according to the present embodiment, as explained with reference to FIG. 4, the preprocessing unit may perform processing for changing, as information to be input to the recognition processing unit, data of the specified pixel in the image generated by the imaging processing unit to another value using data of pixels arranged around the pixel and input the image after the change processing to the recognition processing unit.

The recognition processing unit may include a machine learning recognition processing unit that executes the recognition processing using machine learning.

The machine learning recognition processing unit may be a second machine learning processing unit that has performed learning to receive, as input, an image including an object to be a target of the recognition processing and output a recognition result of the object to be the target of the recognition processing.

Alternatively, in the information processing system 3 according to the present embodiment, as explained with reference to FIG. 4, the preprocessing unit may perform processing for changing, as information to be input to the recognition processing unit, data of the specified pixel in the image generated by the imaging processing unit to a predetermined value to indicate that the pixel is the specified pixel and input the image after the change processing to the recognition processing unit.

The recognition processing unit may include a machine learning recognition processing unit that executes the recognition processing using machine learning.

The machine learning recognition processing unit may be a second machine learning processing unit that has performed learning to receive, as input, an image including an object to be a target of the recognition processing and output a recognition result of the object to be the target of the recognition processing.

Note that the value determined in advance to indicate that the pixel is the specified pixel may be, for example, a minimum value or a maximum value as a value of the pixel or a value close thereto.

Alternatively, in the information processing system 3 according to the present embodiment, as explained with reference to FIG. 5, the preprocessing unit may input, as information to be input to the recognition processing unit, to the recognition processing unit, both of (1) the image generated by the imaging processing unit and (2) two-dimensional image data, the two-dimensional data being a figure or image data indicating a position of the specified pixel in the image generated by the imaging processing unit.

The recognition processing unit may include a machine learning recognition processing unit that executes the recognition processing using machine learning.

The machine learning recognition processing unit may be a second machine learning processing unit that has performed learning to receive, as input, both of an image including an object to be a target of the recognition processing and two-dimensional image data representing a position of the specified pixel and output a recognition result of the object to be the target of the recognition processing.

Alternatively, in the information processing system 3 according to the present embodiment, as explained with reference to FIG. 6, the preprocessing unit may input, as information to be input to the recognition processing unit, to the recognition processing unit, both of (1) the image generated by the imaging processing unit and (2) coordinate data representing the specified pixel position.

The recognition processing unit may include a machine learning recognition processing unit that executes the recognition processing using machine learning.

The machine learning recognition processing unit may be a second machine learning processing unit that has performed learning to receive, as input, both of an image including an object to be a target of the recognition processing and coordinate data representing a position of the specified pixel and output a recognition result of the object to be the target of the recognition processing.

Alternatively, like the information processing system 1A according to the modification 1 of the first embodiment explained with reference to FIG. 10, the information processing system 3 according to the present embodiment may perform relearning of the neural network of the supervised learning processing unit or relearning of the auto encoder of the unsupervised learning processing unit using the image generated by the imaging processing unit and the information concerning the specified pixel.

Further, in the information processing system 3 according to the present embodiment, as explained with reference to FIG. 1 and FIG. 3, the supervised learning processing unit may use a learning model generation method for, to generate, as a learning model, a learning model for “in a use stage of the supervised learning processing unit, receiving, as input, an image generated by the imaging processing unit and outputting, as output, a result of specifying, in the image, a pixel having predetermined information or a pixel included in a region having the predetermined information”,
in a learning stage of the supervised learning processing unit,
“performing learning using, as teacher data, both of an image including a pixel having the predetermined information and position information of the pixel or an image explicitly indicating the pixel having the predetermined information to thereby generate the learning model”.

Further, in the information processing system 3 according to the present embodiment, as explained with reference to FIG. 1 and FIG. 3, the unsupervised learning processing unit may use a learning model generation method for, to generate, as a learning model, a learning model for “in a use stage of the unsupervised learning processing unit, receiving, as input, the image generated by the imaging processing unit and outputting, as output, a result of specifying a pixel in which a difference between the image generated by the imaging processing unit and the image on which the learning is performed is a predetermined threshold or more”,
in learning stage of the unsupervised learning processing unit,
“performing learning using an image not including the predetermined information to thereby generate the learning model”.

### 4. Fourth Embodiment

Next, a fourth embodiment of the present disclosure is explained in detail with reference to the drawings. In the first and second embodiments explained above, the information processing system in which the depth map is set as the processing target is illustrated. In the third embodiment explained above, the information processing system in which a two-dimensional color or monochrome image different from the depth map is set as the processing target is illustrated. An object to which the technology according to the present disclosure is applicable is not limited to the embodiments explained above. In the fourth embodiment, an information processing system including a sensor (hereinafter referred to as fusion sensor) including both of a sensor that acquires a depth map and an image sensor that acquires a two-dimensional color or monochrome image different from the depth map is illustrated. Note that, in the following explanation, the same components and operations as the components and the operations in the embodiment or the modifications thereof explained above are cited to omit detailed explanation of the components and the operations.

### 4.1 Configuration Example of an Information Processing System

A schematic configuration example of an information processing system 4A according to the present embodiment may be, for example, a configuration in which the information processing system 1 in the first embodiment explained with reference to FIG. 1 and the information processing system 3 of the third embodiment explained with reference to FIG. 11 are combined. In the following explanation, a configuration of the information processing system according to the present embodiment is explained with reference to several examples.

### 4.1.1 First Example

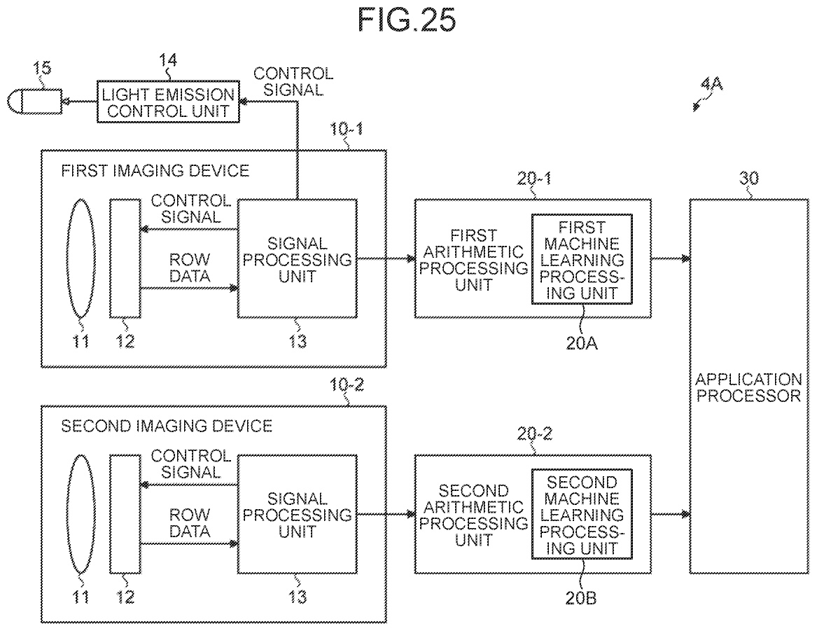

FIG. 25 is a block diagram illustrating a configuration example of the information processing system 4A according to a first example of the present embodiment. As illustrated in FIG. 25, the information processing system 4A according to the first example includes a first imaging device 10-1, a first arithmetic processing unit 20-1, the light emitting unit 15, and the light emission control unit 14, which are the same as those of the information processing system 1 explained with reference to FIG. 1 and includes a second imaging device 10-2 and a second arithmetic processing unit 20-2, which are the same as those of the information processing system 3 described with reference to FIG. 11. As illustrated in FIG. 25, the first arithmetic processing unit 20-1 includes a first machine learning processing unit 20A that is the same as the machine learning processing unit included in the arithmetic processing unit 20 of the information processing system 1 and the second arithmetic processing unit 20-2 includes a second machine learning processing unit 20B that is the same as the machine learning processing unit included in the arithmetic processing unit 20 of the information processing system 3. As illustrated in FIG. 25, the information processing system 4A according to the first example further includes the application processor 30. The application processor illustrated in FIG. 25 may function as, for example, both of the application processor 30 included in the information processing system 1 explained with reference to FIG. 1 and the application processor 30 included in the information processing system 3 explained with reference to FIG. 11.

The information processing system 4A illustrated in FIG. 25 performs the same operation as the operation of the information processing system 1 in the first embodiment using the first imaging device 10-1, the first arithmetic processing unit 20-1, the light emitting unit 15, and the light emission control unit 14 and inputs information processed by the first arithmetic processing unit 20-1 to the application processor 30. The information processing system 4A illustrated in FIG. 25 performs the same operation as the operation of the information processing system 3 of the third embodiment using the second imaging device 10-2 and the second arithmetic processing unit 20-2 and inputs the information processed by the second arithmetic processing unit 20-2 to the application processor 30. The application processor 30 illustrated in FIG. 25 may perform, using the information input from the first arithmetic processing unit 20-1 and the information input from the second arithmetic processing unit 20-2, the same operation as the operation of the application processor 30 included in the information processing system 1 in the first embodiment (for example, processing for recognizing an object in the information input from the first arithmetic processing unit 20-1) and the same operation as the operation of the application processor 30 included in the information processing system 3 in the third embodiment (for example, processing for recognizing an object in the information input from the second arithmetic processing unit 20-2). Further, new information may be obtained using the information obtained by these operations. The information may be, for example, information having the same content as information obtained in a publicly-known fusion type sensor.

As explained above, like the information processing system 1 in the first embodiment and the information processing system 3 in the third embodiment, the information processing system 4A according to the first example of the present embodiment is capable of achieving improvement in processing accuracy (for example, improvement of recognition accuracy), improvement in image quality deteriorated because of an optical factor, an electrical factor, or the like, prevention of leakage of information relating to security or privacy, and the like by executing processing (correction) for image data, which is data acquired by a sensor, before executing processing (for example, recognition processing) for information in the application processor 30. As a result, it is possible to obtain information in which processing accuracy (for example, recognition accuracy) and image quality are further improved than information obtained in the publicly-known fusion type sensor or information in which leakage of information relating to security and privacy is prevented.

### 4.1.2 Second Example

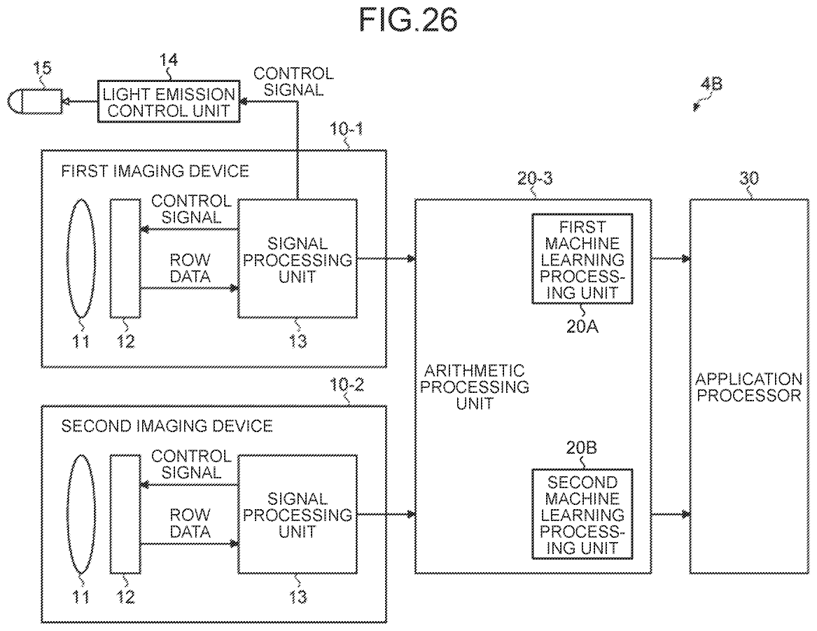

FIG. 26 is a block diagram illustrating a configuration example of an information processing system 4B according to a second example of the present embodiment. In the information processing system 4A illustrated in FIG. 25, the first arithmetic processing unit 20-1 including the first machine learning processing unit 20A and the second arithmetic processing unit 20-2 including the second machine learning processing unit 20B are different blocks. In contrast, the information processing system 4B according to the second example illustrated in FIG. 26 is different in that the first machine learning processing unit 20A and the second machine learning processing unit 20B are included in one arithmetic processing unit 20-3. The other components and operations are the same as the components and the operations of the information processing system 4A illustrated in FIG. 25. Therefore, explanation thereof is omitted.

Like the information processing system 4A illustrated in FIG. 25, the information processing system 4B according to the second example is capable of achieving improvement in processing accuracy (for example, improvement of recognition accuracy), improvement in image quality deteriorated because of an optical factor, an electrical factor, or the like, prevention of leakage of information relating to security or privacy, and the like by executing processing (correction) for image data, which is data acquired by a sensor, before executing processing (for example, recognition processing) for information in the application processor 30. As a result, it is possible to obtain information in which processing accuracy (for example, recognition accuracy) and image quality are further improved than information obtained in the publicly-known fusion type sensor or information in which leakage of information relating to security and privacy is prevented.

### 4.1.3 Third Example

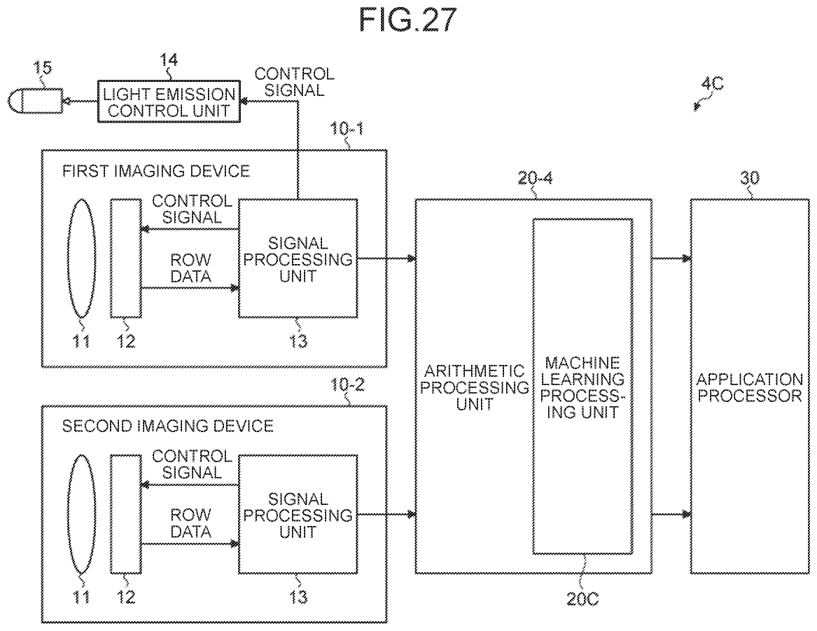

FIG. 27 is a block diagram illustrating a configuration example of an information processing system 4C according to a third example of the present embodiment. In the information processing system 4A illustrated in FIG. 25, the first arithmetic processing unit 20-1 including the first machine learning processing unit 20A and the second arithmetic processing unit 20-2 including the second machine learning processing unit 20B are different blocks. In contrast, the information processing system 4C according to the third example illustrated in FIG. 27 is different in that the first machine learning processing unit 20A and the second machine learning processing unit 20B are configured as one machine learning processing unit 20C and the machine learning processing unit 20C is included in one arithmetic processing unit 20-4. The other components and operations are the same as the components and the operations of the information processing system 4A illustrated in FIG. 25. Therefore, explanation thereof is omitted.

Like the information processing system 4A illustrated in FIG. 25, the information processing system 4C according to the third example is capable of achieving improvement in processing accuracy (for example, improvement of recognition accuracy), improvement in image quality deteriorated because of an optical factor, an electrical factor, or the like, prevention of leakage of information relating to security or privacy, and the like by executing processing (correction) for image data, which is data acquired by a sensor, before executing processing (for example, recognition processing) for information in the application processor 30. As a result, it is possible to obtain information in which processing accuracy (for example, recognition accuracy) and image quality are further improved than information obtained in the publicly-known fusion type sensor or information in which leakage of information relating to security and privacy is prevented.

### 4.1.4 Fourth Example

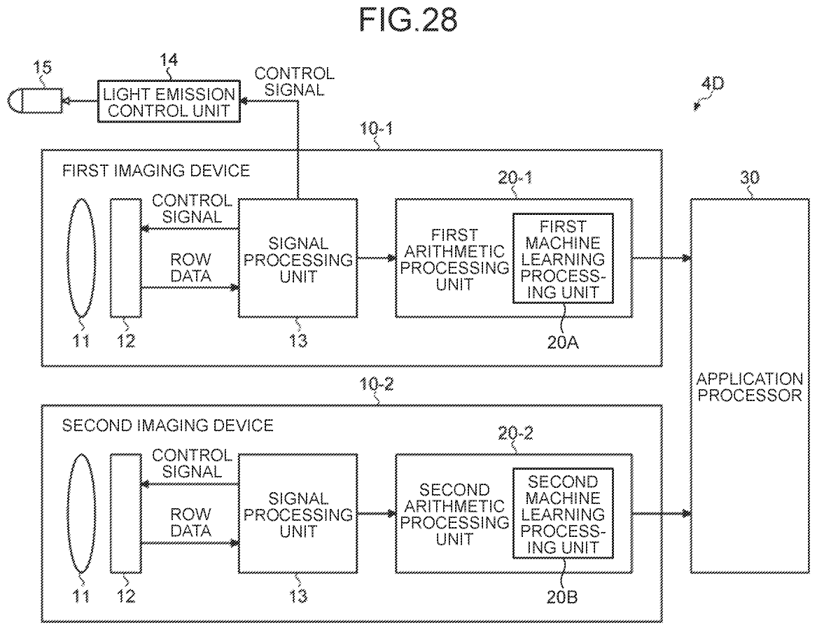

FIG. 28 is a block diagram illustrating a configuration example of an information processing system 4D according to a fourth example of the present embodiment. In the information processing system 4A illustrated in FIG. 25, the first arithmetic processing unit 20-1 and the first imaging device 10-1 are different blocks and the second arithmetic processing unit 20-2 and the second imaging device 10-2 are different blocks. In contrast, the information processing system 4D according to the fourth example illustrated in FIG. 28 is different in that the first arithmetic processing unit 20-1 is provided on the inside of the first imaging device 10-1 and the second arithmetic processing unit 20-2 is provided on the inside of the second imaging device 10-2. The other components and operations are the same as the components and the operations of the information processing system 4A illustrated in FIG. 25. Therefore, explanation thereof is omitted.

As in the information processing system 4A illustrated in FIG. 25, the information processing system 4D according to the fourth example is capable of achieving improvement in processing accuracy (for example, improvement of recognition accuracy), improvement in image quality deteriorated because of an optical factor, an electrical factor, or the like, prevention of leakage of information relating to security or privacy, and the like by executing processing (correction) for image data, which is data acquired by a sensor, before executing processing (for example, recognition processing) for information in the application processor 30. As a result, it is possible to obtain information in which processing accuracy (for example, recognition accuracy) and image quality are further improved than information obtained in the publicly-known fusion type sensor or information in which leakage of information relating to security and privacy is prevented.

### 5. Specific Configuration Example of an Imaging Device

Next, a specific configuration example of the imaging device 10 in the embodiments or the modifications thereof is explained in detail with reference to the drawings.

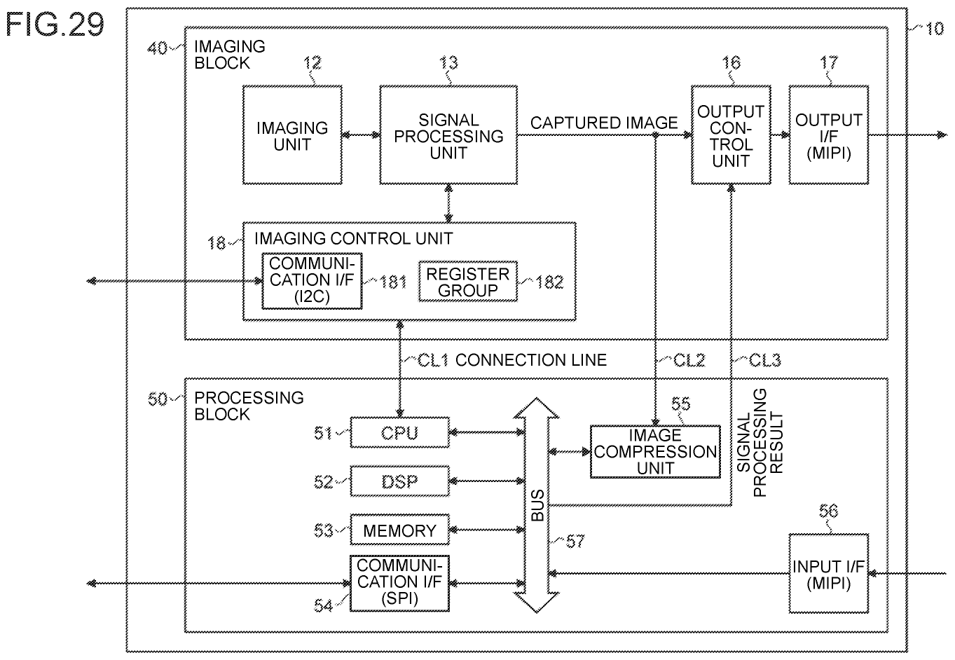

FIG. 29 is a block diagram illustrating a configuration example of the imaging device according to the present disclosure. In FIG. 29, the imaging device 10 includes an imaging block 40 and a processing block 50. The imaging block 40 and the processing block 50 are electrically connected by connection lines (internal buses) CL1, CL2, and CL3.

The imaging block 40 includes the imaging unit 12, the signal processing unit 13, an output control unit 16, an output interface (I/F) 17, and an imaging control unit 18, generates row data for generating a depth map or image data, and executes preprocessing for the generated row data.

The imaging unit 12 is configured with a plurality of pixels 120 (see FIG. 2) arranged two-dimensionally. The imaging unit 12 is driven by the signal processing unit 13 and reads row data from the pixel array unit 121.

That is, light is made incident on the imaging unit 12 via the lens 11 (see FIG. 1 and the like). The pixels 120 in the pixel array unit 121 of the imaging unit 12 receive the incident light from the lens 11, perform photoelectric conversion, and output an analog pixel signal corresponding to the incident light.

Note that a size of row data (image data) output by the imaging unit 12 can be selected from a plurality of sizes such as 12M (3968×2976) pixels and a VGA (Video Graphics Array) size (640×480 pixels).

For the row data (the image data) output by the imaging unit 12, for example, it may be possible to select whether to set the row data (the image data) as a color image of RGB (Red, Green, Blue) or set as a monochrome image of only luminance. The selection of the color image or the monochrome image may be performed as a type of setting of an imaging mode.

According to control of the imaging control unit 18, the signal processing unit 13 executes driving of the imaging unit 12, preprocessing for the row data output from the imaging unit 12, and the like.

A depth map or image data output from the signal processing unit 13 is supplied to the output control unit 16 and supplied to an image compression unit 55 of the processing block 50 via the connection line CL2.

Besides the depth map or the image data being supplied to the output control unit 16 from the signal processing unit 13, a result of signal processing for the depth map or the image data may be supplied to the output control unit 16 from the processing block 50 via the connection line CL3. This signal processing may include the specifying of a target pixel executed by the arithmetic processing unit 20 (S14, 201), the correction of the target pixel (S15, 202), and the recognition processing (S16, 301).

The output control unit 16 performs output control for selectively outputting, from the (one) output I/F 17 to, for example, the application processor 30 on the outside, the depth map or the image data from the signal processing unit 13 and the signal processing result from the processing block 50.

That is, the output control unit 16 selects the depth map or the image data from the signal processing unit 13 or the signal processing result from the processing block 50 and supplies the depth map or the image data or the signal processing result to the output I/F 17.

The output I/F 17 is an interface that outputs, to the outside, the depth map or the image data and the signal processing result supplied from the output control unit 16. For example, a relatively high-speed parallel I/F such as an MIPI (Mobile Industry Processor Interface) can be adopted as the output I/F 17.

In the output I/F 17, the depth map or the image data from the signal processing unit 13 or the signal processing result from the processing block 50 is output to the outside according to the output control of the output control unit 16. Therefore, for example, when only the signal processing result from the processing block 50 is necessary and the depth map or the image data itself is unnecessary on the outside, only the signal processing result can be output and an amount of data output from the output I/F 17 to the outside can be reduced.

In the processing block 50, by performing signal processing for obtaining a signal processing result required on the outside and outputting the signal processing result from the output I/F 17, it is unnecessary to perform signal processing on the outside and it is possible to reduce a load on an external block.

The imaging control unit 18 includes a communication I/F 181 and a register group 182.

The communication I/F 181 is, for example, a first communication I/F such as a serial communication I/F such as an I2C (Inter-Integrated Circuit) and exchanges necessary information such as information to be read from and written in the register group 182 with, for example, the application processor 30 on the outside.

The register group 182 includes a plurality of registers and stores imaging information relating to capturing of an image by the imaging unit 12 and other various kinds of information.

For example, the register group 182 stores imaging information received from the outside in the communication I/F 181 and a result of preprocessing in the signal processing unit 13 (for example, brightness for each small area in row data).

The imaging information stored in the register group 182 can include, for example, (information representing) ISO sensitivity (an analog gain at the time of AD conversion), an exposure time (shutter speed), a frame rate, a focus, an imaging mode, a cutout range, and the like.

The imaging mode includes, for example, a manual mode in which an exposure time, a frame rate, and the like are manually set and an automatic mode in which the exposure time, the frame rate, and the like are automatically set according to a scene. Examples of the automatic mode include modes corresponding to various photographing scenes such as a night scene and a person's face.

The imaging control unit 18 controls the signal processing unit 13 according to the imaging information stored in the register group 182 to thereby control reading of row data in the imaging unit 12.

Note that the register group 182 can store output control information concerning output control in the output control unit 16 besides imaging information and a result of preprocessing in the signal processing unit 13. The output control unit 16 can perform output control for selectively outputting a depth map or image data and a signal processing result according to the output control information stored in the register group 182.

In the imaging device 10, the imaging control unit 18 and a CPU 51 of the processing block 50 are connected via a connection line CL1 and the CPU 51 can read and write information from and in the register group 182 via the connection line CL1.

That is, in the imaging device 10, reading and writing of information from and in the register group 182 can be performed from the CPU 51 as well and besides being performed from the communication I/F 181.

The processing block 50 includes the CPU 51, a DSP 52, a memory 53, a communication I/F 54, an image compression unit 55, and an input I/F 56 and performs predetermined signal processing using a depth map, image data, or the like obtained by the imaging block 40.

The CPU 51 to the input I/F 56 configuring the processing block 50 are connected to one another via a bus and can exchange information according to necessity.

The CPU 51 executes a program stored in the memory 53 to perform control of the processing block 50, reading and writing of information from and in the register group 182 of the imaging control unit 18 via the connection line CL1, and other various processes.

For example, by executing the program, the CPU 51 functions as an imaging information calculation unit that calculates imaging information using a signal processing result obtained by signal processing in the DSP 52 and feeds back new imaging information calculated using the signal processing result to the register group 182 of the imaging control unit 18 via the connection line CL1 and causes the register group 182 to store the new imaging information.

Therefore, as a result, the CPU 51 can control imaging in the imaging unit 12 and imaging signal processing in the signal processing unit 13 according to a signal processing result of a depth map or image data.

The imaging information that the CPU 51 causes the register group 182 to store can be provided (output) to the outside from the communication I/F 181. For example, information concerning a focus in the imaging information stored in the register group 182 can be provided from the communication I/F 181 to a focus driver (not illustrated) that controls the focus.

The DSP 52 executes a program stored in the memory 53 to function as a signal processing unit that performs signal processing using a depth map or image data supplied from the signal processing unit 13 to the processing block 50 via the connection line CL2 or information received from the outside by the input I/F 56.

The DSP 52 is also capable of functioning as the arithmetic processing unit 20 in the embodiments or the modifications thereof explained above. In that case, the DSP 52 executes the processing for specifying the target pixel (S14, 201) by reading and loading a learning model for specifying a target pixel from the memory 53, the application processor 30 on the outside, or the like. The DSP 52 executes the processing for correcting the target pixel (S15, 202) by reading and loading a learning model for correcting the target pixel from the memory 53, the application processor 30 on the outside, or the like or by reading and executing a program.

Further, the DSP 52 is also capable of functioning as a block that executes the recognition processing (S16, 301) in the embodiments or the modifications thereof explained above. In that case, the DSP 52 executes the recognition processing for the corrected depth map or image data (S15, 202) by reading and loading a learning model for performing recognition processing (S16, 301) from the memory 53, the application processor 30 on the outside, or the like or reading and executing a program.

The memory 53 is configured by an SRAM (Static Random Access Memory), a DRAM (Dynamic RAM), or the like and stores data and the like necessary for processing of the processing block 50.

For example, the memory 53 stores a program received from the outside in the communication I/F 54, a depth map or image data compressed by the image compression unit 55 and used in signal processing in the DSP 52, a signal processing result of the signal processing performed in the DSP 52, information received by the input I/F 56, and the like.

The communication I/F 54 is, for example, a second communication I/F such as a serial communication I/F such as an SPI (Serial Peripheral Interface), and exchanges necessary information such as a program executed by the CPU 51 or the DSP 52 with, for example, the application processor 30 on the outside.

For example, the communication I/F 54 downloads a program to be executed by the CPU 51 or the DSP 52 from the outside, supplies the program to the memory 53, and causes the memory 53 to store the program.

Therefore, various kinds of processing can be executed in the CPU 51 or the DSP 52 according to the program downloaded by the communication I/F 54.

Note that the communication I/F 54 can exchange any data besides programs with the outside. For example, the communication I/F 54 can output a signal processing result obtained by the signal processing in the DSP 52 to the outside. The communication I/F 54 can output information conforming to an instruction of the CPU 51 to an external device to thereby control the external device according to the instruction of the CPU 51.

The signal processing result obtained by the signal processing in the DSP 52 can be written in the register group 182 of the imaging control unit 18 by the CPU 51 besides being output from the communication I/F 54 to the outside. The signal processing result written in the register group 182 can be output from the communication I/F 181 to the outside. The same applies to a processing result of the processing performed by the CPU 51.

A depth map or image data is supplied from the signal processing unit 13 to the image compression unit 55 via the connection line CL2. The image compression unit 55 reduces a data amount of the depth map or the image data by performing compression processing for compressing the depth map or the image data.

The depth map or the image data generated by the image compression unit 55 is supplied to the memory 53 via the bus and stored in the memory 53.

Here, the signal processing in the DSP 52 can be performed using compressed data generated from the depth map or the image data in the image compression unit 55 besides being performed using the depth map or the image data itself. Since the compressed data has a smaller data amount than the original depth map or image data, it is possible to realize reduction of a load of the signal processing in the DSP 52 and saving of a storage capacity of the memory 53 that stores the depth map or image data.

As the compression processing in the image compression unit 55, for example, scale-down for converting a depth map or image data having 12M (3968×2976) pixels into a depth map or image data having a VGA size can be performed. When the signal processing in the DSP 52 is performed targeting luminance and target data is RGB image data, the compression processing can include YUV conversion for converting an RGB image into, for example, a YUV image.

Note that the image compression unit 55 can be realized by software or can be realized by dedicated hardware.

The input I/F 56 is an I/F that receives information from the outside. The input I/F 56 receives, for example, from an external sensor, output of the external sensor (external sensor output), supplies the output to the memory 53 via a bus, and causes the memory 53 to store the output.

For example, like the output I/F 17, a parallel I/F such as an MIPI (Mobile Industry Processor Interface) can be adopted as the input I/F 56.

Furthermore, as the external sensor, for example, a distance sensor that senses information concerning a distance can be adopted. Further, as the external sensor, for example, an image sensor that senses light and outputs image data corresponding to the light, in other words, an image sensor separate from the imaging device 10 can be adopted.

In the DSP 52, besides using (compressed data generated from) the depth map or the image data, the input I/F 56 can perform the signal processing using the external sensor output received by the input I/F 56 from the external sensor explained above and stored in the memory 53.

In the one-chip imaging device 10 configured as explained above, the signal processing using (the compressed data generated from) the depth map or the image data obtained by the imaging in the imaging unit 12 is performed by the DSP 52 and a signal processing result of the signal processing and the depth map or image data are selectively output from the output I/F 17. Therefore, it is possible to downsize the imaging device that outputs the information required by the user.

Here, when the signal processing of the DSP 52 is not performed in the imaging device 10 and, therefore, the signal processing result is not output and the depth map or the image data is output from the imaging device 10, that is, when the imaging device 10 is configured as an image sensor that only generates and outputs the depth map or the image data, the imaging device 10 can also be configured by only the imaging block 40 in which the output control unit 16 is not provided.

### 5.1 Modification of the Imaging Device

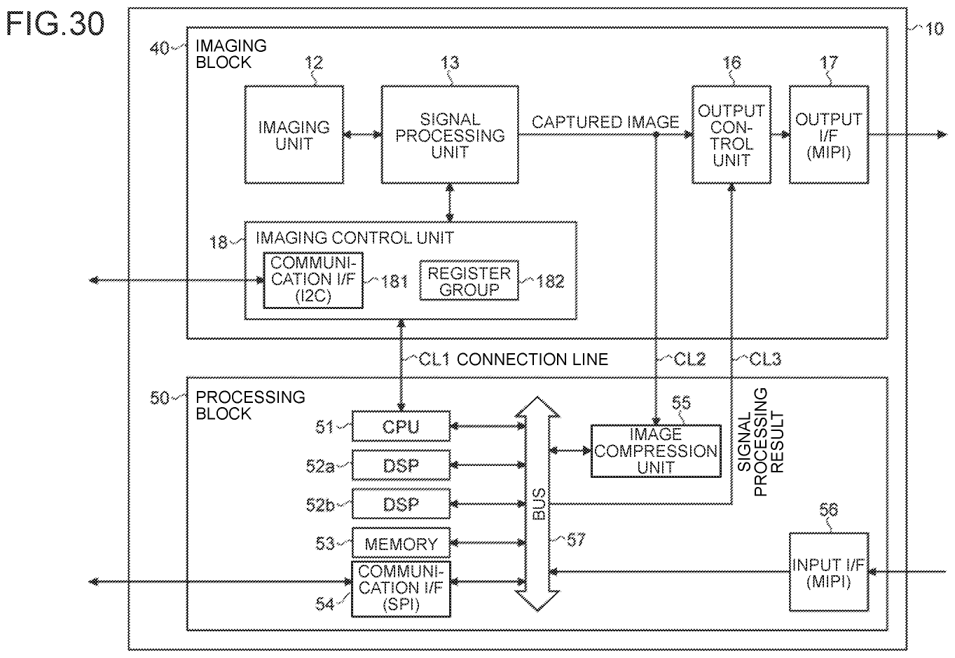

For example, in the embodiments explained above, when the imaging device 10 includes the arithmetic processing unit 20 (FIG. 7 to FIG. 9, FIG. 13, FIG. 17 to FIG. 18, and the like) or when the imaging device 10 executes processing such as recognition processing (S16, 301) (FIG. 9, FIG. 18, and the like), that is, when two or more learning models are used in the imaging device 10, as illustrated in FIG. 30, the processing block 50 of the imaging device 10 may include two or more DSPs 51a and 52b and may be configured such that different learning models are respectively loaded in the DSPs 51a and 52b. For example, in the example illustrated in FIG. 30, a learning model for specifying a target pixel may be loaded in a DSP 52a and a learning model for correcting the target pixel may be loaded in the DSP 52b.

The same may be applied, for example, when the arithmetic processing unit 20 is disposed on the outside of the imaging device 10 (FIG. 1, FIG. 3, FIG. 11, FIG. 14 to FIG. 16, and the like). That is, when the arithmetic processing unit 20 is configured by a DSP or the like disposed on the outside of the imaging device 10, the arithmetic processing unit 20 may include two or more DSPs, that is, a DSP for specifying a target pixel and a DSP for correcting the target pixel. When the arithmetic processing unit 20 executes the recognition processing (S16, 301), the arithmetic processing unit 20 may separately include a DSP for recognition processing.

### 6. Use Case

Next, use cases of the information processing system according to the embodiments or the modifications thereof explained above are explained with reference to an example. Note that, in the following explanation, use cases based on the information processing system according to the third embodiment are illustrated. However, not only this, but use cases can also be based on the information processing systems according to the other embodiments or the modifications thereof.

### 6.1 First Example

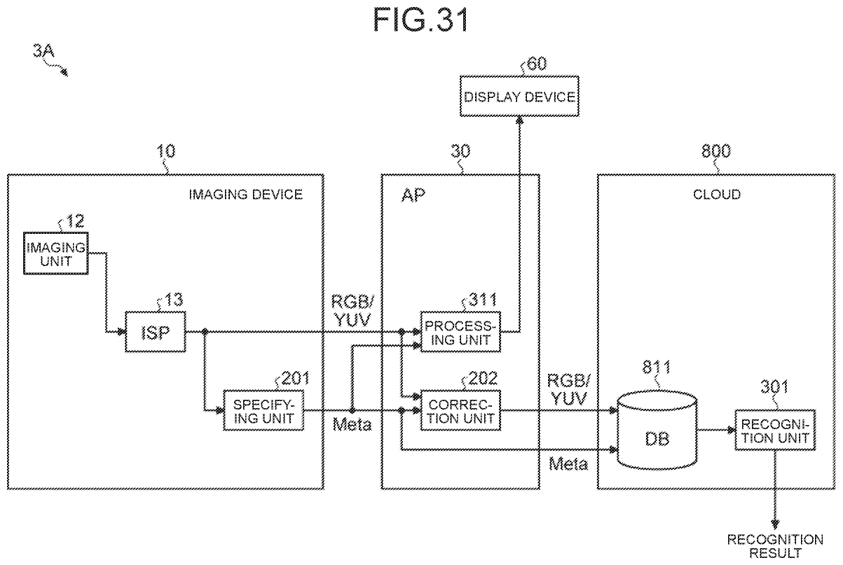

In a first example, a use case in the case in which an information processing system is introduced into a commercial facility such as a store is explained. FIG. 31 is a block diagram illustrating a schematic configuration example of an information processing system according to the first example. Note that, in the first example, a case is illustrated in which the target pixel specifying 201 in the third embodiment is executed by the imaging device 10, the target pixel correction 202 is executed by the application processor 30, and the recognition processing 301 is executed by an external Cloud server or the like.

As illustrated in FIG. 31, in the first example, the imaging device 10 includes an imaging unit 12, the signal processing unit (ISP) 13, and a specifying unit 201. Since the specifying unit 201 is a block that executes the target pixel specifying 201, the same reference numeral is used for convenience. In FIG. 15, the lens 11 disposed on the light receiving surface of the imaging unit 12 is omitted.

Row data generated by the imaging unit 12 is preprocessed by the signal processing unit 13 and, thereafter, input to the specifying unit 201 a target pixel is specified. A region of the specified target pixel is input to the application processor 30 as metadata (Meta) indicating the position and size of the region.

The application processor 30 includes a correction unit 202 and a processing unit 311. Since the correction unit 202 is a block that executes the target pixel correction 202, the same reference numeral is used for convenience.

Besides the metadata (Meta) indicating the position and the size of the region of the target pixel, image data preprocessed by the signal processing unit 13 is also input to the correction unit 202. The correction unit 202 executes, on the target pixel belonging to the region indicated by the metadata in the input image data, correction processing for correcting a pixel value of the target pixel. The image data in which the target pixel is corrected is uploaded to the Cloud 800 together with the metadata. At that time, since the uploaded image data is data in which the target pixel has been corrected, for example, it is possible to prevent information relating to security and privacy from leaking to the outside.

As in the correction unit 202, the image data preprocessed by the signal processing unit 13 and the metadata (meta) indicating the position and the size of the region of the target pixel are input to the processing unit 311. For example, the processing unit 311 executes, based on the metadata, processing for processing input image data, processing for generating image data to be superimposed and displayed on the image data, and the like. The image data processed by or the image data generated by the processing unit 311 is displayed on a display device 60.

The Cloud 800 includes, for example, a database (DB) 811 and a recognition unit 301. Since the recognition unit 301 is a block that executes the recognition processing 301, the same reference numeral is used for convenience.

The database 811 accumulates the corrected image data and the metadata uploaded from the application processor 30.

The recognition unit 301 executes recognition processing on the image data and the metadata accumulated in the database 811.

When an information processing system 3A explained above is introduced into a commercial facility such as a store, the imaging device 10 is installed, for example, at an entrance or in one or a plurality of places in the store. That is, the information processing system 3A can include one or a plurality of imaging devices 10.

Image data and metadata acquired by the imaging devices 10 are input to a common or individual application processor 30. The correction unit 202 of one or a plurality of application processors 30 executes target pixel correction processing on the image data and the metadata input from the imaging devices 10 and uploads a result of the correction processing to the common Cloud 800. Therefore, the corrected image data and the metadata based on the image data acquired by one or a plurality of imaging devices 10 are accumulated in the database 811 of the Cloud 800. Consequently, the recognition unit 301 can execute recognition processing for the corrected image data and the metadata based on the image data acquired by the one or the plurality of imaging devices 10.

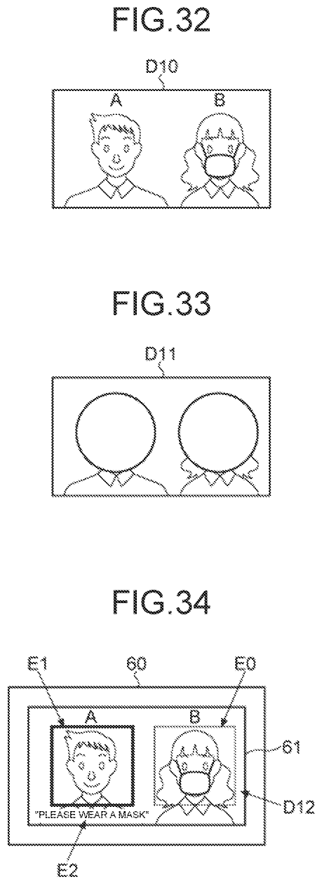

For example, when one of the one or the plurality of imaging devices 10 is installed at the entrance to detect whether an entering person is wearing a mask, as illustrated in FIG. 32, in the imaging device 10 installed at the entrance, for example, image data D10 including the faces of an entering persons A and B is acquired. The acquired image data D10 is preprocessed by the signal processing unit 13 and, thereafter, input to the specifying unit 201, the correction unit 202, and the processing unit 311.

In response to the input of image data D10, the specifying unit 201 outputs metadata such as a masking target region, face IDs of entering persons, estimated ages of the entering persons, sexes of the entering persons, whether or not the entering persons are wearing masks, and position information (coordinate information) of the entering persons. The face ID may be identification information linked with information for specifying an individual but is preferably information with which an image of an individual's face cannot be restored from the face ID. The output metadata is input to the correction unit 202 and the processing unit 311.

The correction unit 202 executes, based on the input image data and the metadata, masking processing for a region (a face in this example) relating to privacy of the entering persons A and B. As a result, as illustrated in FIG. 33, image data D11 in which regions R11 and R12 of the faces of the entering persons A and B are masked is output from correction unit 202. The output image data D11 is accumulated in the database of the Cloud 800 together with the metadata.

On the other hand, the processing unit 311 determines, based on the input image data and the metadata, whether the entering persons are wearing masks and executes image processing and/or image generation processing for issuing a warning or the like to the entering person A not wearing a mask. For example, as illustrated in FIG. 34, the correction unit 202 may execute image processing or image generation for surrounding, with a frame E1 of a warning color such as red, the entering person A not wearing a mask. The correction unit 202 may execute image processing or image generation for displaying, with characters E2 or the like, a warning for urging the entering person A to wear a mask. Note that the correction unit 202 may execute image processing or image generation such as processing with a green frame E0 for the entering person B for whom warning is unnecessary.

As illustrated in FIG. 34, the image data D12 processed or generated by the processing may be displayed on, for example, a screen 61 of the display device 60 installed for entering persons near the entrance.

The recognition unit 301 of the Cloud 800 may execute recognition processing (analysis processing) or the like that receives, as input, the information (corrected image data and metadata) accumulated in the database 811 and outputs, for example, a traffic line analysis result or a purchase point analysis result of an entering person. A result obtained by the recognition processing (the analysis processing) may be presented to the user as visible information such as an image or a character.

### 6.2 Second Example

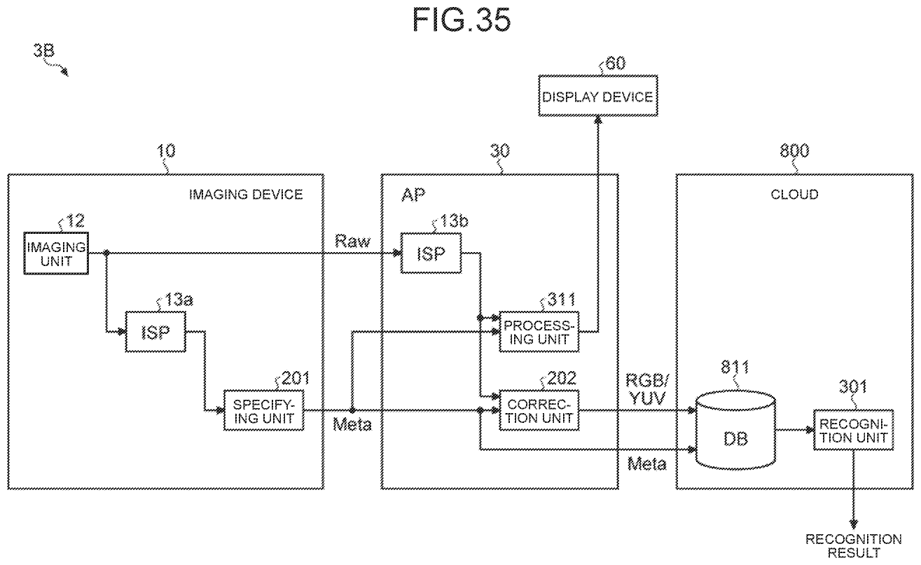

In a second example, a modification of the first example is explained. FIG. 35 is a block diagram illustrating a schematic configuration example of an information processing system according to the second example. In the following explanation, components, operations, and effects that are the same as the components, the operations, and the effects in the first example are cited to omit redundant explanation thereof.

As illustrated in FIG. 35, in an information processing system 3B according to the second example, in the same configuration as the configuration of the information processing system 3A according to the first example, the signal processing unit 13 of the imaging device 10 is replaced with a signal processing unit 13a and the application processor 30 further includes a signal processing unit 13b.

Row data (image data) acquired by the imaging unit 12 is input to each of the signal processing unit 13a in the imaging device 10 and the signal processing unit 13b in the application processor 30. The signal processing unit 13a of the imaging device 10 executes, for example, as preprocessing, preprocessing specialized for specifying of a target pixel by the specifying unit 201. On the other hand, the signal processing unit 13b of the application processor 30 executes, for example, preprocessing specialized for display (including image processing and image generation) and recognition processing.

As explained above, by providing the signal processing units 13a and 13b that perform preprocessing corresponding to a purpose, it is possible not only to reduce a load of the preprocessing executed by the signal processing units 13a and 13b but also to generate preprocessed image data suitable for the purpose. Therefore, it is possible to improve a processing load, processing accuracy, and the like in the subsequent processing.

The other components, operations, and effects may be the same as the components, the operations, and the effects in the first example explained above. Therefore, detailed explanation thereof is omitted here.

### 7. Application Example in which AI is Used

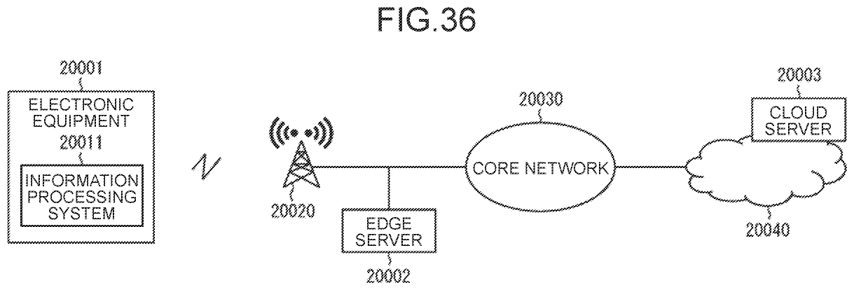

In a configuration to which the technology according to the present disclosure is applied, artificial intelligence (AI) such as machine learning can be used. For example, the preprocessing executed by the signal processing units 13, 13A, 13a, and 13b, the specifying of a target pixel (S14, 201) and the correction of the target pixel (S15, 202) executed by the arithmetic processing unit 20, the recognition processing (S16, 301) executed by the application processor 30, the arithmetic processing unit 20, the Cloud 800, and the like may be executed using the machine learning such as the DNN, the CNN, the RNN, the GAN, or the auto-encoder as explained above. Therefore, a configuration example of a system including a device that performs AI processing is explained below. FIG. 36 is a diagram illustrating a configuration example of a system including a device that performs AI processing according to the present disclosure.

Note that, in the following explanation, a case is illustrated in which the information processing system according to the embodiments or the modifications thereof is applied to a mobile terminal such as a smartphone, a tablet terminal, or a cellular phone. However, not only this, but the information processing system can be applied to various kinds of electronic equipment such as a camera and a sensor device including a wired or wireless communication function.

As illustrated in FIG. 36, electronic equipment 20001 is a mobile terminal such as a smartphone, a tablet terminal, or a cellular phone. The electronic equipment 20001 includes an information processing system to which the technology according to the present disclosure is applied (in the following explanation, a reference numeral of the information processing system according to the embodiments or the modifications thereof is ‘20011’). The electronic equipment 20001 can be connected to a network 20040 such as the Internet via a core network 20030 by being connected to a base station 20020 installed at a predetermined place by wireless communication corresponding to a predetermined communication scheme.

In a position closer to the mobile terminal such as a position between the base station 20020 and the core network 20030, an edge server 20002 for implementing mobile edge computing (MEC) is provided. A Cloud server 20003 is connected to the network 20040. The edge server 20002 and the Cloud server 20003 can perform various kinds of processing corresponding to uses. Note that the edge server 20002 may be provided in the core network 20030.

AI processing is performed by the electronic equipment 20001, the edge server 20002, the Cloud server 20003, or the information processing system 20011. The AI processing is processing the technology according to the present disclosure using AI such as machine learning. The AI processing includes learning processing and inference processing. The learning processing is processing for generating a learning model. The learning processing also includes relearning processing explained below. The inference processing is processing for performing inference using a learning model. In the following explanation, processing the processing concerning the technology according to the present disclosure without using AI is referred to as normal processing and is distinguished from AI processing.

In the electronic equipment 20001, the edge server 20002, the Cloud server 20003, or the information processing system 20011, a processor such as a CPU or a DSP executes a program or dedicated hardware such as a processor specialized for a specific use is used, whereby the AI processing is realized. For example, a GPU (Graphics Processing Unit) can be used as a processor specialized for a specific use.

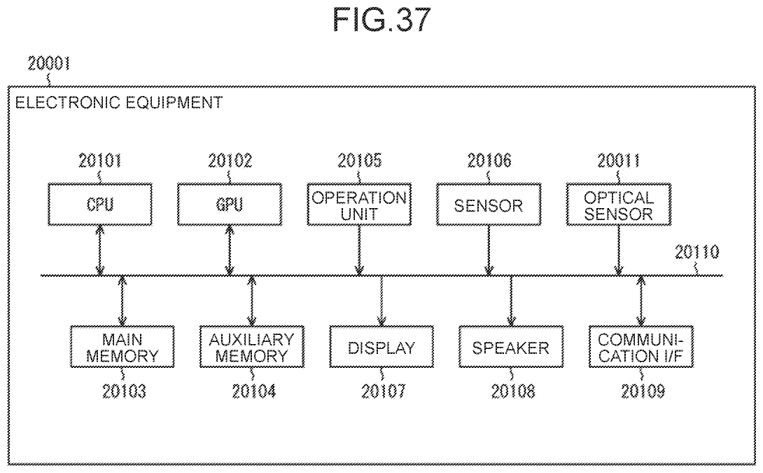

FIG. 37 illustrates a configuration example of the electronic equipment 20001. The electronic equipment 20001 includes a CPU 20101 that performs control of operations of the units and various kinds of processing, a GPU 20102 specialized for image processing and parallel processing, a main memory 20103 such as a DRAM, and an auxiliary memory 20104 such as a flash memory.

The auxiliary memory 20104 records programs for AI processing and data such as various parameters. The CPU 20101 loads the programs and parameters recorded in the auxiliary memory 20104 to the main memory 20103 and executes the programs. Alternatively, the CPU 20101 and the GPU 20102 load the programs and the parameters recorded in the auxiliary memory 20104 in the main memory 20103 and execute the programs. As a result, the GPU 20102 can be used as a GPGPU (General-Purpose computing on Graphics Processing Units).

Note that the CPU 20101 and the GPU 20102 may be configured as an SoC (System on a Chip). When the CPU 20101 executes a program for AI processing, the GPU 20102 may not be provided.

The electronic equipment 20001 also includes an information processing system 20011 to which the technology according to the present disclosure is applied, an operation unit 20105 such as physical buttons or a touch panel, a sensor 20106 including at least one or more sensors, a display 20107 that displays information such as an image or text, a speaker 20108 that outputs sound, a communication I/F 20109 such as a communication module adapted to a predetermined communication scheme, and a bus 20110 that connects the foregoing.

The sensor 20106 includes at least one or more of various sensors such as an optical sensor (an image sensor), a sound sensor (a microphone), a vibration sensor, an acceleration sensor, an angular velocity sensor, a pressure sensor, an odor sensor, and a biological sensor. In the AI processing, data acquired from the at least one or more sensors of the sensor 20106 can be used together with data (a depth map, image data, or the like) acquired from the information processing system 20011. As explained above, by using data obtained from various kinds of sensors together with the depth map, the image data, or the like, AI processing matching various scenes can be realized by a multi-modal AI technology.

Note that data acquired from two or more optical sensors by a sensor fusion technology and data obtained by integrally processing the data may be used in the AI processing. The two or more optical sensors may be a combination of the information processing system 20011 and the optical sensors in the sensor 20106 or a plurality of optical sensors may be included in the information processing system 20011. For example, the optical sensors include an RGB visible light sensor, a distance measurement sensor such as ToF (Time of Flight), a polarization sensor, an event-based sensor, a sensor that acquires an IR image, and a sensor capable of acquiring multiple wavelengths.

In the electronic equipment 20001, the AI processing can be performed by a processor such as the CPU 20101 or the GPU 20102. When the processor of the electronic equipment 20001 performs the inference processing, since the processing can be started without requiring time after a depth map, image data, or the like is acquired by the information processing system 20011, the processing can be performed at high speed. Therefore, in the electronic equipment 20001, when the inference processing is used for a use such as an application required to transmit information with a short delay time, the user can perform operation without feeling discomfort due to a delay. When the processor of the electronic equipment 20001 performs the AI processing, it is unnecessary to use a communication line, computer equipment for a server, or the like and the processing can be realized at lower cost compared with when a server such as the Cloud server 20003 is used.

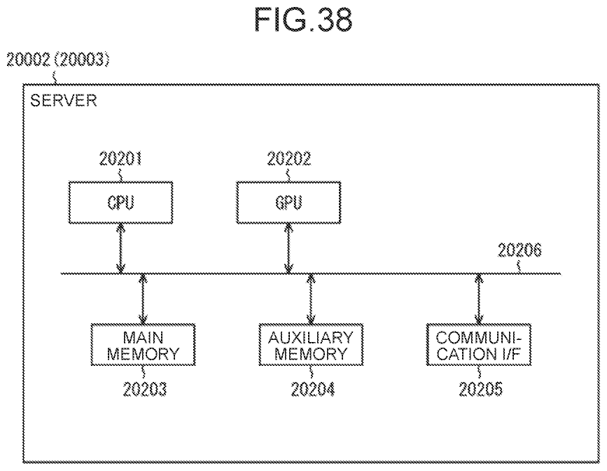

FIG. 38 illustrates a configuration example of the edge server 20002. The edge server 20002 includes a CPU 20201 that performs control of operations of the units and various kinds of processing and a GPU 20202 specialized for image processing and parallel processing. The edge server 20002 further includes a main memory 20203 such as a DRAM, an auxiliary memory 20204 such as an HDD (Hard Disk Drive) or an SSD (Solid State Drive), and a communication I/F 20205 such as an NIC (Network Interface Card), which are connected to a bus 20206.

The auxiliary memory 20204 records programs for AI processing and data such as various parameters. The CPU 20201 loads the programs and the parameters recorded in the auxiliary memory 20204 in the main memory 20203 and executes the programs. Alternatively, the CPU 20201 and the GPU 20202 can use the GPU 20202 as a GPGPU by loading the programs or the parameters recorded in the auxiliary memory 20204 in the main memory 20203 and executing the programs. Note that, when the CPU 20201 executes the programs for AI processing, the GPU 20202 may not be provided.

In the edge server 20002, AI processing can be performed by a processor such as the CPU 20201 or the GPU 20202. When the processor of the edge server 20002 performs the AI processing, since the edge server 20002 is provided in a position closer to the electronic equipment 20001 compared with the Cloud server 20003, it is possible to realize a reduction in a delay of processing. Since the edge server 20002 has higher processing capability such as calculation speed compared with the electronic equipment 20001 and the information processing system 20011, the edge server 20002 can be generally used. Therefore, when the processor of the edge server 20002 performs the AI processing, the AI processing can be performed if data can be received irrespective of a difference in specifications and performances of the electronic equipment 20001 and the information processing system 20011. When the AI processing is performed by the edge server 20002, processing loads in the electronic equipment 20001 and the information processing system 20011 can be reduced.

Since the configuration of the Cloud server 20003 is the same as the configuration of the edge server 20002, explanation thereof is omitted.

In the Cloud server 20003, the AI processing can be performed by a processor such as the CPU 20201 or the GPU 20202. Since the Cloud server 20003 has higher processing capability such as calculation speed compared with the electronic equipment 20001 and the information processing system 20011, the Cloud server 20003 can be generally used. Therefore, when the processor of the cloud server 20003 performs the AI processing, the AI processing can be performed irrespective of a difference in specifications and performances of the electronic equipment 20001 and the information processing system 20011. When it is difficult to perform high-load AI processing in the processor of the electronic equipment 20001 or the information processing system 20011, the processor of the Cloud server 20003 can perform the high-load AI processing and feedback a result of the processing to the processor of the electronic equipment 20001 or the information processing system 20011.

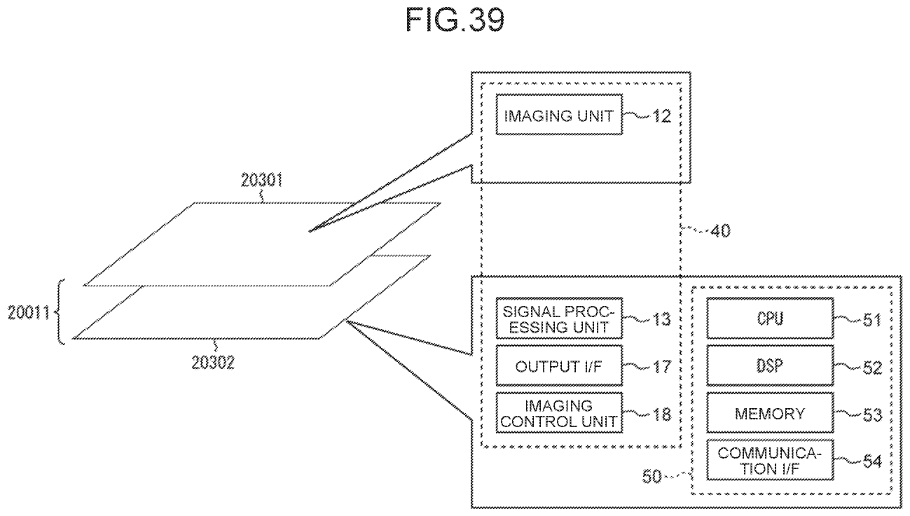

FIG. 39 illustrates a configuration example of the information processing system 20011. The information processing system 20011 can be configured as, for example, a one-chip semiconductor device having a stacked structure in which a plurality of substrates is stacked. The information processing system 20011 is configured by stacking two substrates, that is, a substrate 20301 and a substrate 20302. Note that the configuration of the information processing system 20011 is not limited to the stacked structure. For example, a substrate including an imaging unit may include a processor that performs AI processing such as a CPU or a DSP (Digital Signal Processor).

The imaging unit 12 in which a plurality of pixels are two-dimensionally arranged is mounted on the substrate 20301 in an upper layer. On the substrate 20302 in a lower layer, the signal processing unit 13 that performs processing concerning capturing of an image in the imaging unit 12, the output I/F 17 that outputs a captured image and a signal processing result to the outside, and the imaging control unit 18 that controls imaging of an image in the imaging unit 12 are mounted. The imaging block 40 is configured by the imaging unit 12, the signal processing unit 13, the output I/F 17, and the imaging control unit 18.

On the substrate 20302 in the lower 1, the CPU 51 that performs control of the units and various processes, the DSP 52 that performs signal processing using a captured image, information from the outside, and the like, the memory 53 such as an SRAM (Static Random Access Memory) or a DRAM (Dynamic Random Access Memory), and the communication I/F 54 that exchanges necessary information with the outside are mounted. The processing block 50 is configured by the CPU 51, the DSP 52, the memory 53, and the communication I/F 54. AI processing can be performed by at least one processor of the CPU 51 and the DSP 52.

Note that, in FIG. 39, for example, the output control unit 16, the image compression unit 55, and the input I/F 56 illustrated in FIG. 29 or FIG. 30 are not illustrated. However, the output control unit 16 may be mounted on the substrate 20301 in the upper layer and the image compression unit 55 and the input I/F 56 may be mounted on the substrate 20302 in the lower layer.

As explained above, the processing block 50 for AI processing can be mounted on the substrate 20302 in the lower layer in the stacked structure in which the plurality of substrates are stacked. Consequently, a depth map, image data, or the like acquired by the imaging block 40 for imaging mounted on the substrate 20301 in the upper layer is processed by the processing block 50 for AI processing mounted on the substrate 20302 in the lower layer. Therefore, a series of processing can be performed in the one-chip semiconductor device.

In the information processing system 20011, AI processing can be performed by a processor such as the CPU 51. When the processor of the information processing system 20011 performs AI processing such as inference processing, since a series of processing is performed in the one-chip semiconductor device, information does not leak to the outside of the sensor. Therefore, it is possible to enhance confidentiality of the information. Since it is unnecessary to transmit data such as the depth map and the image data to another device, the processor of the information processing system 20011 can perform the AI processing such as the inference processing using the depth map, the image data, or the like at high speed. For example, when the inference processing is used for a use such as an application requiring a real-time property, it is possible to sufficiently secure the real-time property. Here, securing the real-time property means that information can be transmitted with a short delay time. Further, when the processor of the information processing system 20011 performs the AI processing, various kinds of metadata are passed by the processor of the electronic equipment 20001, whereby it is possible to reduce processing and achieve a reduction in power consumption.

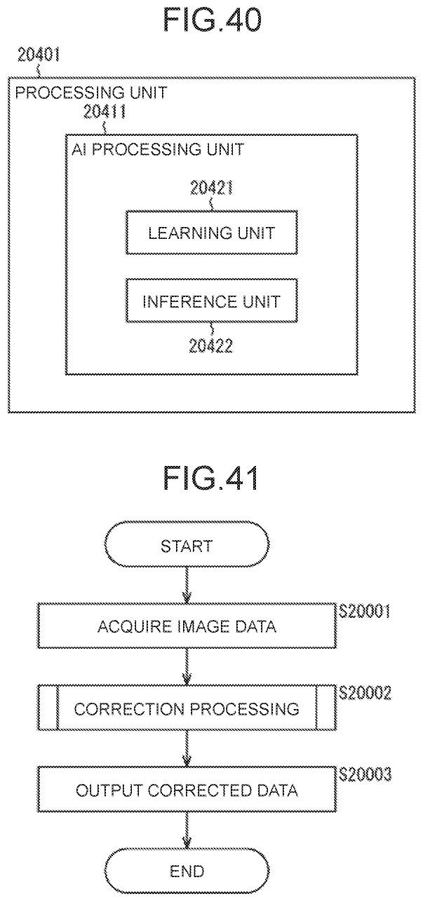

FIG. 40 illustrates a configuration example of a processing unit 20401. The processor of the electronic equipment 20001, the edge server 20002, the Cloud server 20003, or the information processing system 20011 executes various kinds of processing according to a program to function as the processing unit 20401. Note that a plurality of processors included in the same or different devices may be caused to function as the processing unit 20401.

The processing unit 20401 includes an AI processing unit 20411. The AI processing unit 20411 performs AI processing. The AI processing unit 20411 includes a learning unit 20421 and an inference unit 20422.

The learning unit 20421 performs learning processing for generating a learning model. In the learning processing, a machine-learned learning model that has performed machine learning for correcting a target pixel included in a depth map, image data, or the like is generated. The learning unit 20421 may perform relearning processing for updating the generated learning model. In the following explanation, generation and update of the learning model are distinguished and explained. However, since it can be considered that the learning model is generated by updating the learning model, the generation of the learning model includes the meaning of the update of the learning model.

The generated learning model is recorded in a storage medium such as the main memory or the auxiliary memory included in the electronic equipment 20001, the edge server 20002, the Cloud server 20003, the information processing system 20011, or the like. Therefore, the generated learning model can be used anew in inference processing performed by the inference unit 20422. Consequently, the electronic equipment 20001, the edge server 20002, the Cloud server 20003, the information processing system 20011, or the like that performs inference processing based on the learning model can be generated. Further, the generated learning model may be recorded in a storage medium or electronic equipment independent of the electronic equipment 20001, the edge server 20002, the Cloud server 20003, the information processing system 20011, or the like and provided to be used in another device. Note that the generation of the electronic equipment 20001, the edge server 20002, the Cloud server 20003, the information processing system 20011, or the like includes, at the time of manufacturing, not only recording a learning model anew in the storage media but also updating already recorded generated learning model.

The inference unit 20422 performs inference processing using the learning model. In the inference processing, processing for correcting a target pixel included in a depth map, image data, or the like is performed using the learning model. The target pixel is a pixel to be a correction target that satisfies a predetermined condition among a plurality of pixels in an image corresponding to the depth map, the image data, or the like.

As a method of machine learning, a neural network, deep learning, or the like can be used. The neural network is a model imitating a human cranial nerve circuit and includes three types of layers, that is, an input layer, an intermediate layer (a hidden layer), and an output layer. The deep learning is a model using a neural network having a multilayer structure. In the deep learning, a complex pattern hidden in a large amount of data can be learned by repeating characteristic learning in layers.

Supervised learning can be used as problem setting of the machine learning. For example, in the supervised learning, a feature value is learned based on given labeled teacher data. This makes it possible to derive a label of unknown data. As the teacher data, it is possible to use a data set and the like generated by a simulator such as a depth map, image data, or the like actually acquired by an optical sensor, and an acquired depth map, image data, or the like that is aggregated and managed.

Note that not only the supervised learning but also unsupervised learning, semi-supervised learning, reinforcement learning, and the like may be used. In the unsupervised learning, a large amount of unlabeled learning data is analyzed to extract a feature value and clustering or the like is performed based on the extracted feature value. This makes it possible to analyze and predict a tendency based on a huge amount of unknown data. The semi-supervised learning is learning in which the supervised learning and the unsupervised learning are mixed and is a method in which a feature value is learned by the supervised learning and, thereafter, a huge amount of supervised data is given by the unsupervised learning and repetitive learning is performed while the feature value is automatically calculated. The reinforcement learning deals with a problem of determining an action that an agent in a certain environment should take by observing a current state.

As explained above, the processor of the electronic equipment 20001, the edge server 20002, the Cloud server 20003, or the information processing system 20011 functions as the AI processing unit 20411, whereby the AI processing is performed by any one or a plurality of devices of these devices.

The AI processing unit 20411 only has to include at least one of the learning unit 20421 and the inference unit 20422. That is, the processors of the devices naturally execute both the learning processing and the inference processing and may execute one of the learning processing and the inference processing. For example, when the processor of the electronic equipment 20001 performs both of the inference processing and the learning processing, the electronic equipment 20001 includes the learning unit 20421 and the inference unit 20422. However, when the electronic equipment 20001 performs only the inference processing, the electronic equipment 20001 has to include only the inference unit 20422.

The processors of the devices may execute all kinds of processing concerning the learning processing or the inference processing or a part of the processing may be executed by the processors of the devices and, thereafter, the remaining processes may be performed by the processors of the other devices. The devices may include a common processor for executing the respective functions of AI processing such as learning processing and inference processing or may individually include processors for each of the functions.

Note that the AI processing may be performed by a device other than the devices explained above. For example, the AI processing can be performed by other electronic equipment to which the electronic equipment 20001 can be connected by wireless communication or the like. Specifically, when the electronic equipment 20001 is a smartphone, the other electronic equipment that performs the AI processing can be a device such as another smartphone, a tablet terminal, a cellular phone, a PC (Personal Computer), a game machine, a television receiver, a wearable terminal, a digital still camera, or a digital video camera.

Even in a configuration in which a sensor mounted on a moving body such as an automobile, a sensor used in remote medical equipment, or the like is used, AI processing such as inference processing can be applied. However, a delay time is required to be short in those environments. In such environments, the delay time can be reduced by, rather than performing the AI processing in the processor of the cloud server 20003 via the network 20040, performing the AI processing in a processor of a local-side device (for example, the electronic equipment 20001 functioning as vehicle-mounted equipment or medical equipment). Further, even when there is no environment for connection to the network 20040 such as the Internet or in the case of a device used in an environment in which high-speed connection cannot be performed, the AI processing can be performed in a more appropriate environment by performing the AI processing in a processor of a local-side device such as the electronic equipment 20001 or the information processing system 20011.

Note that the configuration explained above is an example and another configuration may be adopted. For example, the electronic equipment 20001 is not limited to a mobile terminal such as a smartphone and may be electronic equipment such as a PC, a game machine, a television receiver, a wearable terminal, a digital still camera, or a digital video camera, vehicle-mounted equipment, or medical equipment. The electronic equipment 20001 may be connected to the network 20040 by wireless communication or wired communication adapted to a predetermined communication scheme such as a wireless LAN (Local Area Network) or a wired LAN. The AI processing is not limited to the processors such as the CPUs and the GPUs of the devices. A quantum computer, a neuromorphic computer, or the like may be used.

(Flow of Processing)

A flow of processing in which AI is used is explained with reference to a flowchart of FIG. 41.

In step S20001, the processing unit 20401 acquires data (a depth map, image data, or the like) from the information processing system 20011. In step S20002, the processing unit 20401 performs correction processing on the acquired depth map, image data, or the like. In this correction processing, inference processing in which the learning model is used is performed on at least a part of the depth map, the image data, or the like and corrected data, which is data after correction of a target pixel included in the depth map, the image data, or the like is obtained. In step S20003, the processing unit 20401 outputs the corrected data obtained by the correction processing.

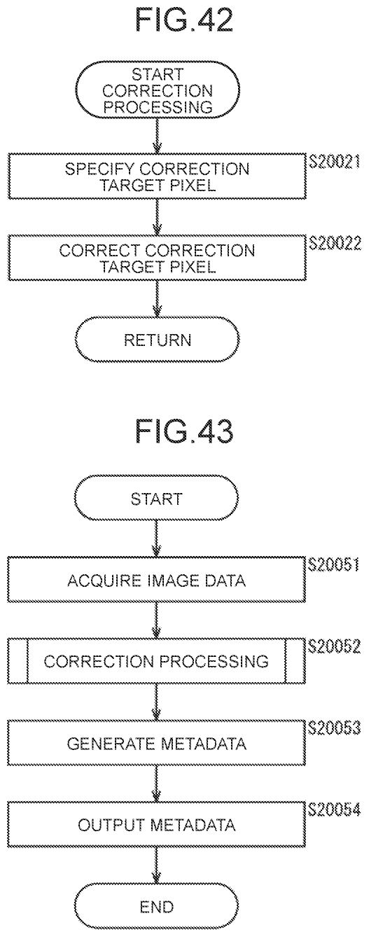

Here, details of the correction processing in step S20002 explained above are explained with reference to a flowchart of FIG. 42.

In step S20021, the processing unit 20401 specifies the target pixel included in the depth map, the image data, or the like. In the step of specifying the target pixel (hereinafter referred to as detection step), inference processing or normal processing is performed.

When the inference processing is performed as the detection step, in the inference unit 20422, the depth map, the image data, or the like is input to the learning model, whereby information (hereinafter referred to as detection information) for specifying the target pixel included in the input depth map, image data, or the like is output. Therefore, the target pixel can be specified. Here, a learning model that receives, as input, the depth map, the image data, or the like including the target pixel and outputs detection information of the target pixel included in the depth map, the image data, or the like is used. On the other hand, when the normal processing is performed as the detection step, processing for specifying the target pixel included in the depth map, the image data, or the like is performed by the processor or the signal processing circuit of the electronic equipment 20001 or the information processing system 20011 without using AI.

When the target pixel included in the depth map, the image data, or the like is specified in step S20021, the processing is advanced to step S20022. In step S20022, the processing unit 20401 corrects the specified target pixel. In the step of correcting the target pixel (hereinafter referred to as correction step), inference processing or normal processing is performed.

When the inference processing is performed as the correction step, in the inference unit 20422, the depth map, the image data, or the like and the detection information of the target pixel are input to the learning model, whereby the corrected depth map, the image data, or the like or the corrected detection information of the target pixel is output. Therefore, the target pixel can be corrected. Here, a learning model that receives, as input, the depth map, the image data, or the like including the target pixel and the detection information of the target pixel and outputs the detection information of the corrected depth map, image data, or the like or the corrected specific information of the target pixel is used. On the other hand, when the normal processing is performed as the correction step, processing for correcting the target pixel included in the depth map, the image data, or the like is performed without using AI by the processor or the signal processing circuit of the electronic equipment 20001 or the information processing system 20011.

As explained above, in the correction processing, the inference processing or the normal processing is performed in the detection step for specifying the target pixel and the inference processing or the normal processing is performed in the correction step for correcting the specified target pixel, whereby the inference processing is performed in at least one of the detection step and the correction step. That is, in the correction processing, inference processing in which the learning model is used is performed for at least a part of the depth map, the image data, or the like from the information processing system 20011.

In the correction processing, the detection step may be performed integrally with the correction step by using the inference processing. When the inference processing is performed as such the correction step, in the inference unit 20422, the depth map, the image data, or the like in which the target pixel is corrected is output by inputting the depth map, the image data, and the like to the learning model. Therefore, the target pixel included in the input depth map, image data, or the like can be corrected. Here, a learning model that receives, as input, the depth map, the image data, or the like including the target pixel and outputs the depth map, the image data, or the like in which the target pixel is corrected is used.

The processing unit 20401 may generate metadata using corrected data. A flowchart of FIG. 43 illustrates a flow of processing in the case in which metadata is generated.

In steps S20051 and S20052, as in steps S20001 and S20002 explained above, the depth map, the image data, or the like is acquired and the correction processing in which the acquired depth map, image data, or the like is used is performed. In step S20053, the processing unit 20401 generates metadata using corrected data obtained by the correction processing. In the step of generating metadata (hereinafter referred to as generation step), inference processing or normal processing is performed.

When the inference processing is performed as the generation step, in the inference unit 20422, the corrected data is input to the learning model, whereby metadata concerning the input corrected data is output. Therefore, the metadata can be generated. Here, a learning model that receives the corrected data as input and outputs the metadata is used. For example, the metadata includes three-dimensional data such as a point Cloud or a data structure. Note that the processing in steps S20051 to S20054 may be performed by end-to-end machine learning. On the other hand, when normal processing is performed as the generation step, processing of generating metadata from the corrected data is performed without using AI by the processor or the signal processing circuit of the electronic equipment 20001 or the information processing system 20011.

As explained above, in the electronic equipment 20001, the edge server 20002, the Cloud server 20003, or the information processing system 20011, as the correction processing in which the depth map, the image data, or the like from the information processing system 20011 is used, the detection step for specifying the target pixel and the correction step for correcting the target pixel are performed or the correction step for correcting the target pixel included in the depth map, the image data, or the like is performed. Further, the electronic equipment 20001, the edge server 20002, the Cloud server 20003, or the information processing system 20011 can perform the generation step for generating metadata using the corrected data obtained by the correction processing.

Further, by recording the data such as the corrected data and the metadata in a readable storage medium, the storage medium in which those data are recorded or a device such as electronic equipment on which the storage medium is mounted can also be generated. The storage medium may be a storage medium such as the main memory or the auxiliary memory provided in the electronic equipment 20001, the edge server 20002, the Cloud server 20003, or the information processing system 20011 or may be a storage medium or electronic equipment independent of the electronic equipment 20001, the edge server 20002, the Cloud server 20003, or the information processing system 20011.

When the detection step and the correction step are performed in the correction processing, the inference processing in which the learning model is used can be performed in at least one step among the detection step, the correction step, and the generation step. Specifically, after the inference processing or the normal processing is performed in the detection step, the inference processing or the normal processing is performed in the correction step, and further, the inference processing or the normal processing is performed in the generation step. Therefore, the inference processing is performed in at least one step.

When only the correction step is performed in the correction processing, the inference processing can be performed in the correction step and the inference processing or the normal processing can be performed in the generation step. Specifically, after the inference processing is performed in the correction step, the inference processing or the normal processing is performed in the generation step, whereby the inference processing is performed in at least one step.

As explained above, in the detection step, the correction step, and the generation step, the inference processing may be performed in all the steps or the inference processing may be performed in a part of the steps and the normal processing may be performed in the remaining steps. In the following explanation, processing in the case in which inference processing is performed in the steps is explained.

(A) Processing in the Case in which the Inference Processing is Performed in the Detection Step

When the detection step and the correction step are performed in the correction processing, when the inference processing is performed in the detection step, in the inference unit 20422, a learning model that receives, as input, a depth map, image data, or the like including a target pixel and outputs detection information of the target pixel included in the depth map, image data, or the like is used. This learning model is generated by the learning processing by the learning unit 20421, provided to the inference unit 20422, and used when the inference processing is performed.

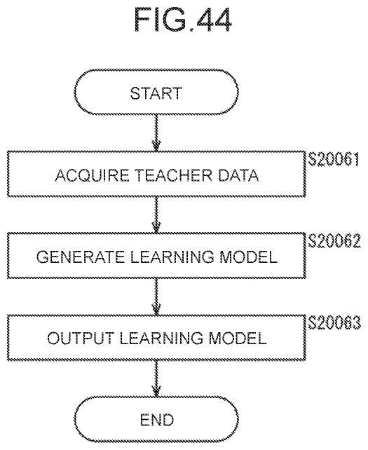

A flow of the learning processing performed in advance in performing inference processing in the detection step when the detection step and the correction step are performed in the correction processing is explained as follows with reference to a flowchart of FIG. 44. That is, the learning unit 20421 acquires, as teacher data, a data set or the like generated by a simulator such as a depth map, image data, or the like actually acquired by an optical sensor and an acquired depth map, image data, or the like that is aggregated and managed (S20061), and generates a learning model using the acquired teacher data (S20062). As this learning model, a learning model that receives, as input, a depth map, image data, or the like including a target pixel and outputs detection information of the target pixel included in the depth map, image data, or the like is generated and output to the inference unit 20422 (S20063).

(B) Processing in the Case in which the Inference Processing is Performed in the Correction Step

When the detection step and the correction step are performed in the correction processing, when the inference processing is performed in the correction step, in the inference unit 20422, a learning model that receives, as input, a depth map, image data, or the like including a target pixel and detection information of the target pixel and outputs the corrected depth map, image data, or the like or the corrected specific information of the target pixel is used. This learning model is generated by the learning processing by the learning unit 20421.

A flow of learning processing performed in advance in performing the inference processing in the correction step when the detection step and the correction step are performed in the correction processing is explained as follows with reference to the flowchart of FIG. 44. That is, the learning unit 20421 acquires, as teacher data, a depth map, image data, or the like from an optical sensor, a data set from a simulator, and the like (S20061) and generates a learning model using the acquired teacher data (S20062). As this learning model, a learning model that receives, as input, a depth map, image data, or the like including a target pixel and detection information of the target pixel and outputs a corrected depth map, image data, or the like or corrected detection information of the target pixel is generated and output to the inference unit 20422 (S20063).

(C) Processing in the Case in which the Inference Processing is Performed in the Correction Step

When only the correction step is performed in the correction processing, when the inference processing is performed in the correction step, in the inference unit 20422, a learning model that receives, as input, a depth map, image data, or the like including a target pixel and outputs the depth map, the image data, or the like in which the target pixel is corrected is used. This learning model is generated by the learning processing by the learning unit 20421.

A flow of the learning processing performed in advance in performing the inference processing in the correction step when only the correction step is performed in the correction processing is explained as follows with reference to the flowchart of FIG. 44. That is, the learning unit 20421 acquires, as teacher data, a depth map, image data, or the like from an optical sensor, a data set from a simulator, and the like (S20061) and generates a learning model using the acquired teacher data (S20062). As this learning model, a learning model that receives, as input, a depth map, image data, or the like including a target pixel and outputs the depth map, the image data, or the like in which the target pixel is corrected is generated and output to the inference unit 20422 (S20063).

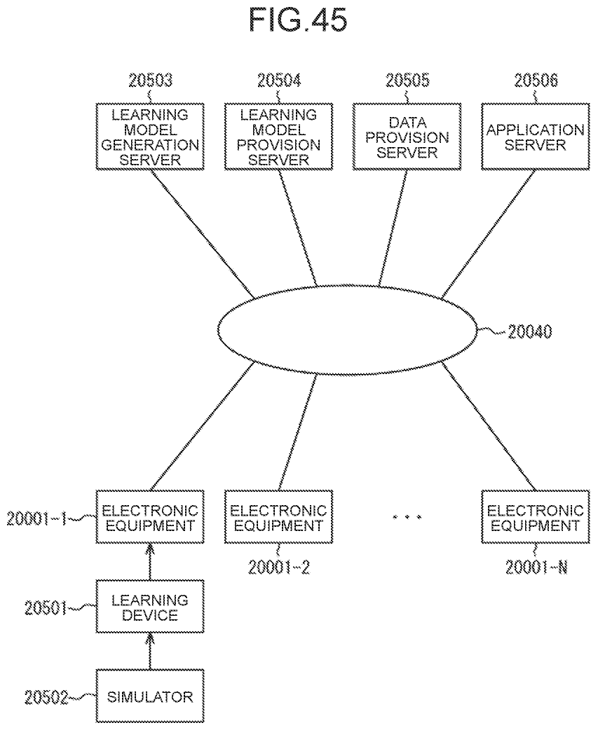

Incidentally, the data such as the learning mode, the depth map, the image data, or the like and the corrected data are naturally used in a single device and may be exchanged among a plurality of devices and used in the devices. FIG. 45 illustrates a flow of the data among the plurality of devices.

Electronic equipment 20001-1 to electronic equipment 20001-N (N is an integer equal to or larger than 1) are, for example, possessed by each of users and can be respectively connected to the network 20040 such as the Internet via a base station (not illustrated) or the like. At the time of manufacturing, a learning device 20501 is connected to the electronic equipment 20001-1. A learning model provided by the learning device 20501 can be recorded in the auxiliary memory 20104. The learning device 20501 generates a learning model using, as teacher data, a data set generated by the simulator 20502 and provides the learning model to the electronic equipment 20001-1. Note that the teacher data is not limited to the data set provided from the simulator 20502. A depth map, image data, or the like actually acquired by an optical sensor, an acquired depth map, image data, or the like that is aggregated and managed, and the like may be used.

Although not illustrated, like the electronic equipment 20001-1, the electronic equipment 20001-2 to the electronic equipment 20001-N can also record a learning model at a state of the manufacturing time. In the following explanation, the electronic equipment 20001-1 to the electronic equipment 20001-N are referred to as electronic equipment 20001 when it is unnecessary to distinguish the electronic equipment 20001-1 to the electronic equipment 20001-N from one another.

Besides the electronic equipment 20001, a learning model generation server 20503, a learning model provision server 20504, a data provision server 20505, and an application server 20506 are connected to the network 20040 and can exchange data with one another. The servers can be provided as a Cloud server.

The learning model generation server 20503 has the same configuration as the configuration of the Cloud server 20003 and can perform learning processing with a processor such as a CPU. The learning model generation server 20503 generates a learning model using teacher data. In the illustrated configuration, a case is illustrated in which the electronic equipment 20001 records a learning model at the time of manufacturing. However, the learning model may be provided from the learning model generation server 20503. The learning model generation server 20503 transmits the generated learning model to the electronic equipment 20001 via the network 20040. The electronic equipment 20001 receives the learning model transmitted from the learning model generation server 20503 and records the learning model in the auxiliary memory 20104. Consequently, the electronic equipment 20001 including the learning model is generated.

That is, when a learning model is not recorded in the stage at the manufacturing time in the electronic equipment 20001, the electronic equipment 20001 in which a new learning model is recorded is generated by recording a learning model from the learning model generation server 20503 anew. When a learning model has already been recorded in the stage at the manufacturing time in the electronic equipment 20001, the electronic equipment 20001 in which an updated learning model recorded is generated by updating the recorded learning model to the learning model from the learning model generation server 20503. The electronic equipment 20001 can perform inference processing using a learning model that is updated as appropriate.

The learning model is not limited to be directly provided from the learning model generation server 20503 to the electronic equipment 20001 and may be provided by the learning model provision server 20504, which aggregates and manages various learning models, via the network 20040. The learning model provision server 20504 provides the learning model not only to the electronic equipment 20001 but also to another device to generate the other device including the learning model. In addition, the learning model may be provided by being recorded in a detachable memory card such as a flash memory. The electronic equipment 20001 can read and record the learning model from the memory card inserted into a slot. Consequently, the electronic equipment 20001 can acquire the learning model, for example, even when the electronic equipment 20001 is used in a severe environment, when the electronic equipment 20001 does not have a communication function, when the electronic equipment 20001 has a communication function but an amount of information that can be transmitted is small.

The electronic equipment 20001 can provide a depth map, image data, or the like and data such as corrected data and metadata to other devices via the network 20040. For example, the electronic equipment 20001 transmits the data such as the depth map, the image data, or the like and the corrected data to the learning model generation server 20503 via the network 20040. Consequently, the learning model generation server 20503 can generate a learning model using, as teacher data, the data such as the depth map, the image data, or the like and the corrected data collected from one or a plurality of kinds of electronic equipment 20001. By using more teacher data, the accuracy of the learning processing can be improved.

The data such as the depth map, the image data, or the like and the corrected data are not limited to be directly provided from the electronic equipment 20001 to the learning model generation server 20503 and may be provided by the data provision server 20505 that aggregates and manages various data. The data provision server 20505 may collect data not only from the electronic equipment 20001 but also from other devices or may provide data not only to the learning model generation server 20503 but also to other devices.

The learning model generation server 20503 may perform, on an already generated learning model, relearning processing in which data such as a depth map, image data, or the like and corrected data provided from the electronic equipment 20001 or the data provision server 20505 are added to teacher data and update the learning model. The updated learning model can be provided to the electronic equipment 20001. When learning processing or relearning processing is performed in the learning model generation server 20503, processing can be performed irrespective of a difference in specifications or performances of the electronic equipment 20001.

In the electronic equipment 20001, when the user performs correction operation on corrected data or metadata (for example, when the user inputs correct information), the feedback data concerning the correction processing may be used for the relearning processing. For example, by transmitting feedback data from the electronic equipment 20001 to the learning model generation server 20503, the learning model generation server 20503 can perform relearning processing using the feedback data from the electronic equipment 20001 and update the learning model. Note that, in the electronic equipment 20001, an application provided by the application server 20506 may be used when the correction operation by the user is performed.

The relearning processing may be performed by the electronic equipment 20001. When the electronic equipment 20001 performs the relearning processing using the depth map, the image data, or the like and the feedback data and updates the learning model, the learning model can be improved in the device. As a result, the electronic equipment 20001 including the updated learning model is generated. Furthermore, the electronic equipment 20001 may transmit the updated learning model obtained by the relearning processing to the learning model provision server 20504 such that the updated learning model is provided to the other electronic equipment 20001. Consequently, it is possible to share the updated learning model among the plurality of kinds of electronic equipment 20001.

Alternatively, the electronic equipment 20001 may transmit difference information of the relearned learning model (difference information concerning the learning model before the update and the learning model after the update) to the learning model generation server 20503 as update information. The learning model generation server 20503 can generate an improved learning model based on the update information from the electronic equipment 20001 and provide the improved learning model to the other electronic equipment 20001. By exchanging such difference information, privacy can be further protected and communication cost can be reduced compared with when all information is exchanged. Note that, like the electronic equipment 20001, the information processing system 20011 mounted on the electronic equipment 20001 may perform the relearning processing.

The application server 20506 is a server capable of providing various applications via the network 20040. The applications provide predetermined functions in which data such as a learning model, corrected data, and metadata are used. The electronic equipment 20001 can realize a predetermined function by executing an application downloaded from the application server 20506 via the network 20040. Alternatively, the application server 20506 can also realize the predetermined function by acquiring data from the electronic equipment 20001 via, for example, an API (Application Programming Interface) and executing the application on the application server 20506.

As explained above, in the system including the device to which the present technology is applied, data such as a learning model, a depth map, image data, or the like and corrected data are exchanged and distributed among the devices and various services in which the data are used can be provided. For example, it is possible to provide a service for providing a learning model via the learning model provision server 20504 and a service for providing data such as a depth map, image data, or the like and corrected data via the data provision server 20505. It is possible to provide a service for providing an application via the application server 20506.

Alternatively, the depth map, the image data, or the like acquired from the information processing system 20011 of the electronic equipment 20001 may be input to the learning model provided by the learning model provision server 20504 and corrected data obtained as an output the learning model may be provided. A device such as electronic equipment in which the learning model provided by the learning model provision server 20504 is implemented may be generated and provided. Furthermore, by recording the data such as the learning model, the corrected data, and the metadata in a readable storage medium, the storage medium in which the data is recorded or a device such as electronic equipment on which the storage medium is mounted may be generated and provided. The storage medium may be a nonvolatile memory such as a magnetic disk, an optical disk, a magneto-optical disk, or a semiconductor memory or may be a volatile memory such as an SRAM or a DRAM.

Although the embodiments of the present disclosure are explained above, the technical scope of the present disclosure is not limited to the embodiments explained above per se. Various changes are possible without departing from the gist of the present disclosure. Components in different embodiments and modifications may be combined as appropriate.

The effects in the embodiments described in this specification are only illustrations and are not limited. Other effects may be present.

Note that the present technique can also take the following configurations.

<1>

An information processing system including:
an imaging processing unit that performs a light receiving operation and generates a depth map by using a result of the light receiving operation;
a preprocessing unit that performs preprocessing on the depth map before recognition processing is performed on the depth map; and
a recognition processing unit that performs the recognition processing using the information output by the preprocessing unit and outputs obtained information, wherein
(1) the preprocessing unit includes a machine learning processing unit that executes at least a part of the preprocessing by using the machine learning,
(2) the machine learning processing unit executes, using machine learning, processing for specifying a pixel having predetermined information or a pixel included in a region having the predetermined information in the depth map,
(3) the predetermined information is
(3-1) information generated by, among factors affecting data of the depth map generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the depth map generated by the imaging processing unit, or
(3-2) information concerning the subject in the depth map generated by the imaging processing unit, the information being different from the information obtained by the recognition processing,
(4) the machine learning processing unit includes, as a processing unit that executes the specifying processing using the machine learning, a supervised learning processing unit that has performed supervised learning or an unsupervised learning processing unit that has performed unsupervised learning,
(5) the supervised learning processing unit includes a neural network, the neural network being a neural network that has performed learning using, as teacher data, both a depth map including a pixel having the predetermined information and position information of the pixel or a depth map explicitly indicating the pixel having the predetermined information, and
the supervised learning processing unit receives, as input, the depth map generated by the imaging processing unit and outputs, as output, a result of specifying the pixel having the predetermined information or a pixel included in a region having the predetermined information in the depth map, and
(6) the unsupervised learning processing unit includes an auto encoder and a comparator, the auto encoder being an auto encoder that has performed learning using a depth map not including the predetermined information, and
the unsupervised learning processing unit receives, as input, the depth map generated by the imaging processing unit and outputs, as output, a result of specifying a pixel in which a difference between the depth map generated by the imaging processing unit and the depth map on which the learning has been performed is a predetermined threshold or more.
   <2>

The information processing system according to <1>, wherein
the preprocessing unit performs processing for changing, as information to be input to the recognition processing unit, data of the specified pixel in the depth map generated by the imaging processing unit to another value using data of pixels arranged around the pixel and input the depth map after the changing processing to the recognition processing unit,
the recognition processing unit includes a machine learning recognition processing unit that executes the recognition processing using the machine learning, and
the machine learning recognition processing unit is a second machine learning processing unit that has performed learning using a depth map including an object to be a target of the recognition processing.
   <3>

The information processing system according to <1>, wherein
the preprocessing unit performs processing for changing, as information to be input to the recognition processing unit, data of the specified pixel in the depth map generated by the imaging processing unit to a predetermined value to indicate that the pixel is the specified pixel and input the depth map after the changing processing to the recognition processing unit,
the recognition processing unit includes a machine learning recognition processing unit that executes the recognition processing using the machine learning, and
the machine learning recognition processing unit is a second machine learning processing unit that has performed learning using a depth map including an object to be a target of the recognition processing.
   <4>

The information processing system according to <1>, wherein
the preprocessing unit inputs, as information to be input to the recognition processing unit, to the recognition processing unit, both of the depth map generated by the imaging processing unit and two-dimensional image data, the two-dimensional image data being a figure or image data indicating a position of the specified pixel in the depth map generated by the imaging processing unit,
the recognition processing unit includes a machine learning recognition processing unit that executes the recognition processing using the machine learning, and
the machine learning recognition processing unit is a second machine learning processing unit that has performed learning using both of a depth map including an object to be a target of the recognition processing and the two-dimensional image data representing the position of the specified pixel.
   <5>

The information processing system according to <1>, wherein
the preprocessing unit inputs, as information to be input to the recognition processing unit, to the recognition processing unit, both of the depth map generated by the imaging processing unit and coordinate data representing a position of the specified pixel,
the recognition processing unit includes a machine learning recognition processing unit that executes the recognition processing using the machine learning, and
the machine learning recognition processing unit is a second machine learning processing unit that has performed learning using both of a depth map including an object to be a target of the recognition processing and the coordinate data representing the position of the specified pixel.
   <6>

The information processing system according to <1>, wherein
the information processing system performs relearning of the neural network of the supervised learning processing unit or the auto-encoder of the unsupervised learning processing unit using the depth map generated by the imaging processing unit and the information of the specified pixel.
   <7>

The information processing system according to <1>, wherein
the predetermined information is noise that occurred in the light receiving operation and is due to an electrical factor or an optical factor, variation in a light receiving result due to an electrical factor or an optical factor, or information erroneously detected because of an electrical factor or an optical factor.
   <8>

The information processing system according to <1>, wherein
the predetermined information is information different from the information obtained by the recognition processing and is information relating to privacy or security of a subject in the depth map generated by the imaging processing unit.
   <9>

A learning model generation method for an information processing system including:
an imaging processing unit that performs a light receiving operation and generates a depth map by using a result of the light receiving operation;
a preprocessing unit that performs preprocessing on the depth map before recognition processing is performed on the depth map; and
a recognition processing unit that performs the recognition processing using the information output by the preprocessing unit and outputs obtained information,
(1) the preprocessing unit including a machine learning processing unit that executes at least a part of the preprocessing by using the machine learning,
(2) the machine learning processing unit executing, using machine learning, processing for specifying a pixel having predetermined information or a pixel included in a region having the predetermined information in the depth map,
(3) the predetermined information being
(3-1) information generated by, among factors affecting data of the depth map generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the depth map generated by the imaging processing unit, or
(3-2) information concerning the subject in the depth map generated by the imaging processing unit, the information being different from the information obtained by the recognition processing,
(4) the machine learning processing unit including, as a processing unit that executes the specifying processing using the machine learning, a supervised learning processing unit that has performed supervised learning,
(5) the learning model generation method including, in the supervised learning processing unit, to generate a learning model for, in a use stage of the supervised learning processing unit, receiving, as input, the depth map generated by the imaging processing unit and outputting, as output, a result of specifying, in the depth map, a pixel having predetermined information or a pixel included in a region having the predetermined information,
in a learning stage of the supervised learning processing unit, performing learning using, as teacher data, both of a depth map including a pixel having the predetermined information and position information of the pixel or a depth map explicitly indicating the pixel having the predetermined information to thereby generate the learning model.
   <10>

A learning model generation method for an information processing system including:
an imaging processing unit that performs a light receiving operation and generates a depth map by using a result of the light receiving operation;
a preprocessing unit that performs preprocessing on the depth map before recognition processing is performed on the depth map; and
a recognition processing unit that performs the recognition processing using the information output by the preprocessing unit and outputs obtained information,
(1) the preprocessing unit including a machine learning processing unit that executes at least a part of the preprocessing by using the machine learning,
(2) the machine learning processing unit executing, using machine learning, processing for specifying a pixel having predetermined information or a pixel included in a region having the predetermined information in the depth map,
(3) the predetermined information being
(3-1) information generated by, among factors affecting data of the depth map generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the depth map generated by the imaging processing unit, or
(3-2) information concerning the subject in the depth map generated by the imaging processing unit, the information being different from the information obtained by the recognition processing,
(4) the machine learning processing unit including, as a processing unit that executes the specifying processing using the machine learning, an unsupervised learning processing unit that has performed unsupervised learning,
(5) the learning model generation method including, in the unsupervised learning processing unit, to generate a learning model for, in a use stage of the unsupervised learning processing unit, receiving, as input, the depth map generated by the imaging processing unit and outputting, as output, a result of specifying a pixel in which a difference between the depth map generated by the imaging processing unit and the depth map on which the learning is performed is a predetermined threshold or more,
in a learning stage of the unsupervised learning processing unit, performing learning using a depth map not including the predetermined information to thereby generate the learning model.
   <11>

An information processing system including:
an imaging processing unit that performs a light receiving operation and generates a two-dimensional image by using a result of the light receiving operation;
a preprocessing unit that performs preprocessing on the two-dimensional image before recognition processing is performed on the two-dimensional image; and
a recognition processing unit that performs the recognition processing using the information output by the preprocessing unit and outputs obtained information, wherein
(1) the preprocessing unit includes a machine learning processing unit that executes at least a part of the preprocessing by using the machine learning,
(2) the machine learning processing unit executes, using machine learning, processing for specifying a pixel having predetermined information or a pixel included in a region having the predetermined information in the two-dimensional image,
(3) the predetermined information is
(3-1) information generated by, among factors affecting data of the two-dimensional image generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the two-dimensional image generated by the imaging processing unit, or
(3-2) information concerning the subject in the two-dimensional image generated by the imaging processing unit, the information being different from the information obtained by the recognition processing,
(4) the machine learning processing unit includes, as a processing unit that executes the specifying processing using the machine learning, a supervised learning processing unit that has performed supervised learning or an unsupervised learning processing unit that has performed unsupervised learning,
(5) the supervised learning processing unit includes a neural network, the neural network being a neural network that has performed learning using, as teacher data, both a two-dimensional image including a pixel having the predetermined information and position information of the pixel or a two-dimensional image explicitly indicating the pixel having the predetermined information, and
the supervised learning processing unit receives, as input, the two-dimensional image generated by the imaging processing unit and outputs, as output, a result of specifying the pixel having the predetermined information or a pixel included in a region having the predetermined information in the two-dimensional image, and
(6) the unsupervised learning processing unit includes an auto encoder and a comparator, the auto encoder being an auto encoder that has performed learning using a two-dimensional image not including the predetermined information, and
the unsupervised learning processing unit receives, as input, the two-dimensional image generated by the imaging processing unit and outputs, as output, a result of specifying a pixel in which a difference between the two-dimensional image generated by the imaging processing unit and the two-dimensional image on which the learning has been performed is a predetermined threshold or more.
   <12>

The information processing system according to <11>, wherein
the preprocessing unit performs processing for changing, as information to be input to the recognition processing unit, data of the specified pixel in the two-dimensional image generated by the imaging processing unit to another value using data of pixels arranged around the pixel and input the two-dimensional image after the changing processing to the recognition processing unit,
the recognition processing unit includes a machine learning recognition processing unit that executes the recognition processing using the machine learning, and
the machine learning recognition processing unit is a second machine learning processing unit that has performed learning using a two-dimensional image including an object to be a target of the recognition processing.
   <13>

The information processing system according to <11>, wherein
the preprocessing unit performs processing for changing, as information to be input to the recognition processing unit, data of the specified pixel in the two-dimensional image generated by the imaging processing unit to a predetermined value to indicate that the pixel is the specified pixel and input the two-dimensional image after the changing processing to the recognition processing unit,
the recognition processing unit includes a machine learning recognition processing unit that executes the recognition processing using the machine learning, and
the machine learning recognition processing unit is a second machine learning processing unit that has performed learning using a two-dimensional image including an object to be a target of the recognition processing.
   <14>

The information processing system according to <11>, wherein
the preprocessing unit inputs, as information to be input to the recognition processing unit, to the recognition processing unit, both of the two-dimensional image generated by the imaging processing unit and two-dimensional image data, the two-dimensional image data being a figure or image data indicating a position of the specified pixel in the two-dimensional image generated by the imaging processing unit, and
the machine learning recognition processing unit is a second machine learning processing unit that has performed learning using both of a two-dimensional image including an object to be a target of the recognition processing and the two-dimensional image data representing the position of the specified pixel.
   <15>

The information processing system according to <11>, wherein
the preprocessing unit inputs, as information to be input to the recognition processing unit, to the recognition processing unit, both of the two-dimensional image generated by the imaging processing unit and coordinate data representing a position of the specified pixel, and
the machine learning recognition processing unit is a second machine learning processing unit that has performed learning using both of a two-dimensional image including an object to be a target of the recognition processing and the coordinate data representing the position of the specified pixel.
   <16>

The information processing system according to <11>, wherein
the information processing system performs relearning of the neural network of the supervised learning processing unit or the auto-encoder of the unsupervised learning processing unit using the two-dimensional image generated by the imaging processing unit and the information of the specified pixel.
   <17>

The information processing system according to <11>, wherein
the predetermined information is noise that occurred in the light receiving operation and is due to an electrical factor or an optical factor, variation in a light receiving result due to an electrical factor or an optical factor, or information erroneously detected because of an electrical factor or an optical factor.
   <18>

The information processing system according to <11>, wherein
the predetermined information is information different from the information obtained by the recognition processing and is information relating to privacy or security of a subject in the two-dimensional image generated by the imaging processing unit.
   <19>

A learning model generation method for an information processing system including:
an imaging processing unit that performs a light receiving operation and generates a two-dimensional image by using a result of the light receiving operation;
a preprocessing unit that performs preprocessing on the two-dimensional image before recognition processing is performed on the two-dimensional image; and
a recognition processing unit that performs the recognition processing using the information output by the preprocessing unit and outputs obtained information,
(1) the preprocessing unit including a machine learning processing unit that executes at least a part of the preprocessing by using the machine learning,
(2) the machine learning processing unit executing, using machine learning, processing for specifying a pixel having predetermined information or a pixel included in a region having the predetermined information in the two-dimensional image,
(3) the predetermined information being
(3-1) information generated by, among factors affecting data of the two-dimensional image generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the two-dimensional image generated by the imaging processing unit, or
(3-2) information concerning the subject in the two-dimensional image generated by the imaging processing unit, the information being different from the information obtained by the recognition processing,
(4) the machine learning processing unit including, as a processing unit that executes the specifying processing using the machine learning, a supervised learning processing unit that has performed supervised learning,
(5) the learning model generation method including, in the supervised learning processing unit, to generate a learning model for, in a use stage of the supervised learning processing unit, receiving, as input, the two-dimensional image generated by the imaging processing unit and outputting, as output, a result of specifying, in the two-dimensional image, a pixel having predetermined information or a pixel included in a region having the predetermined information,
in a learning stage of the supervised learning processing unit, performing learning using, as teacher data, both of a two-dimensional image including a pixel having the predetermined information and position information of the pixel or a two-dimensional image explicitly indicating the pixel having the predetermined information to thereby generate the learning model.
   <20>

A learning model generation method for an information processing system including:
an imaging processing unit that performs a light receiving operation and generates a two-dimensional image by using a result of the light receiving operation;
a preprocessing unit that performs preprocessing on the two-dimensional image before recognition processing is performed on the two-dimensional image; and
a recognition processing unit that performs the recognition processing using the information output by the preprocessing unit and outputs obtained information,
(1) the preprocessing unit including a machine learning processing unit that executes at least a part of the preprocessing by using the machine learning,
(2) the machine learning processing unit executing, using machine learning, processing for specifying a pixel having predetermined information or a pixel included in a region having the predetermined information in the two-dimensional image,
(3) the predetermined information being
(3-1) information generated by, among factors affecting data of the two-dimensional image generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the two-dimensional image generated by the imaging processing unit, or
(3-2) information concerning the subject in the two-dimensional image generated by the imaging processing unit, the information being different from the information obtained by the recognition processing,
(4) the machine learning processing unit including, as a processing unit that executes the specifying processing using the machine learning, an unsupervised learning processing unit that has performed unsupervised learning,
(5) the learning model generation method including, in the unsupervised learning processing unit, to generate a learning model for, in a use stage of the unsupervised learning processing unit, receiving, as input, the two-dimensional image generated by the imaging processing unit and outputting, as output, a result of specifying a pixel in which a difference between the two-dimensional image generated by the imaging processing unit and the two-dimensional image on which the learning is performed is a predetermined threshold or more,
in a learning stage of the unsupervised learning processing unit, performing learning using a two-dimensional image not including the predetermined information to thereby generate the learning model.

### REFERENCE SIGNS LIST

1, 1A, 2, 2A, 3-1 to 3-11, 3A, 3B, 4A, 4B, 4C, 4D INFORMATION PROCESSING SYSTEM
10, 10A IMAGING DEVICE
10-1 FIRST IMAGING DEVICE
10-2 SECOND IMAGING DEVICE
11 LENS
12 IMAGING UNIT
13, 13A, 13a, 13b SIGNAL PROCESSING UNIT
14 LIGHT EMISSION CONTROL UNIT
15 LIGHT EMITTING UNIT
16 OUTPUT CONTROL UNIT
17 OUTPUT I/F
18 IMAGING CONTROL UNIT
20, 20-3, 20-4 ARITHMETIC PROCESSING UNIT
20-1 FIRST ARITHMETIC PROCESSING UNIT
20-2 SECOND ARITHMETIC PROCESSING UNIT
20A FIRST MACHINE LEARNING PROCESSING UNIT
20B SECOND MACHINE LEARNING PROCESSING UNIT
20C MACHINE LEARNING PROCESSING UNIT
30 APPLICATION PROCESSOR
40 IMAGING BLOCK
50 PROCESSING BLOCK
51 CPU
52, 52a, 52b DSP
53 MEMORY
54 COMMUNICATION I/F
55 IMAGE COMPRESSION UNIT
56 INPUT I/F
57 BUS
60 DISPLAY DEVICE
61 SCREEN
80 CLOUD SERVER
120 PIXEL
121 PIXEL ARRAY UNIT
122 VERTICAL DRIVE UNIT
123 COLUMN PROCESSING UNIT
124 HORIZONTAL DRIVE UNIT
125 SYSTEM CONTROL UNIT
126 PIXEL DRIVE LINE
127 VERTICAL SIGNAL LINE
131 DEFECT CORRECTION
132 SHADING CORRECTION
133 COLOR MIXING CORRECTION
134 DIGITAL GAIN ADJUSTMENT
135 WHITE BALANCE ADJUSTMENT
136 DETECTION
137 DEMOSAIC
138 GAMMA CORRECTION
139 DISTORTION CORRECTION
181 COMMUNICATION I/F
182 REGISTER GROUP
201 TARGET PIXEL SPECIFYING (SPECIFYING unit UNIT)
202 TARGET PIXEL CORRECTION (CORRECTION UNIT)
301 RECOGNITION PROCESSING (RECOGNITION UNIT)
311 PROCESSING UNIT
800 CLOUD
801 RELEARNING
811 DATABASE
CL1, CL2, CL3 CONNECTION LINE
S11, S21 READ ROW DATA
S12, S22 SIGNAL PROCESSING
S13, S23 GENERATE DEPTH MAP
S14 SPECIFY TARGET PIXEL
S15 CORRECT TARGET PIXEL
S16 RECOGNITION PROCESSING
S17 CONTROL
S18 RELEARNING

1. An information processing system including:
an imaging processing unit that performs a light receiving operation and generates a depth map by using a result of the light receiving operation;
a preprocessing unit that performs preprocessing on the depth map before recognition processing is performed on the depth map; and
a recognition processing unit that performs the recognition processing using the information output by the preprocessing unit and outputs obtained information, wherein
(1) the preprocessing unit includes a machine learning processing unit that executes at least a part of the preprocessing by using the machine learning,
(2) the machine learning processing unit executes, using machine learning, processing for specifying a pixel having predetermined information or a pixel included in a region having the predetermined information in the depth map,
(3) the predetermined information is
(3-1) information generated by, among factors affecting data of the depth map generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the depth map generated by the imaging processing unit, or
(3-2) information concerning the subject in the depth map generated by the imaging processing unit, the information being different from the information obtained by the recognition processing,
(4) the machine learning processing unit includes, as a processing unit that executes the specifying processing using the machine learning, a supervised learning processing unit that has performed supervised learning or an unsupervised learning processing unit that has performed unsupervised learning,
(5) the supervised learning processing unit includes a neural network, the neural network being a neural network that has performed learning using, as teacher data, both a depth map including a pixel having the predetermined information and position information of the pixel or a depth map explicitly indicating the pixel having the predetermined information, and
the supervised learning processing unit receives, as input, the depth map generated by the imaging processing unit and outputs, as output, a result of specifying the pixel having the predetermined information or a pixel included in a region having the predetermined information in the depth map, and
(6) the unsupervised learning processing unit includes an auto encoder and a comparator, the auto encoder being an auto encoder that has performed learning using a depth map not including the predetermined information, and
the unsupervised learning processing unit receives, as input, the depth map generated by the imaging processing unit and outputs, as output, a result of specifying a pixel in which a difference between the depth map generated by the imaging processing unit and the depth map on which the learning has been performed is a predetermined threshold or more.

2. The information processing system according to claim 1, wherein
the preprocessing unit performs processing for changing, as information to be input to the recognition processing unit, data of the specified pixel in the depth map generated by the imaging processing unit to another value using data of pixels arranged around the pixel and input the depth map after the changing processing to the recognition processing unit,
the recognition processing unit includes a machine learning recognition processing unit that executes the recognition processing using the machine learning, and
the machine learning recognition processing unit is a second machine learning processing unit that has performed learning using a depth map including an object to be a target of the recognition processing.

3. The information processing system according to claim 1, wherein
the preprocessing unit performs processing for changing, as information to be input to the recognition processing unit, data of the specified pixel in the depth map generated by the imaging processing unit to a predetermined value to indicate that the pixel is the specified pixel and input the depth map after the changing processing to the recognition processing unit,
the recognition processing unit includes a machine learning recognition processing unit that executes the recognition processing using the machine learning, and
the machine learning recognition processing unit is a second machine learning processing unit that has performed learning using a depth map including an object to be a target of the recognition processing.

4. The information processing system according to claim 1, wherein
the preprocessing unit inputs, as information to be input to the recognition processing unit, to the recognition processing unit, both of the depth map generated by the imaging processing unit and two-dimensional image data, the two-dimensional image data being a figure or image data indicating a position of the specified pixel in the depth map generated by the imaging processing unit,
the recognition processing unit includes a machine learning recognition processing unit that executes the recognition processing using the machine learning, and
the machine learning recognition processing unit is a second machine learning processing unit that has performed learning using both of a depth map including an object to be a target of the recognition processing and the two-dimensional image data representing the position of the specified pixel.

5. The information processing system according to claim 1, wherein
the preprocessing unit inputs, as information to be input to the recognition processing unit, to the recognition processing unit, both of the depth map generated by the imaging processing unit and coordinate data representing a position of the specified pixel,
the recognition processing unit includes a machine learning recognition processing unit that executes the recognition processing using the machine learning, and
the machine learning recognition processing unit is a second machine learning processing unit that has performed learning using both of a depth map including an object to be a target of the recognition processing and the coordinate data representing the position of the specified pixel.

6. The information processing system according to claim 1, wherein
the information processing system performs relearning of the neural network of the supervised learning processing unit or the auto-encoder of the unsupervised learning processing unit using the depth map generated by the imaging processing unit and the information of the specified pixel.

7. The information processing system according to claim 1, wherein
the predetermined information is noise that occurred in the light receiving operation and is due to an electrical factor or an optical factor, variation in a light receiving result due to an electrical factor or an optical factor, or information erroneously detected because of an electrical factor or an optical factor.

8. The information processing system according to claim 1, wherein
the predetermined information is information different from the information obtained by the recognition processing and is information relating to privacy or security of a subject in the depth map generated by the imaging processing unit.

9. A learning model generation method for an information processing system including:
an imaging processing unit that performs a light receiving operation and generates a depth map by using a result of the light receiving operation;
a preprocessing unit that performs preprocessing on the depth map before recognition processing is performed on the depth map; and
a recognition processing unit that performs the recognition processing using the information output by the preprocessing unit and outputs obtained information,
(1) the preprocessing unit including a machine learning processing unit that executes at least a part of the preprocessing by using the machine learning,
(2) the machine learning processing unit executing, using machine learning, processing for specifying a pixel having predetermined information or a pixel included in a region having the predetermined information in the depth map,
(3) the predetermined information being
(3-1) information generated by, among factors affecting data of the depth map generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the depth map generated by the imaging processing unit, or
(3-2) information concerning the subject in the depth map generated by the imaging processing unit, the information being different from the information obtained by the recognition processing,
(4) the machine learning processing unit including, as a processing unit that executes the specifying processing using the machine learning, a supervised learning processing unit that has performed supervised learning,
(5) the learning model generation method including, in the supervised learning processing unit, to generate a learning model for, in a use stage of the supervised learning processing unit, receiving, as input, the depth map generated by the imaging processing unit and outputting, as output, a result of specifying, in the depth map, a pixel having predetermined information or a pixel included in a region having the predetermined information,
in a learning stage of the supervised learning processing unit, performing learning using, as teacher data, both of a depth map including a pixel having the predetermined information and position information of the pixel or a depth map explicitly indicating the pixel having the predetermined information to thereby generate the learning model.

10. A learning model generation method for an information processing system including:
an imaging processing unit that performs a light receiving operation and generates a depth map by using a result of the light receiving operation;
a preprocessing unit that performs preprocessing on the depth map before recognition processing is performed on the depth map; and
a recognition processing unit that performs the recognition processing using the information output by the preprocessing unit and outputs obtained information,
(1) the preprocessing unit including a machine learning processing unit that executes at least a part of the preprocessing by using the machine learning,
(2) the machine learning processing unit executing, using machine learning, processing for specifying a pixel having predetermined information or a pixel included in a region having the predetermined information in the depth map,
(3) the predetermined information being
(3-1) information generated by, among factors affecting data of the depth map generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the depth map generated by the imaging processing unit, or
(3-2) information concerning the subject in the depth map generated by the imaging processing unit, the information being different from the information obtained by the recognition processing,
(4) the machine learning processing unit including, as a processing unit that executes the specifying processing using the machine learning, an unsupervised learning processing unit that has performed unsupervised learning,
(5) the learning model generation method including, in the unsupervised learning processing unit, to generate a learning model for, in a use stage of the unsupervised learning processing unit, receiving, as input, the depth map generated by the imaging processing unit and outputting, as output, a result of specifying a pixel in which a difference between the depth map generated by the imaging processing unit and the depth map on which the learning is performed is a predetermined threshold or more,
in a learning stage of the unsupervised learning processing unit, performing learning using a depth map not including the predetermined information to thereby generate the learning model.

11. An information processing system including:
an imaging processing unit that performs a light receiving operation and generates a two-dimensional image by using a result of the light receiving operation;
a preprocessing unit that performs preprocessing on the two-dimensional image before recognition processing is performed on the two-dimensional image; and
a recognition processing unit that performs the recognition processing using the information output by the preprocessing unit and outputs obtained information, wherein
(1) the preprocessing unit includes a machine learning processing unit that executes at least a part of the preprocessing by using the machine learning,
(2) the machine learning processing unit executes, using machine learning, processing for specifying a pixel having predetermined information or a pixel included in a region having the predetermined information in the two-dimensional image,
(3) the predetermined information is
(3-1) information generated by, among factors affecting data of the two-dimensional image generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the two-dimensional image generated by the imaging processing unit, or
(3-2) information concerning the subject in the two-dimensional image generated by the imaging processing unit, the information being different from the information obtained by the recognition processing,
(4) the machine learning processing unit includes, as a processing unit that executes the specifying processing using the machine learning, a supervised learning processing unit that has performed supervised learning or an unsupervised learning processing unit that has performed unsupervised learning,
(5) the supervised learning processing unit includes a neural network, the neural network being a neural network that has performed learning using, as teacher data, both a two-dimensional image including a pixel having the predetermined information and position information of the pixel or a two-dimensional image explicitly indicating the pixel having the predetermined information, and
the supervised learning processing unit receives, as input, the two-dimensional image generated by the imaging processing unit and outputs, as output, a result of specifying the pixel having the predetermined information or a pixel included in a region having the predetermined information in the two-dimensional image, and
(6) the unsupervised learning processing unit includes an auto encoder and a comparator, the auto encoder being an auto encoder that has performed learning using a two-dimensional image not including the predetermined information, and
the unsupervised learning processing unit receives, as input, the two-dimensional image generated by the imaging processing unit and outputs, as output, a result of specifying a pixel in which a difference between the two-dimensional image generated by the imaging processing unit and the two-dimensional image on which the learning has been performed is a predetermined threshold or more.

12. The information processing system according to claim 11, wherein
the preprocessing unit performs processing for changing, as information to be input to the recognition processing unit, data of the specified pixel in the two-dimensional image generated by the imaging processing unit to another value using data of pixels arranged around the pixel and input the two-dimensional image after the changing processing to the recognition processing unit,
the recognition processing unit includes a machine learning recognition processing unit that executes the recognition processing using the machine learning, and
the machine learning recognition processing unit is a second machine learning processing unit that has performed learning using a two-dimensional image including an object to be a target of the recognition processing.

13. The information processing system according to claim 11, wherein
the preprocessing unit performs processing for changing, as information to be input to the recognition processing unit, data of the specified pixel in the two-dimensional image generated by the imaging processing unit to a predetermined value to indicate that the pixel is the specified pixel and input the two-dimensional image after the changing processing to the recognition processing unit,
the recognition processing unit includes a machine learning recognition processing unit that executes the recognition processing using the machine learning, and
the machine learning recognition processing unit is a second machine learning processing unit that has performed learning using a two-dimensional image including an object to be a target of the recognition processing.

14. The information processing system according to claim 11, wherein
the preprocessing unit inputs, as information to be input to the recognition processing unit, to the recognition processing unit, both of the two-dimensional image generated by the imaging processing unit and two-dimensional image data, the two-dimensional image data being a figure or image data indicating a position of the specified pixel in the two-dimensional image generated by the imaging processing unit, and
the machine learning recognition processing unit is a second machine learning processing unit that has performed learning using both of a two-dimensional image including an object to be a target of the recognition processing and the two-dimensional image data representing the position of the specified pixel.

15. The information processing system according to claim 11, wherein
the preprocessing unit inputs, as information to be input to the recognition processing unit, to the recognition processing unit, both of the two-dimensional image generated by the imaging processing unit and coordinate data representing a position of the specified pixel, and
the machine learning recognition processing unit is a second machine learning processing unit that has performed learning using both of a two-dimensional image including an object to be a target of the recognition processing and the coordinate data representing the position of the specified pixel.

16. The information processing system according to claim 11, wherein
the information processing system performs relearning of the neural network of the supervised learning processing unit or the auto-encoder of the unsupervised learning processing unit using the two-dimensional image generated by the imaging processing unit and the information of the specified pixel.

17. The information processing system according to claim 11, wherein
the predetermined information is noise that occurred in the light receiving operation and is due to an electrical factor or an optical factor, variation in a light receiving result due to an electrical factor or an optical factor, or information erroneously detected because of an electrical factor or an optical factor.

18. The information processing system according to claim 11, wherein
the predetermined information is information different from the information obtained by the recognition processing and is information relating to privacy or security of a subject in the two-dimensional image generated by the imaging processing unit.

19. A learning model generation method for an information processing system including:
an imaging processing unit that performs a light receiving operation and generates a two-dimensional image by using a result of the light receiving operation;
a preprocessing unit that performs preprocessing on the two-dimensional image before recognition processing is performed on the two-dimensional image; and
a recognition processing unit that performs the recognition processing using the information output by the preprocessing unit and outputs obtained information,
(1) the preprocessing unit including a machine learning processing unit that executes at least a part of the preprocessing by using the machine learning,
(2) the machine learning processing unit executing, using machine learning, processing for specifying a pixel having predetermined information or a pixel included in a region having the predetermined information in the two-dimensional image,
(3) the predetermined information being
(3-1) information generated by, among factors affecting data of the two-dimensional image generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the two-dimensional image generated by the imaging processing unit, or
(3-2) information concerning the subject in the two-dimensional image generated by the imaging processing unit, the information being different from the information obtained by the recognition processing,
(4) the machine learning processing unit including, as a processing unit that executes the specifying processing using the machine learning, a supervised learning processing unit that has performed supervised learning,
(5) the learning model generation method including, in the supervised learning processing unit, to generate a learning model for, in a use stage of the supervised learning processing unit, receiving, as input, the two-dimensional image generated by the imaging processing unit and outputting, as output, a result of specifying, in the two-dimensional image, a pixel having predetermined information or a pixel included in a region having the predetermined information,
in a learning stage of the supervised learning processing unit, performing learning using, as teacher data, both of a two-dimensional image including a pixel having the predetermined information and position information of the pixel or a two-dimensional image explicitly indicating the pixel having the predetermined information to thereby generate the learning model.

20. A learning model generation method for an information processing system including:
an imaging processing unit that performs a light receiving operation and generates a two-dimensional image by using a result of the light receiving operation;
a preprocessing unit that performs preprocessing on the two-dimensional image before recognition processing is performed on the two-dimensional image; and
a recognition processing unit that performs the recognition processing using the information output by the preprocessing unit and outputs obtained information,
(1) the preprocessing unit including a machine learning processing unit that executes at least a part of the preprocessing by using the machine learning,
(2) the machine learning processing unit executing, using machine learning, processing for specifying a pixel having predetermined information or a pixel included in a region having the predetermined information in the two-dimensional image,
(3) the predetermined information being
(3-1) information generated by, among factors affecting data of the two-dimensional image generated by the imaging processing unit,
a factor of being other than a subject that is a target imaged by the imaging processing unit and a factor of being other than an optical path connecting the imaging processing unit and the subject with a straight line, the factor being an optical or electrical factor, and written in the two-dimensional image generated by the imaging processing unit, or
(3-2) information concerning the subject in the two-dimensional image generated by the imaging processing unit, the information being different from the information obtained by the recognition processing,
(4) the machine learning processing unit including, as a processing unit that executes the specifying processing using the machine learning, an unsupervised learning processing unit that has performed unsupervised learning,
(5) the learning model generation method including, in the unsupervised learning processing unit, to generate a learning model for, in a use stage of the unsupervised learning processing unit, receiving, as input, the two-dimensional image generated by the imaging processing unit and outputting, as output, a result of specifying a pixel in which a difference between the two-dimensional image generated by the imaging processing unit and the two-dimensional image on which the learning is performed is a predetermined threshold or more,
in a learning stage of the unsupervised learning processing unit, performing learning using a two-dimensional image not including the predetermined information to thereby generate the learning model.
